(19) United States
(12) Patent Application Publication
(10) Pub. No.: US 2024/0118579 A1
(43) Pub. Date: Apr. 11, 2024

(54) OPTOMETAPHORESIS: PROGRAMMABLE METAPHOTONICS BY PARTICLE MIGRATION AND LIGHT-BENDING IN NANOPARTICLE COLLOIDS CONTROLLED BY NEAR-FIELD MICRO-STRUCTURED CURRENT-VOLTAGE-ENERGIZED PHASED-ARRAY ANTENNA-ELECTRODES INDUCING DIELECTROPHORESIS

(71) Applicant: Leo D. DiDomenico, Orinda, CA (US)

(72) Inventor: Leo D. DiDomenico, Orinda, CA (US)

(21) Appl. No.: 17/941,997

(22) Filed: Sep. 9, 2022

(51) Int. Cl. G02F 1/167; G02B 1/00; G02F 1/1676; G02F 1/1685

(52) U.S. Cl. CPC G02F 1/167; G02B 1/002; G02F 1/1676; G02F 1/1685; G02F 2001/1678

(57) ABSTRACT

Optometaphoresis is a new form of software programmable optics wherein light is controlled by the migration of a large number of particles in a colloid due to radio frequency signals injected into the colloid by a near-field micro-structured current-voltage-energized phased-array antenna-electrode that impress dielectrophoretic forces and torques on nanoparticles in the colloid. This creates a fluidic metamaterial that affects the propagation of light (ultraviolet, visible light, infrared, THz waves, millimeter waves, etc.) passing through the colloid. The migration modalities of the particles include translation, orientation, and deformation of particles in a colloid. Optometaphoresis synthesis the central quantity to all optics: Refractive Index. Light may be refracted, reflected, diffracted, guided, and even polarized within the optometaphoresis system by bending light.

### CROSS REFERENCE TO RELATED APPLICATIONS

This invention claims the benefit of provisional patent application number U.S. 63/242,331, entitled “Light Beam Steering by Dielectrophoresis of Nanoparticle Colloids Using Voltage and Current Electrodes,” which was filed by Dr. Leo D. DiDomenico on 2021 Sep. 9, the entirety of which is incorporated herein by reference.

### TECHNICAL FIELD OF INVENTION

This disclosure describes a new technical field of metaphotonics called Optometaphoresis (OMP), which synthesis optical devices by manipulating at least one of the position, orientation, and shape distributions of trillions of nanoparticles held in suspension in a thin colloidal metafilm, by the application of software programmable Radio Frequency (RF) energy from micro-structured current-voltage-energized near-field phased-array antenna-electrodes in close proximity thereto. Optometaphoresis provides a means to create any optical device desired, e.g. lenses, mirrors, diffraction gratings, polarizers, polarization converters, beam splitters, wave plates, refractive surfaces, chiral optical materials, orbital angular momentum synthesizers, beam steerers, and more; all by software programing the optical device into existence. It has a large working temperature range, ability to handle high powers and energy, small-to-huge (millimeter-to-meter) area devices are possible, retained optics in static memory that requires no additional power, achromatic optics, and roll-to-roll low-cost manufacturing are possible.

### BACKGROUND ART

Today's conventional optics, comprising lenses, phase shifters, beam splitters, polarizers, mirrors, and layered filters are often large and incompatible with advanced applications that require hyper-compact light-weight optics, for example, augmented reality headsets, solar concentrator panels, and optical chip-sets, because they typically require many thousands of wavelengths of light to realize their function. However, during the past couple of decades the emergence of optical metasurfaces has become a driving force for development of advanced optics. Optical metasurfaces are engineered surfaces that control the flow of light by means of an arraignment of nano-scale features, which are sometimes called meta-atoms and meta-molecules. An example of a prior art meta-lens, as seen looking at the lens from the optical axis, is shown in FIG. 1. It has a single layer of sub-wavelength cylindrical meta-atoms with diameters proportional to refractive index to form a phase-screen. The lens is static, i.e. it can't zoom, and it is small with a limited diameter of perhaps 1 mm to 10 mm. Today's metasurfaces have the ability to control electromagnetic-field amplitude, phase, polarization with a single layer of optical scatterers that act as a kind of optical antenna with a thickness that is sub-wavelength. Metasurfaces have allowed almost on-demand and pervasive manipulation of light-matter interactions by the careful selection of size, shape, and orientation of meta-atoms that is based on hyper-precise lithographic techniques. Thus, the idea that it might be possible replace conventional optics with such a compact system has been compelling and motivated extensive innovation.

Nonetheless, metasurfaces still have certain shortcomings associated with “going too far” and making the optics too thin. First, metasurfaces have been static optics that are unable to adapt to new functionality. Attempts to overcome this shortcoming have included at least one of (1) liquid crystals to provide electrically controllable birefringence, (2) electrical deformation of underlying substrates to change the spacing between meta-atoms, (3) voltage and heat controlled anisotropy of the underlying substrates that metasurfaces are built upon and (4) localized charge injection, in the vicinity of the meta-atoms, to change the dielectric properties of the substrate and/or the meta-atoms. These solutions are still early and currently unable to realize compete light beam control. Second, metasurfaces are often fabricated on exotic materials, like sapphire, using chemical vapor deposition and plasma etching that limits the size of the optical system to very much less than a meter in scale. This limits their use for large-area and high-power applications. Third, metasurface manufacturing is process intensive, and cannot easily accommodate roll-to-roll manufacturing of hundreds of square kilometers needed, for example, the solar energy industry. Thus, while the potential impact of metasurface optics is very high, there is a need to do much better to address today's emerging optics problems.

Thus, in this disclosure the latest evolution of a series of innovations, by the current author, is discussed to control light by overcoming the “too thin” shortcomings of metasurfaces. These innovations have converged to a novel optofluidic metafilm, which utilizes the full three-dimensional volume of a film for optical systems with ten to hundreds of optical wavelengths of thickness. This current evolution is driven by near-field micro-structured phased-array antenna-electrodes, and typically is compact and intrinsically has the ability to change and reconfigure to allow: dynamic optics, large-areas, high-powers, broad spectrum, low-cost roll-to-roll manufacturing, and other game-changing optical capabilities. The historical progress of the current author's thinking is outlined immediately below and the current evolution is discussed in the remainder of this disclosure.

In U.S. Pat. No. 10,371,936, having publication date 2019 Aug. 6 and entitled, “Wide Angle, Broad-Band, Polarization Independent Beam Steering and Concentration of Wave Energy Utilizing Electronically Controlled Soft Matter,” which is included herein in its entirety by this reference, the current applicant provides a first generation (G1) of a light control technology based on mixing two or more liquid chemicals to form a solution that provides a Refractive Index Matching (RIM) liquid. The G1 technology is characterized by mixing the molecules of two or more liquid chemicals, both of which have molecules that are typically less than 1 nm in maximum size. The resulting liquid solution may be advected through capillaries by various means (e.g. pressure differences) to hide and reveal optical boundaries so that total internal reflection (TIR) may provide light steering.

In U.S. patent application Ser. No. 11/385,516, having publication date 2022 Jul. 12, and entitled, “Agile Light Control by Means of Noise, Impulse, and Harmonic Signal Induced Dielectrophoresis Plus Other Phoretic Forces for the Control of Optical Scattering and Refractive Index to Bend, and Focus Light,” which is included herein in its entirety by this reference, the current author provides a second generation (G2) of a light control technology. G2 is based on replacing one of the liquid components of the G1 technology with a (typically) solid spherical nanoparticle (NP) so that dielectrophoresis (DEP) [1] can provide a means for electronically controlled advection. DEP comprising conventional dielectrophoresis that uses two-phase electrical excitation to provide pondermotive forces in the positive direction of the gradient of the square of the electric field (pDEP), or in the negative direction of the gradient of the square of the electric field (nDEP). DEP also comprising four-phase electrical excitation provides pondermotive forces in the direction of a traveling wave (twDEP). Substantial theory and examples were provided for using nanoparticle spatial translation to affect control of the scalar refractive index and consequently provide light control. One of the key distinguishing features of G1 from G2 is that G1 uses solutions with particle size typically less than 1 nm while G2 is based on colloids with particle size between 1 nm and 1000 nm for visible light optics, but with a strong preference towards particle size of about 30 nm or less to reduce Tyndall scattering effects in the visible region of the electromagnetic spectrum, at the same time as increasing DEP forces by a million over molecules in solution.

In U.S. Patent Application 20210208469, with publication date 2021 Jul. 8, and entitled “Light Control by Means of Forced Translation, Rotation, Orientation, and Deformation of Particles Using Dielectrophoresis,” which is included herein in its entirety by this reference, the current author provides a third generation (G3) of a light control technology where strong emphasis is based on NP rotation and orientation in an electric field. This provides a geometric anisotropy for light scattering by an effective refractive index (RI) due to NP rotations and orientations. One of the distinguishing features of G2 from G3 is that G3 rotates NPs into the proper orientation for light control while G2 translates the NPs. Rotation of NPs often takes up to 1000 times less voltage on electrodes to achieve desired optical effects.

That said, the first objective in this disclosure is to demonstrate how to configure electrodes for compact and precision control of NPs and RI for G3 technology, a second objective is to refine the description of OMP to better teach the art. Finally, it is a third objective of this document to introduce and clearly define new scientific words, including “optometaphoresis” and its possible derivatives within the greater field of metaphotonics.

### BRIEF DESCRIPTION OF THE DRAWINGS

The foregoing discussion is only an introduction and other objects, features, aspects, and advantages will become apparent from the following detailed description and drawings of physical principles given by way of illustration. Note that figures are often drawn for improved clarity of the underlying physical principles, are not necessarily drawn to scale, and have certain idealizations introduced to show the essence of the method and embodiments to make descriptions clear. Also note that drawings of embodiments have reference designations to point to specific features, while theoretical images that are used to develop mathematical principles will often have descriptions and variables directly thereon, to assist in clarity of presentation.

FIG. 1 shows prior of a top view of a meta lens comprising a plurality of cylindrical meta atoms formed on a substrate (not shown), with modulo coordinated diameters, and formed into an array to allow a lens to be formed by fly-back refractive index formation.

FIG. 2 shows a graph of the real and imaginary parts of the two distinct diagonal components of the electric susceptibility tensor of a uniaxial colloid's frequency response. An R subscript represents the real part, and an I subscript indicates the imaginary part.

FIG. 3 shows the depolarization of a spheroid particle passing from oblate to sphere to prolate as represented by the ratio of its principle axes lengths {a, b, c} in the x, y, and z directions. In particular, the sphere occurs when the ratio of principal lengths is η=c/a=1 and M=1/3. The oblate spheroid occurs when 0<η<1 and c<a=b. The prolate spheroid occurs when 1<η<∞ and a=b<c. This is critical to forming electric fields inside a particle that are not in the same direction to the external dielectrophoresis excitation field to allows non-zero torques on particles controlling light scattering.

FIG. 4 shows an example calcite crystal rhomb that forms the crystal habit as well as the optical axis of the crystal and the angles formed due to the underlying atomic structure.

FIG. 5 shows the representation indicatrix in three dimensions and the electromagnetic field configuration for an e-wave traveling in an anisotropic medium such that the Poynting vector is not in the same direction as the wave vector. This is the e-wave configuration, where the magnetic fields are perpendicular to the optical axis.

FIG. 6 A shows a small section of a colloid containing both liquid molecules and ellipsoidal NPs.

FIG. 6 B shows the same small section of a colloid as FIG. 6A, but only with the ellipsoidal NPs so that the pattern of NP rotation becomes visible.

FIG. 6 C shows the effective orientation of ellipsoidal NPs so that a pattern of RI ellipsoids can be assigned to each voxel.

FIG. 7 shows phase-ray trajectories and phase-wavefronts for a theoretical discussion on the origins of Fermat's principle and how to extend this principle to anisotropic media.

FIG. 8 shows phase-ray trajectories, phase-wavefronts, and energy-ray trajectories in an isotropic medium.

FIG. 9 shows phase-ray trajectories, phase-wavefronts, and energy-ray trajectories in an anisotropic medium.

FIG. 10 shows the geometry for a theoretical discussion that disallows anisotropic beam steering using circular phase-ray trajectories.

FIG. 11 shows in cross section the indicatrix representation of a homogeneous and isotropic medium, such as an amorphous glass or a colloid with spherical glass nanoparticles dispersed uniformly and randomly throughout the dispersion.

FIG. 12 shows in cross section the indicatrix representation of an inhomogeneous and isotropic medium comprising an isotropic graded refractive index (I-GRIN) medium.

FIG. 13 shows in cross section the indicatrix representation of a graded refractive index medium with a reset at a step discontinuity across a diagonal, which runs from lower left to upper right. This step discontinuity is required in many prior-art beam steering technologies and is difficult to achieve correctly as discussed in the APPENDIX of this disclosure.

FIG. 14 shows in cross section the indicatrix representation of a positive uniaxial crystal with the optical axis running from the upper left hand corner to the lower right hand corner.

FIG. 15 shows in cross section the indicatrix representation of a positive uniaxial crystal with the optical axis changing orientation from the upper left hand corner to the lower right hand corner by π/2 radians via a constant gradient (i.e. linear change in angle spatially).

FIG. 16 shows in cross section the indicatrix representation of a positive uniaxial crystal with the optical axis changing orientation from the upper left hand corner to the lower right hand corner without the need for a step discontinuity as is the case for isotropic gradient refractive index media. The indicatrix just keeps on rotating as needed to accomplish the optical function needed.

FIG. 17 shows in cross section the indicatrix representation of a fluidic meta material comprising a positive uniaxial crystal with the optical axis in a fixed orientation from the upper left hand corner to the lower right hand corner and with a simultaneous increase in the volume fraction of nanoparticles in the same direction.

FIG. 18 shows in cross section the indicatrix representation of a fluidic meta material comprising a positive uniaxial crystal with the optical axis changing orientation from the upper left hand corner to the lower right hand corner and with a simultaneous increase in the volume fraction of nanoparticles in the same direction.

FIG. 19 shows in cross section the indicatrix representation of a boundary between two isotropic and homogeneous optical media. This is typical of the type of boundary found between a conventional lens and the air.

FIG. 20 shows in cross section the indicatrix representation of a simple diffractive optical element, comprising periodic and isotropic variations in the refractive index to provide diffraction.

FIG. 21 shows a grid of refractive index ellipsoids, which are averages from within a colloid that are taken on a grid. The refractive index ellipsoids provide an example such that they are orientated with a positive gradient in angular rotation from the upper left hand corner to the lower right and corner, it also shows five iso-orientation bands where the refractive index ellipsoids have a constant angle.

FIG. 22 shows that substantially different phase-ray trajectories are provided by colloids with nanoparticles that are orientated with different spatial rotation directions for the common initial condition of the long axis of the refractive index ellipsoid being parallel to the input light.

FIG. 23 shows that substantially different phase ray trajectories are provided by colloids with nanoparticles that are orientated with different spatial rotation directions for the common initial condition of the long axis of the refractive index ellipsoid being perpendicular to the input light.

FIG. 24 shows that different initial conditions impact the maximum curvature of the ray trajectory and can provide a range of output directions for the incident light.

FIG. 25 shows that the underlying physics for ray trajectories in A-GRIN media is given by light moving towards the higher refractive index as provided by refractive index ellipsoids that are normal to the ray trajectory in the osculating plane of the trajectory.

FIG. 26 shows a plurality of parallel input rays being bent into a plurality of parallel output rays.

FIG. 27 shows eight example ray bundles that are each steered into a different direction by setting the appropriate initial refractive index ellipsoid orientation in a colloid and the rate of rotation of nanoparticles.

FIG. 28 shows examples or rays steered into a different directions by a combination of controlled refraction and a mirror, this is accomplished by setting the appropriate initial refractive index ellipsoid orientation in a colloid and the rate of rotation of nanoparticles.

FIG. 29 shows a prior-art quadrupole electrode system that is used to create a rotating electric field by means of four voltage electrodes that create orthogonal and phase quadrature electric fields.

FIG. 30 shows side cut-away view of a beam steering pixel with a voltage and current electrode working together to provide orthogonal quadrature-phase electric fields within a colloid that is located between the electrodes.

FIG. 31 shows side cut-away view of a beam steering pixel with single a electrode acting as both voltage and current electrode to provide orthogonal phase-quadrature electric fields within a colloid that is located between the electrodes.

FIG. 32 shows a pixel schematic in cross-section with a refractive index ellipsoid within a colloid that is surrounded by electrodes that produce normal and parallel electric fields. The pixel coordinates and the refractive index coordinates are shown so that a conversion between the two can be derived in the document.

FIG. 33 shows in cross section a portion of a light beam steering pixel element, which is based on separate voltage and current electrodes, so that an input light beam can be steering into an output light beam.

FIG. 34 Shows another example of light beam steering by a colloid between two glass plates as represented by a grid of rotating refractive index ellipsoids and curved light ray trajectories.

FIG. 35 shows in cross section a portion of a light beam steering pixel that is configured for concentrating the input light to a common focus.

FIG. 36 shows a three dimensional perspective of a portion of a light beam steering panel with glass layers, electrodes, and a colloid.

FIG. 37 shows a three dimensional schematic and perspective of a refractive index ellipsoid (a spheroid) that is orientated into position by means of two orthogonal harmonic currents on a current electrode and one harmonic voltage on a voltage electrode. Theses three signals provide enough information to allow arbitrary steering of light into any direction.

FIG. 38 shows the top view of a segmented electrode that is designed to provide a decaying electric field strength moving away from the plane of the electrode, even over very large areas.

FIG. 39 shows the top view of two segmented electrodes that are stacked over each, i.e. without touching, and in close proximity. The two electrodes provide substantially orthogonal electric fields away from the edges of the electrodes.

FIG. 40 shows a perspective view of two segmented electrodes that are stacked over each, i.e. without touching.

FIG. 41A shows an array of charged wires in cross section as well as the resulting iso-contours of the magnitude of the electric fields. The apodization strength is the same on each wire. As a result the magnitude of the electric fields, shown as iso-contour lines, are not parallel to the plane of the electrode as required for uniform beam steering. The axis units are both length.

FIG. 41B shows an array of charged wires in cross section as well as the resulting iso-contours of the magnitude of the electric fields. The apodization strength is now parabolic across the wires of the array. As a result the magnitude of the electric fields, shown as iso-contour lines, are now substantially parallel to the plane of the electrode as required for uniform beam steering. The axis units are both length.

FIG. 42 shows a three dimensional perspective of a large-area, broad-spectrum optometaphoresis light beam steering device comprising nanoparticles sandwiched in a layered stack that employs dielectrophoresis for rotational (and optionally translational) nanoparticle manipulation and light beam control.

FIG. 43 shows an active segmented electrode array that is controlled by field effect transistors that impress an apodization across the electrode to optimize the dielectrophoretic fields for optical beam steering.

FIG. 44 shows a general elliptic trajectory that the electric field vector sweeps out as it propagates in a plane wave. This is used for defining quantities that are used in developing polarization beam steering.

FIG. 45 shows a general elliptic trajectory that the electric field vector sweeps out as it propagates in a plane wave, but with normalized quantities listed. This is used for defining quantities that are used in developing polarization beam steering.

FIG. 46 shows a Poincaré sphere with orthogonal input and output polarization states depicted.

FIG. 47 shows two ellipses that represent orthogonal electric fields of the polarization state of light, such orthogonal fields form the vector basis of a light field and are chosen to select certain polarization states to pass through an optical system with a common output polarization state, while rejecting other undesired polarization states.

FIG. 48 shows the phasor representation of the orthogonal polarization basis.

FIG. 49 shows two example symmetry representations for theoretical discussion on arbitrary light polarization conversion.

FIG. 50 shows how coordinates change sign for backwards traveling waves.

FIG. 51 A shows a spherical shaped dimerized meta-atom with bi-axial crystal composition that is used in plurality in the formation of a polarization beam steering colloid.

FIG. 51 B shows an ellipsoidal shaped dimerized meta-atom with uniaxial crystal anisotropy and uniaxial shape anisotropy, which in combination form a bi-axial anisotropy and in combination are used in plurality the formation of a polarization beam steering colloid.

FIG. 51 C shows a spherically shaped dimerized meta-atoms with a first uniaxial crystal anisotropy and a second uniaxial crystal anisotropy, which in combination form a biaxial anisotropy and in combination are used in plurality the formation of a polarization beam steering colloid.

FIG. 51 D shows amorphous ellipsoidal and spherically shaped dimerized meta-atoms with a first uniaxial shape anisotropy and a second uniaxial crystal anisotropy, which in combination form a biaxial anisotropy and in combination are used in plurality in the formation of a polarization beam steering colloid.

FIG. 52 shows I-GRIN beam steering geometry in cross-section of a paper-thin colloid sheet between glass plates, where α₁ is the input angle, α₂ is the output angle, point (x_{c}, 0) is the center of the circular arc and coordinate origin, and β is the direction of the refractive index gradient. This figure is provided so the reader can understanding why prior art techniques, base on linear phase distributions, have failed for beam steering. Not to scale.

FIG. 53 shows the need for different blaze widths and refractive index gradient directions for I-GRIN beam steering, which has caused loss of performance in prior beam steering attempts.

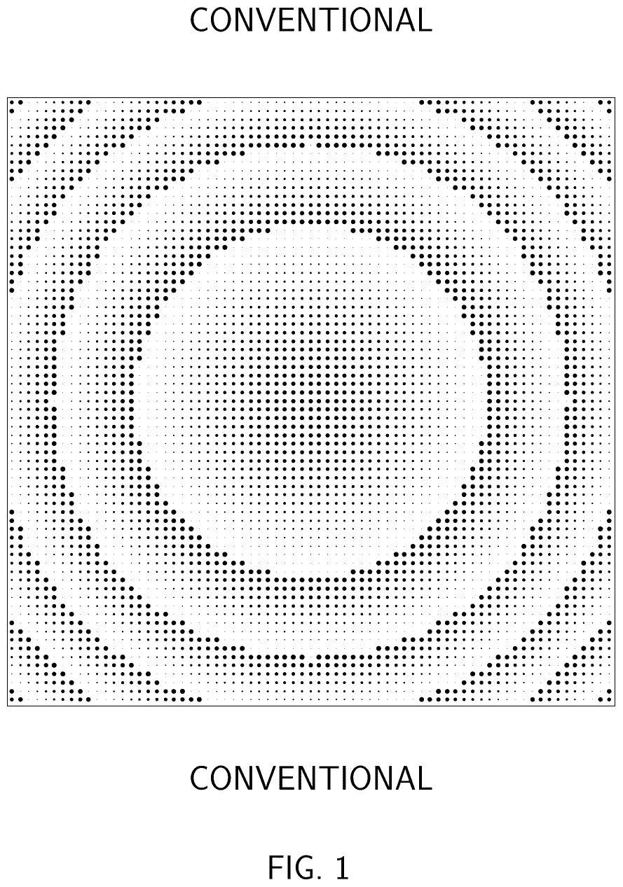

### SUMMARY

Optometaphoresis is optics changed by the migration of a (typically) large number of particles in a colloid. The migration is due to radio frequency (RF) signals injected into the colloid by a near-field micro-structured current-voltage-energized phased-array antenna-electrode that impress dielectrophoretic forces and torques on nanoparticles in the colloid. Unlike dielectrophoresis for biology [1], which tends to focus on manipulating a small number of cells, herein dielectrophoresis typically moves trillions of particles. This creates a fluidic metamaterial that affects the propagation of light in amazing new ways. The migration modalities of the particles include translation, orientation, and deformation of particles in a colloid. Optometaphoresis synthesizes the physical quantity that is central to all optics: Refractive Index (RI) at the nanoscale under software control. In this disclosure specialized segmented electrodes arrays are disclosed. These electrodes act as short-range antennas that inject RF energy into a colloid to provide dielectrophoretic forces and torques on nanoparticles to control the flow of light. This provides the same kind of electronic control over redirecting broadband electromagnetic radiation as phased arrays provide for narrow band electromagnetic radiation. In particular, by changing the current and voltage weighting functions across electrodes, the position and orientation of nanoparticles in a paper-thin colloid are controlled, and this provides almost complete and arbitrary control of RI and how light passes through a fluidic meta material. The system is hyper efficient because the viscous colloid is a kind of analog memory that retains its nanoparticle distribution without the continuous application of RF signals and energy. Light may be refracted, reflected, diffracted, guided, and even polarized within the optometaphoresis system all by bending the light to provide many more degrees of freedom than is possible by conventional optics. This operational flexibility combined with software programmability provides for many practical applications. Furthermore, in recent years there has been a tremendous technical effort by other researchers to create static metasurfaces that can provide new optics functionality in thin materials with engineered surfaces. This disclosure takes that trend to a new and more advanced level as it adds the significant functionality of dynamic reconfigurability to the metasurface to allow a significantly expanded set of optical functionality.

### Applications

A highly abridged list of potential applications includes: (1) large area solar concentration using solid-state optics instead of large mechanical heliostats. This can be used to provide intense industrial heat near 1,500° C. to replace fossil fuels in industries like cement manufacture, smelting steel, ammonia manufacture for fertilizers, and plastic manufacture. All of which currently provide up to 25% of global green house gas emissions. (2) LiDAR transceivers for autonomous (self-driving) vehicles. (3) Augmented, virtual, and mixed reality headsets that are compact and low cost. (4) The steering of high energy laser light for welding, cutting, drilling, and sintering for both subtractive and additive manufacturing. (5) Dynamic control of fiber lasers for generation of high energy light. (6) Energy distribution in mobile energy networks to power drones and other vehicles while in flight and motion along the ground. (7) Dense optical computer information storage. (8) Three dimensional holograph-like plasma displays. (9) Dynamic optical components such as lenses, holograms, optical couplers, optical splitters, and waveguides. (10) Passive optical components that are manufactured by optometaphoresis and then set by optical curing. (11) Dynamic metasurface optical elements that take the current trend in metasurface optics to an entirely new level of capability, including metasurfaces and meta-volumes that are completely reconfigurable, of exceptionally large area and capable of high-power handling. (12) Dynamic polarization imagers for remote sensing and other applications. (13) Cloaking of objects (e.g. a person) using camouflage surfaces that redirect light around the object to be hidden visually, thereby rendering the object substantially invisible. (14) Tomographic imaging of three dimensional particles for scientific and medical metrology. (15) Ultra-short pulse compression for metrology, plasma displays, communications, and inertial confinement fusion. (16) Metasurface lasers. (17) Both spin and orbital angular momentum generation and conversion for light. (18) Compact endoscopes that can also beam-steer light for surgery. (19) The making emerging photonic quantum computers compact and reconfigurable. (20) Photonic neural networks and “photonic-brain” chip-sets for generalized artificial intelligence. (21) Hybrid optics that exploit the fuzzy momentum of a confined quantum-scale metasurface with the beam steering of a metafilm for quantum computing with single photons. (22) Numerous other potentially high-value applications.

### THE WRITTEN DESCRIPTION

### Foundational Physical Principles

### Optometaphoresis

Optometaphoresis (OMP) is a word derived from the Greek language, which means visibility changed by migration. However, in the context of this document, where a new optical science is being introduced to the reader, it is to mean optics synthesized by migration of particles. In general, migration comprises at least one of particle translation, rotation, and deformation and often by means of diffusion. The emphasis herein is on rotation and orientation of NPs. The particles comprise at least one of amorphous particle materials, crystals, cage molecules (e.g. Bucky Balls), carbon and silicon polymers, Janus (two faced) particles, quantum dots, plasmonic dots, soft dispersed materials, particle-clusters, lithographically formed particles, plastic particles (e.g. polystyrene), and self-assembled particles like cells and viruses. The medium of migration being a liquid. Typically, migrations are due to dielectrophoresis, but may also include magnetophoresis, chemophoresis, acoustophoresis, thermophoresis, and other phoresis modalities.

The liquid used may be isotropic or it may be anisotropic, such as liquid crystals, and the liquids may or may not be Newtonian. The particles are small, e.g. roughly 3 nm to 30 nm scale (order of magnitude) nanoparticles for visible optics, but may be larger/smaller for controlling other wavelengths of electromagnetic radiation. The liquids may be highly viscus and/or solidified, e.g. by photo-optical curing, to lock-in structured particle distributions so that both active and passive-devices-of-manufacture are also included by this disclosure. Different operational modalities for the resulting fluidic metamaterial are possible, including: classical light control, by positive and negative RI, as well as quantum entanglement of light with the particles, liquid, and controlling signals. The resulting effective RI change may be at least one of isotropic and anisotropic for each of particle spatial distribution and for particle angular distributions.

### An Easy to Understand Analogy

The physics of light steering by nanoparticle orientation is a bit complex, so an easy-to-understand analogy is given first in this section to provide a means to appreciate what is going on in a simple way. This will help guide the reader when the math gets more complex later on. In particular, note that the light bending process described herein is mathematically similar to the differential geometry of Einstein's general relativity [2], where the mass in Einstein's theory is made analogous to changes in the natural log of the refractive index (ln n). Imagine a physics demonstration in a classroom where a large steel mass in the shape of a sphere is placed on a large, thin, strong, and freely suspended rubber sheet. The rubber sheet bends and dimples symmetrically in response to the weight, so a small test mass (e.g. a marble that casually represents a photon or light ray) launched along the rubber sheet near the larger mass will take a particular trajectory that deviates from a straight line. The orientation of the massive sphere is not important to the marble's trajectory because the large steel sphere is symmetrical.

In contradistinction, now imagine that the large steel sphere is replaced with a large steel American football having an oblong shape. The rubber sheet again bends in response, but the orientation of the football will provide a non-circular-symmetric bending of the rubber sheet and the resulting trajectory of the marble moving along the sheet will depend on the orientation of the football shaped mass relative to the marble.

In this document the use of a colloid with tens or hundreds of thousands of electrically non-spherical nanoparticles per cubic micron (or even a liquid crystal mixed with other NPs) is analogous to an asteroid field with many non-spherical and oblong asteroids. A marble pushed into the asteroid field is slightly deviated by each individual asteroid and the orientation of each asteroid makes a small difference to the final trajectory of the marble. In much the same way, many small deviations of a light ray due to changes of orientation of nanoparticles determines the trajectory of light.

What is amazing and new here is that continuous changes of orientation of nanoparticles are not a consumable resource, it is an infinite resource because nanoparticles can be rotated as much as needed at different spatial positions. This is unlike the changes in the density of a material used to make a gradient refractive index today's gradient refractive index lenses, which is a consumable quantity and highly limited! This is not a perfect analogy, but it is good enough for an introduction to the optics of this disclosure.

Additionally, this disclosure shows how to grab hold of (i.e. carry in a phoretic way) the nanoparticles electronically and rotate them as needed to encode a nanoparticle orientation field (i.e. like an asteroid field) that can give incident light almost any desired trajectory as it pass through the active medium (e.g. a colloid, or liquid crystal, or hybrid thereof) forming a metaphotonic system.

It is hoped that the reader will appreciate that like all analogies there is a limit to how far to take this analogy. For example, the analogy provided above does not account for the polarization of light or for the impacts of dispersion on the energy velocity. Also, light can scatter off of a nanoparticle, effectively moving through the particle, but a test mass impacting a larger mass will interact differently. Nonetheless, the above-discussed model is a good (and simplistic) place to start in the process of understanding and it works as an analogy for translation, rotation, and deformation of particles.

### The Scope of Dielectrophoresis

The name dielectrophoresis (DEP) is composed of three morphemes: di-, which comes from the latin and means “apart from;”-electro-, which comes of the Greek word amber and relates to phenomena associated with electrons that may be rubbed off thereof by the triboelectric effect; and -phoresis, which comes from the Greek language and means “to carry around” or “migrate.” Thus, dielectrophoresis means that which is apart from a single electron or charge and which provides a means to move or carry around. It should be noted that the morpheme di- can also come from the Greek, and when it does it means a quantity of two, which is cognate with the prefix bi-. Finally, the prefix di- also has a second meaning in the Greek, which is “through and in different directions.” Thus, DEP is a phenomena that does not apply to materials with a built-in single charge (like ions), but which does allow pairs of induced charges (i.e. an a dipole moment) to assist in carrying and manipulating particles in other media—e.g. a liquid, gas, etc.

The meaning of dielectrophoresis continues to evolve. Variations of dielectrophoresis include: standing wave dielectrophoresis (sDEP), traveling wave dielectrophoresis (tDEP or twDEP), negative dielectrophoresis (nDEP) where particles translate opposite to the gradient of the electric field, positive dielectrophoresis (pDEP) where particles translate in the direction of the gradient of the electric field, rotational dielectrophoresis (rDEP), electro rotation (ROT or EROT), orientational dielectrophoresis (oDEP), and others.

This proliferation of terms over time is an indication of a healthy and growing field where new insights are constantly developing. Thus, the word “dielectrophoresis” from the 1970's does not hold the same nuanced meaning as “dielectrophoresis” in the 2020's. Originally, dielectrophoresis was developed by Prof. Herb Pohl and his graduate students at Oklahoma State University (USA) around 1966 and was originally associated with translation of a particle (e.g. a blood cell) due to a nonuniform electric field. However, now around 2022 it can also include rotation, orientation, and deformation of a particle. With so many potential types of dielectrophoresis it often makes sense to talk about a generalized dielectrophoresis (gDEP) that includes all possible phenomena. When the specific form of dielectrophoresis is not obvious from the context of the writing then the casual term dielectrophoresis (DEP) will mean gDEP in this document. The reader is cautioned that different authors may introduce their own notation for the different types of gDEP modes of operation. DEP is considered in more detail later in the document as its application is central to the design of electrodes to implement OMP.

### At Least Two Frequency Bands

For the avoidance of doubt, for optical applications there are two temporal frequency bands: the DEP frequencies that are often (but not necessarily) in the range of 1 KHz to 1 GHz and the optical frequencies that are often (but not necessarily) in the range of 430 THz-750 THz (terahertz). The primary characteristic is that these frequency domains are so far apart that a material's constitutive parameters are often much different at the different frequency bands. Thus, controlling optical processes by DEP are (roughly speaking) a two frequency band process. Other “optical” frequency bands are also possible, e.g millimeter-wave optics, though particles deployed are larger than for the visible spectrum. Thus, the use of the term “nanoparticles” or NPs should not be interpreted so strictly that, for example, the control of millimeter wave light by micron scale (or larger) particles is excluded. It is also possible to use the “optical tweezer effect” to manipulate particles so that laser light can control other forms of light, but that is not the focus of this disclosure.

### Depolarization, Polarizability, & Clausius-Mossotti Tensors

Consider a liquid medium with solid particles in suspension to form a colloid, and an input electric field Eᵢₙ passing though this charge-neutral mixture. The electric field induces charge separation. At an arbitrary time we “mathematically freeze” the positions of the particles and charges. Associated with the particle is Eₚₐᵣ and associated with the cavity is E_{cav}, such that Eᵢₙ=Eₚₐᵣ+E_{cav} as discussed by Feynman [3, 4]. The positive and negative charges on a particle form dipoles moments that, when spatially averaged by integration, provide [symbol] pₚₐᵣ [symbol] = [symbol] M_{zz}p_{z}, M_{yy}p_{y}, M_{zz}p_{z} [symbol] =Mpₚₐᵣ. Where pᵢ are the products of the charge magnitude times the maximum spatial separation. The unitless quantity M̅ is called the depolarization tensor, where M̅=diag(Mₓₓ, M_{yy}, M_{zz}), with Mᵢᵢ∈[0,1] and diag means diagonal matrix. M̅ may be thought of as a deviation from the maximum possible dipole moment in a particular direction and it depends on particle shape and not on the particle size. Note, if we use angle brackets for average quantities, then the spatial average [symbol] Pₚₐᵣ [symbol] =N [symbol] pₚₐᵣ [symbol] =N(M̅pₚₐᵣ)=M̅Pₚₐᵣ, where N is the number of particles per unit volume. Also, because polarization is in the opposite direction to the electric field Eₚₐᵣ=−M̅Pₚₐᵣ/∈_{med}, where ∈_{med} is the medium permittivity. This is described in great detail in this author's G2 patent application, as referenced earlier in this document.

However, in overview, consider a sphere with input electric field Eᵢₙ=Eᵢₙ\hat{z}. Let θ be the polar angle and ϕ the azimuth angle. Then there is a separation of charges q(θ)=q₀ cos θ by a chord length d(θ)=d₀ cos θ so that p(θ)=q(θ)d(θ)\hat{z}. The average dipole moment is then

$$〈 {p}_{p a r} 〉 = \frac{1}{4 π} {\int }_{ϕ = 0}^{2 π} {\int }_{θ = 0}^{π} ( {q}_{0} {d}_{0} \hat{z} ) {cos}^{2} θsinθ d ϕ d θ = ( {q}_{0} {d}_{0} \hat{z} ) / 3.$$

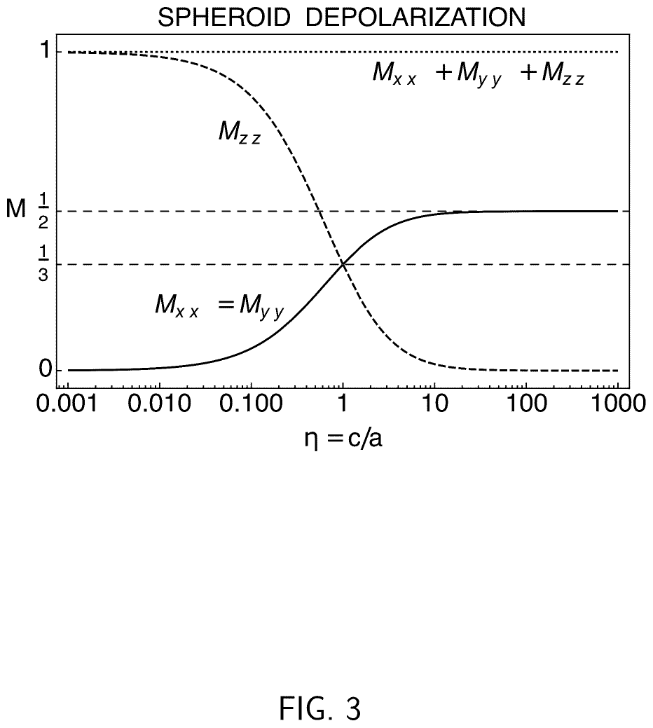

The symmetry of the sphere then gives the depolarization as M̅(sphere)=diag(1/3,1/3,1/3). A detailed analysis based on reference [5] and the G2 patent application is shown in FIG. 3 and clearly shows that particle shape is directly related to depolarization.

The cavity field may be thought of as inducing the electric polarization of the particle when the particle is replaced back into the cavity. Therefore, the cavity field is obtained in terms of the input field by subtracting the particle field

$${E}_{i n} = {E}_{cav} + {E}_{p a r} = {E}_{cav} - \frac{{M}^{\overline{\_}} {P}_{p a r}}{{ϵ}_{m e d}} = [ {I}^{\overline{\_}} - {M}^{\overline{\_}} ( N {α}^{\overline{\_}} ) ] {E}_{cav} \qquad ( 1 )$$

where the definition of the electric polarizability tensor Pₚₐᵣ≡∈_{med}(Nα̅)E_{cav} was used in the last equality and now used again by solving Eq. 1 for E_{cav}

Pₚₐᵣ=∈_{med}(Nα̅)[I̅−M̅(Nα̅)]⁻¹Eᵢₙ≡∈_{med}χ̅Eᵢₙ. (2)

Therefore, the electric susceptibility tensor is given by

χ̅=(Nα̅)[I̅−M̅(Nα̅)]⁻¹, (3)

which when normalized by M̅ gives a quantity called the Clausius-Mossotti tensor K̅=M̅χ̅. The electric susceptibility tensor and Clausius-Mossotti tensor characterize DEP based forces and torques, which are used to electronically control the distribution of NP positions and orientations during forced diffusion. The reader may consider the separate components of the frequency response of the complex electric susceptibility χ̅ as Bode frequency response curves.

For Maxwell's equations written in the phasor domain, we may take

∈=∈_{R}−i∈_{I} (4)

σ=σ_{R}−iσ_{I} (5)

Also taking the free current density as J_{f}=σ_{f}E then form Maxwell's equations we find that the effective permittivity is

$$\tilde{ϵ} ( r , ω ) = {ϵ}_{R} ( r , ω ) - i \{ {ϵ}_{I} ( r , ω ) + \frac{{σ}_{f} ( r , ω )}{ω} \} \qquad ( 6 )$$

However, in practice we can take the imaginary parts ∈_{I}≈0 and σ_{I}≈0 and make reasonable assumption that the permittivity is far away from a material resonance, as provided in the Lorentz model of a dielectric. Thus, we have the colloid embedding medium and included particle permittivities as

$${ϵ}_{m e d} = {ϵ}_{m R} - i \frac{{σ}_{m R}}{ω} \qquad ( 7 )$$

$${ϵ}_{p a r} = {ϵ}_{p R} - i \frac{{σ}_{p R}}{ω} . \qquad ( 8 )$$

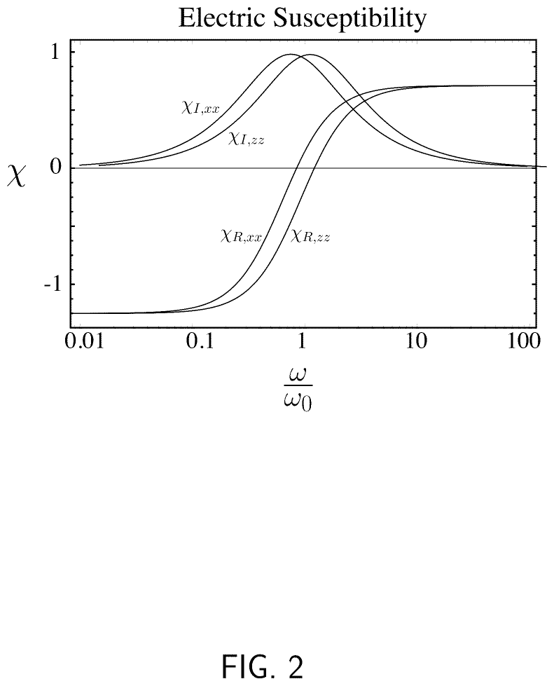

Plugging in Eqs. 7-8 into Eq. 3 and only writing out the individual components of the diagonal matrix for χ̅ as

$$χ \approx N α = {\underbrace{{K}_{∞} + \frac{{K}_{0} - {K}_{∞}}{1 + {τ}_{M W}^{2} {ω}^{2}}}}_{{χ}_{R}} + i {\underbrace{\frac{[ {K}_{∞} - {K}_{0} ] {τ}_{M W} ω}{1 + {τ}_{M W}^{2} {ω}^{2}}}}_{{χ}_{I}} . \qquad ( 9 )$$

where i=\sqrt{−1}. The resulting parameters of the electric susceptibility are

$${K}_{0} = \frac{{σ}_{p R} - {σ}_{m R}}{M {σ}_{p R} + ( 1 - M ) {σ}_{m R}} \qquad ( 10 )$$

$${K}_{∞} = \frac{{ϵ}_{p R} - {ϵ}_{m R}}{M {ϵ}_{p R} + ( 1 - M ) {ϵ}_{m R}} \qquad ( 11 )$$

$${τ}_{M W} = \frac{M {ϵ}_{p R} + ( 1 - M ) {ϵ}_{m R}}{M {σ}_{p R} + ( 1 - M ) {σ}_{m R}} \qquad ( 12 )$$

where it is understood that M in the above equations can take on the values {Mₓₓ, M_{yy}, M_{zz}} so that χ takes on the values of {χₓₓ, χ_{yy}, χ_{zz}} respectively. Also, for crystalline particles it is appropriate to take ∈ₚR and ∈ₘR as the components of the permittivity in the eigen basis of the particle symmetry basis. Thus, the particles can be anisotropic by both material composition and geometry. The above explicit relations to calculate χ̅ are very useful for force and torque calculations of dielectrophoresis when the NP volume fraction is low, as is usually the case in optometaphoresis. Some example curves are provided for the real and imaginary parts of the electric susceptibility in FIG. 2.

Finally, let's write the electric displacement as Dᵢₙ=∈_{med}Eᵢₙ+Pₚₐᵣ=∈̅ₚₐᵣEᵢₙ, where ∈̅ is the tensor permittivity. This generalizes the typical definition where ∈_{med}=∈₀ and is done to account for the interaction scale. For RI calculations light propagates between atoms and molecules in a background vacuum and ∈_{med}=∈₀. However, when discussing DEP the fields interact with particles through a background liquid ∈_{med}=∈_{L}. It can be shown that this shortcut works, and again it may be thought of using problem-scale strategically. Consequently, Pₚₐᵣ=(∈̅ₚₐᵣ−I̅∈_{med})Eᵢₙ, where I̅ is the unity tensor. This result is substituted into Eq. 2 and rearranged so that

Nα̅=[∈̅ₚₐᵣM̅+∈_{med}(I̅−M̅)]⁻¹(∈̅ₚₐᵣ−I̅∈_{med}). (13)

The electric polarizability tensor is used in the next section for averaging RI of a mixture comprising different liquid and solid NPs.

### Refractive Index of Anisotropic Colloids

An expression is needed for the RI of a colloid as a function of particle volume fraction and orientation. It is tacitly assumed that all the NPs in a differential volume (1) are much smaller than the wavelength, (2) are orientated in the same direction, (3) are uniformly spaced, and (4) have coordinate basis of the NP principle axis. The last assumption is later relaxed. For a number ω_{L} liquid molecules and a number ω_{P} solid NPs in suspension the average polarizability is a weighted sum

$$〈 {α}^{\overline{\_}} 〉 = \frac{{w}_{L} {{α}^{\overline{\_}}}_{L} + {w}_{P} {{α}^{\overline{\_}}}_{P}}{{w}_{L} + {w}_{P}} . \qquad ( 14 )$$

However, the ratio ω_{L}(ω_{L}+ω_{P})=N_{L}ν_{L} and ω_{P}/(ω_{L}+ω_{P})=N_{P}ν_{P}, where ν_{L} and ν_{P} are the volume fractions of the liquid and NPs satisfying ν_{P}, which satisfy ν_{L}+ν_{P}=1. Therefore,

[symbol]

Nα̅ [symbol] =ν_{L}(N_{L}α̅_{L})+ν_{P}(N_{P}α̅_{P}). (15)

Equation 15 is a tensor Lorentz-Lorenz mixing equation. For optics, light is traveling in a vacuum between atomic and molecular particles, therefore ∈_{med}=∈₀. Assuming that the material comprising a NP is an isotropic material, i.e. without a crystal structure, then ∈̅ₚₐᵣ=∈₀∈_{P}I̅ is a diagonal matrix, and by Eq. 13

$$N {α}^{\overline{\_}} = diag [ \frac{{ϵ}_{P} - 1}{{ϵ}_{P} {M}_{x x} + ( 1 - {M}_{x x} )} , \frac{{ϵ}_{P} - 1}{{ϵ}_{P} {M}_{y y} + ( 1 - {M}_{y y} )} , \frac{{ϵ}_{P} - 1}{{ϵ}_{P} {M}_{z z} + ( 1 - {M}_{z z} )} ] \qquad ( 16 )$$

where ∈_{P} is the relative permittivity of the particles. Thus, particle shape strongly influences the polarizability and thus the scattering of light. Each diagonal term takes the form Nαₘₘ=(∈_{P}−1)/(∈_{P}Mₘₘ+(1−Mₘₘ)). To simplify notation, temporarily set Mₘₘ→M, then diagonal matrix elements of Eq. 15 satisfy

$$\frac{{n}^{2} - 1}{{n}^{2} M + 1 - M} = ( \frac{{n}_{L}^{2} - 1}{{n}_{L}^{2} {M}_{L} + 1 - {M}_{L}} ) {ν}_{L} + ( \frac{{n}_{P}^{2} - 1}{{n}_{P}^{2} {M}_{P} + 1 - {M}_{P}} ) {ν}_{P} \qquad ( 17 )$$

where the effective RI is n²=∈, the liquid RI is n_{L}²=∈_{L}, and the particle RI is n_{P}²=∈_{P}. The terms of the form (n²−1)/[n²M+(1−M)], when Taylor expanded about n=1, only contain M in terms to second order in n. A first-order theory in n requires retaining only n² terms in Eq. 17, which provides a good numerical approximation for small NP volume fractions. The resulting first order expansion about n=1 contains factors of M. So starting with

$$\frac{{n}^{2}}{{n}^{2} M + 1 - M} \approx ( \frac{{n}_{L}^{2}}{{n}_{L}^{2} {M}_{L} + 1 - {M}_{L}} ) {ν}_{L} + ( \frac{{n}_{P}^{2}}{{n}_{P}^{2} {M}_{P} + 1 - {M}_{P}} ) {ν}_{P} \qquad ( 18 )$$

n has an error much less 4% of Eq. 17 when ν_{P}≤10%. Most practical colloids have ν_{P}˜1%, so this is a very good with errors typically less then 1%. This low error is consistent with the ansatz M=M_{L}ν_{L}+M_{P}ν_{P}, therefore on expanding Eq. 18

[−M+M_{L}ν_{L}+M_{P}ν_{P}]+{−n(1−M)+(1−M_{L})n_{L}ν_{L}+(1−M_{P})n_{P}ν_{P}}=0 (19)

where square brackets items are set to zero via the ansatz. Solving for effective RI we get the components of the RI tensor n and supporting equations

$$n = {n}_{L} {σ}_{L} {ν}_{L} + {n}_{P} {σ}_{P} {ν}_{P} \qquad ( 20 )$$

$${σ}_{L} {ν}_{L} + {σ}_{P} {ν}_{P} = 1 \qquad ( 21 )$$

$${ν}_{L} = \frac{{V}_{L}}{V} , {ν}_{P} = \frac{{V}_{P}}{V} \qquad ( 22 )$$

$${σ}_{L} = \frac{{S}_{L}}{S} , {σ}_{P} = \frac{{S}_{P}}{S} \qquad ( 23 )$$

$$S = 1 - M , {S}_{L} = 1 - {M}_{L} , {S}_{P} = 1 - {M}_{P} \qquad ( 24 )$$

$$M = {M}_{L} {ν}_{L} + {M}_{P} {ν}_{P} \qquad ( 25 )$$

$${ν}_{L} + {ν}_{P} = 1 \qquad ( 26 )$$

which in the diagonal-matrix eigen symmetry basis is generalized to

$${n}^{\overline{\_}} = {{n}^{\overline{\_}}}_{L} {{σ}^{\overline{\_}}}_{L} {ν}_{L} + {{n}^{\overline{\_}}}_{P} {{σ}^{\overline{\_}}}_{P} {ν}_{P} \qquad ( 27 )$$

$${{σ}^{\overline{\_}}}_{L} {ν}_{L} + {{σ}^{\overline{\_}}}_{P} {ν}_{P} = 1 \qquad ( 28 )$$

$${{σ}^{\overline{\_}}}_{L} = \frac{{{S}^{\overline{\_}}}_{L}}{{S}^{\overline{\_}}} , {σ}_{P} = \frac{{{S}^{\overline{\_}}}_{P}}{{S}^{\overline{\_}}} \qquad ( 29 )$$

$${ν}_{L} = \frac{{V}_{L}}{V} , {ν}_{P} = \frac{{V}_{P}}{V} \qquad ( 30 )$$

$${S}^{\overline{\_}} = {I}^{\overline{\_}} - {M}^{\overline{\_}} , {{S}^{\overline{\_}}}_{L} = {I}^{\overline{\_}} - {{M}^{\overline{\_}}}_{L} , {{S}^{\overline{\_}}}_{P} = {I}^{\overline{\_}} - {{M}^{\overline{\_}}}_{P} \qquad ( 31 )$$

$${M}^{\overline{\_}} = {{M}^{\overline{\_}}}_{L} {ν}_{L} + {{M}^{\overline{\_}}}_{P} {ν}_{P} \qquad ( 32 )$$

$${ν}_{L} + {ν}_{P} = 1 \qquad ( 33 )$$

where division by a square diagonal matrix is allowed because the individual diagonal terms are simply inverted according to

$${{S}^{\overline{\_}}}^{- 1} = \frac{1}{{S}^{\overline{\_}}} = [ \begin{matrix}\frac{1}{{s}_{x x}} & 0 & 0 \\ 0 & \frac{1}{{s}_{y y}} & 0 \\ 0 & 0 & \frac{1}{{s}_{z z}}\end{matrix} ] \qquad ( 34 )$$

Also, the shape factor matrix components for the liquid are σ_{L}=(1−M_{L})/(1−M) and for the NPs are σ_{P}=(1−M_{P})/(1−M), where M_{L} and M_{P} come from FIG. 3 and are a function of the aspect ratio η=c/a of the solid and liquid particles. It also follows with a little algebra that σ_{L}ν_{L}+σ_{P}ν_{P}=1, which can be used to write n̅=n_{L}I̅+(n_{P}−n_{L})ν_{P}σ̅_{P}. This may be generalized so that from point-to-point in the colloid the NPs smoothly changes volume fraction and orientation. Therefore, ν_{P}=ν_{P}(r) and introduce a rotation matrix R̅(r) that changes the orientation of the NPs from point-to-point, where r is the position vector in the laboratory frame of reference, i.e. not the principal axis frame of reference of the NPs. Therefore, by an active rotation transformation

n̅(r)=R̅(r)n̅₀(r), (35)

where n̅₀(r) is the RI in the diagonalized eigen symmetry basis

n̅₀(r)≈n̅_{L}+(n̅_{P}−n̅_{L})ν_{P}(r)σ̅_{P}, (36)

which takes the form n̅₀(r)=diag [n_{A}, n_{B}, n_{C}] for bi-axial anisotropy. This expression can also be extended to colloids with more than one type of particle by adding the appropriate extra terms as needed. For example, this allows for both positive and negative material dispersion particles to work together to cancel material dispersion and remove chromatic aberrations from optical systems. In the important case when n_{A}=n_{B}=nₒ(ordinary wave polarization) and n_{c}=nₑ (extraordinary wave polarization) then there is a uniaxial anisotropy and n̅₀(r)=diag [nₒ, nₒ, nₑ]. Most of the emphasis in this document is for uniaxial materials, however this does not diminish the generality of the disclosure to include bi-axial anisotropy as well. The one notable exception, where bi-axial anisotropy is discussed later, is for dynamic polarization control.

In U.S. Patent Application 20210208469 entitled, “Light Control by Means of Forced Translation, Rotation, Orientation, and Deformation of Particles Using Dielectrophoresis,” the current author provides a detailed calculation for the depolarization M̅, the results of which are provided here for the reader's convenience. In particular, in the limit of substantially oblate, prolate, and spherical spheroids we have the approximations

$${M}^{=} ( Oblate ) = [ \begin{matrix}0 & 0 & 0 \\ 0 & 0 & 0 \\ 0 & 0 & 1\end{matrix} ] \qquad ( 37 )$$

$${M}^{=} ( Prolate ) = [ \begin{matrix}\frac{1}{2} & 0 & 0 \\ 0 & \frac{1}{2} & 0 \\ 0 & 0 & 0\end{matrix} ] \qquad ( 38 )$$

$${M}^{=} ( Sphere ) = [ \begin{matrix}\frac{1}{3} & 0 & 0 \\ 0 & \frac{1}{3} & 0 \\ 0 & 0 & \frac{1}{3}\end{matrix} ] \qquad ( 39 )$$

and the resulting expressions that use the tensor depolarization factor simplify substantially. If in the eigen basis of the NPs we take the x, y, and z NP radii as a, b, and c respectively, then in general, for the spacial case of symmetric prolate and oblate spheroid NPs (where a=b≠c) we find that Mₓₓ=M_{yy} and if we define a new variable η=c/a as the ratio of the z-axis radius c to the x-axis radius a, then the depolarization components in the eigen symmetry basis are

$${M}_{x x} = {M}_{y y} = \frac{1}{2} - \frac{1}{2 ( 1 - {η}^{2} )} + \frac{η {cos}^{- 1} η}{2 {( 1 - {η}^{2} )}^{3 / 2}} \qquad ( 40 )$$

$${M}_{z z} = \frac{1}{1 - {η}^{2}} - \frac{η {cos}^{- 1} η}{{( 1 - {η}^{2} )}^{3 / 2}} \qquad ( 41 )$$

See the plot of above equations in FIG. 3. Also, note that any imaginary parts that may arise during the calculation of the components of M̅ in the above expressions cancel leaving a pure real number. On computers, some care must be exercised to remove tiny imaginary components that are a result of a computer's limited precision due to representing number by a finite number of bits. This numerical error is easily removed simply by ignoring any tiny imaginary parts in the above expressions for the components of M̅. Thus, for symmetric NPs defined by the ratio of the axial radii η=c/a

$${M}^{=} = [ \begin{matrix}{M}_{x x} & 0 & 0 \\ 0 & {M}_{y y} & 0 \\ 0 & 0 & {M}_{z z}\end{matrix} ] = diag [ {M}_{x x} , {M}_{y y} , {M}_{z z} ] \qquad ( 42 )$$

A numerical example will help the reader appreciate this important material. Consider polystyrene NPs in aqueous suspension at about 500 nm wavelength. Then material composition gives

n̅_{L}=diag[1.333,1.333,1.333] (43)

n̅_{P}=diag[1.600,1.600,1.600]. (44)

The liquid water molecules, at many different random orientations, are taken on average as spherical and the NPs are prolate spheroidal with a=b=10 nm, and c=40 nm then η=c/a=4 so by Eqs. 40-41 we have

M̅_{L}=diag[1/3,1/3,1/3] (45)

M̅_{P}=diag[0.4623,0.4623,0.0754] (46)

Notice that M̅_{P} is not too far from the ideal of an infinitely long prolate spheroid given by M̅(Prolate) in Eq. 38 and the approximation becomes better the more elongated the NP becomes. Next, let's assume that the volume fraction of NPs is 10%. Then by Eq. 33 we have that ν_{P}=0.1 and ν_{L}=0.9 so that by Eqs. 27-33

M̅=diag[0.3346,0.3346,0.3308] (47)

S̅=diag[0.6654,0.6654,0.6692] (48)

S̅_{L}=diag[2/3,2/3,2/3] (49)

S̅_{P}=diag[0.5377,0.5377,0.9246] (50)

and therefore the shape factor matrices are

σ̅_{L}=diag[1.02,1.02,0.9628] (51)

σ̅_{P}=diag[0.8225,0.8225,1.3352]. (52)

Thus, the RI matrix in the eigen symmetry basis is given by Eq. 36 as

n̅(Prolate)=diag[1.5727,1.5727,1.6804] (53)

which is uniaxial and has a positive birefringence of (1.6804-1.5727)=0.1077. If instead of a prolate spheroid with η=4 we instead choose NPs that are oblate with a=b=40 nm and c=10 nm then η=1/4 and

n̅(Oblate)=diag[1.661,1.661,1.4988] (54)

which is uniaxial and has a negative birefringence of (1.4988−1.661)=−0.1622. Thus, the oblate spheroid has over a 50% increase in the magnitude of the birefringence compared to the prolate spheroid with similar parameters.

While both prolate and oblate spheroids (and shapes of similar and alternate forms) can be used in anisotropic beam steering of light it is generally true that geometry anisotropy is most pronounced for the oblate spheroid. Oblate spheroids are therefore more impactful in bending and redirecting light compared to prolate spheroids in anisotropic optical systems. This may not be the case if the NPs are also crystalline, which also introduces material anisotropy into the colloid.

### Crystal Optics

Equation 36 is rather amazing. It provides a means to find the effective RI, in the eigen symmetry basis, comprising an isotropic or anisotropic liquid (e.g. a common anisotropic liquid is a liquid crystal) that is mixed with at least one of (typically larger) particles that are materially isotropic or anisotropic (e.g. crystal particles of titanium dioxide), and particles that are geometrically isotropic or anisotropic. The only real assumption is that all identical particles in the colloid are orientated in the same direction. This NP orientation assumption need only exist from one differential volume to the next differential volume, as is developed later in this disclosure. Moreover, it is the state that the colloid will be in after DEP interactions have caused rotational diffusion of NPs into a steady state after the optometaphoresis system is turned on and allowed to settle for perhaps a fraction of a second.

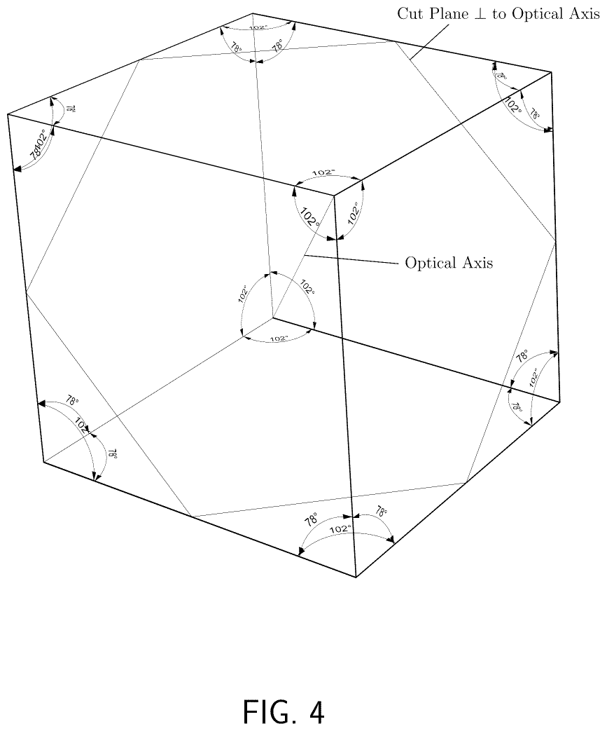

Before addressing how to connect one differential volume to neighboring differential volume, for the purposes of predicting ray trajectory, it is important to first understand the general principles of crystal optics [6, 7]. As an example of a crystal, consider a large bulk rhomb of calcite (perhaps having several centimeter edge lengths) that is shown in FIG. 4. The rhomb's shape represents the underlying atomic structure (not shown) of the crystal. In the case of calcite there are only two corners that have every edge angle of about 102°. Other corners have at least one angle of about 78°. The line between the two corners having every edge angle equal to about 102° forms the optical axis and the plane that is a perpendicular cut of the optical axis is not a simple cut parallel to a rhomb face, as can be seen in the figure. The optical axis defines an underlying electromagnetic and optical symmetry. This optical axis is present even if the rhomb is mechanically or chemically reshaped into a sphere (or spheroid) and the resulting object decreased in size into the nanoscale. Other crystal habits will occur for other materials, such as titanium dioxide and crystalline silicon, however there will be one optical axis for uniaxial crystals and two optical axis for biaxial crystals.

From an electromagnetic perspective, an electric field that is perpendicular to the optical axis will always encounter the same RI independent of the orientation of the electric field about the optical axis. An electromagnetic wave that provides such an electric field is called an ordinary wave. In contradistinction, an electromagnetic wave that provides its magnetic field as perpendicular to the optical axis will provide an extraordinary wave and there is an anisotropic RI. In this disclosure, many spherically shaped anisotropic crystal NPs, or non-spherical shaped homogeneous NPs are used to create a dynamic and synthetic crystal, a fluidic meta material, in the form of a suspension of NPs, to control the propagation direction of light. Of course even combinations of non-spherical crystal NPs are also possible. However complex this optical process may become, at its core is the physics of crystal optics, in an average sense, as captured in Eq. 36.

These matters are now made more precise by considering Maxwell's equations

$$∇ \times E = - \frac{\partial B}{\partial t} \qquad ( 55 )$$

$$∇ \times H = + \frac{\partial D}{\partial t} + J \qquad ( 56 )$$

where the electric field intensity is E [V/m], and the magnetic field intensity is H [A/m]. To include the effect of the fields on materials and the effects of materials on the fields we introduce the electric field density (i.e. the displacement) D [C/m²] and the magnetic field density (i.e. the induction) B [Wb/m²]. Given that the divergence of a field that only circulates is zero, i.e. that ∇·(∇×E)≡0 is an identity, and similarly for H we find that ∇·B=0 and that ∇·J=−∂ₜ(∇·D), and we can identify that ∇·D=ρ, where ρ is the free charge density.

Both D and B are material properties. For linear optical materials, where the field strengths are not too large, we can write

D=∈₀E+P=∈̅E (57)

B=μ₀H+M=μ̅H (58)

where the electric polarization density is P [C/m³] and the magnetization density is M [Wb/m²] (not to be confused with the depolarization M̅).

The external power that is expended to support a field is F·ν, where the force F is in units of [N], and the charge velocity ν is in units of [m/s]. The volume forces are in general

$$F = {\underbrace{ρ E + J \times B}}_{Lorentz Forces} + {\underbrace{P \cdot ∇ E + M \cdot ∇ H}}_{Kelvin Forces} \qquad ( 59 )$$

Notice that the Kelvin Forces are associated with the dielectrophoresis and megnetophoresis of particle translation, which are assumed to be small in this disclosure as the dielectrophiesis of rotation is the primary phenomena discussed herein.

Therefore, on inserting the Lorentz force law F=ρE+J×B, having units of [N/m³], into the expression for power density we get

$$\frac{Power}{Volume} = F \cdot v ≡ J \cdot E \qquad ( 60 )$$

so that on solving Maxwell's equations for J and inserting into the above expression we obtain conservation of energy via

$$\frac{\partial u}{\partial t} + ∇ \cdot S = J \cdot E \qquad ( 61 )$$

$$u = \frac{1}{2} ( E \cdot D + H \cdot B ) \qquad ( 62 )$$

$$S = E \times H \qquad ( 63 )$$

where the energy density is u [J/m³] and the Poynting vector is S [W/m²].

For harmonic signals we have that

E=E₀e^{i(ωt-k·r)} (64)

H=H₀e^{i(ωt-k·r)} (65)

and after plugging this back into the source-free Maxwells' equations we find that

k×E=ωμ̅H (66)

k×H=−ω∈̅E (67)

or equivalently that

$$H = ( \frac{k}{ω {μ}_{0}} ) \hat{k} \times E \qquad ( 68 )$$

$$D = - ( \frac{k}{ω} ) \hat{k} \times H \qquad ( 69 )$$

where \hat{k} is the unit vector of k. Clearly, we must have that

H⊥k and D⊥k. (70)

Next, observe that we can plug Eq. 68 into Eq. 69 to show that

$$D = ( \frac{- {k}^{2}}{{ω}^{2} {μ}_{0}} ) [ \hat{k} ( \hat{k} \cdot E ) - E ] \qquad ( 71 )$$

where \hat{k} is the unit vector in the direction of the vector wave number k. This relation says that

D spans k and E in a plane. (72)

Additionally, the energy density of Eq. 62 can be broken up into two parts: electric energy density and magnetic energy density. For systems that have anisotropic RI the electric displacement energy density is u_{D}=E·D/2, where E=∈̅⁻¹D which is a constant in a homogeneous anisotropic medium. Therefore, in the diagonal eigen symmetry basis of c we can write

$$\frac{{D}_{x}^{2}}{{ϵ}_{x x}} + \frac{{D}_{y}^{2}}{{ϵ}_{y y}} + \frac{{D}_{z}^{2}}{{ϵ}_{z z}} = 2 {ε}_{0} {u}_{D} \qquad ( 73 )$$

where {∈ₓₓ, ∈_{yy}, ∈_{zz}} are the relative permittivities and ∈₀ is the permittivity of freespace. Therefore, on making the substitution x′=Dₓ/\sqrt{2∈₀u_{D}} and n_{A}²=∈ₓₓ and similar for y′ and z′ so that the representation ellipsoid, i.e. the coordinate indicatrix, is written as

$${( \frac{{x}^{′}}{{n}_{A}} )}^{2} + {( \frac{{y}^{′}}{{n}_{B}} )}^{2} + {( \frac{{z}^{′}}{{n}_{C}} )}^{2} = 1 \qquad ( 74 )$$

where the primes indicate the diagonal eignen symmetry basis. Notice that D=∈̅E and that the polarization of the optical field is along E.

Next we consider meaning of the trajectory of a ray and assert that there are in fact phase-rays, group-rays, and energy rays. In particular, if k is the wave vector, and w the radian frequency then the phase velocity, group velocity, and energy velocity are associated with different kinds of rays. These velocities are, respectively, given as

$${v}_{p} = \frac{ω}{k} \hat{k} \qquad ( 75 )$$

$${v}_{g} = \frac{\partial ω}{\partial k} \approx {∇}_{k} ω ( k ) \qquad ( 76 )$$

$${v}_{e} = \frac{S}{u} ≡ {∇}_{k} ω ( k ) . \qquad ( 77 )$$

The phase velocity tracks the crest of a sine wave. As the wave moves k·r−ωt=const. a constant. On taking the implicit derivative with time this gives the definition of Eq. 75. For group velocity we use superposition to generate a wave-packet with wave-numbers clustered about a central value so that the wave amplitude is

$$A ( r , t ) = {\int \int \int }_{- ∞}^{+ ∞} {d}^{3} k A ( k ) {e}^{i ( k \cdot r - ω t )} , \qquad ( 78 )$$

but to first order a Taylor expansion is ω(k)≈ω(k₀)+(k−k₀)·∇ₖω(k) so that

$$A ( r , t ) \approx {\underbrace{{e}^{i [ {k}_{0} \cdot r - ω ( {k}_{0} ) t ]}}}_{Phase Wave} {\underbrace{{\int \int \int }_{- ∞}^{+ ∞} {d}^{3} k A ( k ) {e}^{i ( k - {k}_{0} ) \cdot ( r - {∇}_{k} ω ( k ) t )}}}_{Group Wave} \qquad ( 79 )$$

and an implicit time derivative of r−∇ₖω(k)t=const. provides the approximate group velocity of Eq. 76.

While the group velocity is only approximate and depends on the validity of a Taylor expansion in its derivation, the energy velocity is an exact quantity and provides a means to track the energy of a ray in a crystal. In particular, from Eqs. 66-67 we can take differentials so that

δk×E+k×δE=δwμ̅H+ωμ̅δH (80)

δk×H+k×δH=δw∈̅E+ω∈̅δE (81)

Then, on taking the inner product of Eq. 80 with H, taking the inner product of Eq. 81 with E, using the identity A·(B×C)=B·(C×A)=C·(A×B), subtracting the resulting equations, and using Maxwell's equations from Eqs. 66-67 we obtain

$$δ ω \frac{1}{2} ( H \cdot B + E \cdot D ) = δ k \cdot ( E \times H ) \qquad ( 82 )$$

or

δωu=δk·S (83)

and if we take νₑ=S/u then

δω=δk·νₑ (84)

but from the definition of group velocity

δω=δk·∇ₖω(k)=δk·ν_{g} (85)

but since δk is arbitrary we must have that ν_{g}=νₑ. Moreover, if δω=0 for elastic scattering of a single frequency (wavelength) of light, then δk·νₑ=0 and

νₑ [symbol] ω(k), (86)

where ω(k) is the optical dispersion relation. Therefore, if δω=0 (i.e. for an ideal laser) then δk must be tangent to the dispersion surface ω(k). This implies that E and H are in the tangent plane of the normal and

S⊥ω(k). (87)

This is useful, but somewhat constraining as it will be shown later that the square of the dispersion relation is more readily obtained and manipulated. Therefore, consider the generic representation quadratic

f=ρₓx²+ρ_{y}y²+ρ_{z}z² (88)

which has a normal given by

∇f=2 [symbol] ρₓx,ρ_{y}y,ρ_{z}z [symbol] . (89)

Then multiplying and dividing by the distance r from the origin to a point on the surface of the representation quadratic we can rewrite this expression in terms of the direction cosines {lₓ, l_{y}, l_{z}}

∇f=2r [symbol] ρₓlₓ,ρ_{y}l_{y},ρ_{z}l_{z} [symbol] (90)

and the unit normal vector is

$$\hat{N} = \frac{∇ f}{\vert ∇ f \vert} = \frac{〈 {ρ}_{x} {l}_{x} , {ρ}_{y} {l}_{y} , {ρ}_{z} {l}_{z} 〉}{\sqrt{{ρ}_{x}^{2} {l}_{x}^{2} + {ρ}_{y}^{2} {l}_{y}^{2} + {ρ}_{z}^{2} {l}_{z}^{2}}} . \qquad ( 91 )$$

Alternately, consider the slightly different case of

g²=ρₓx²+ρ_{y}y²+ρ_{z}z² (92)

then on taking the implicit gradient we obtain

2g∇g=2 [symbol] ρₓlₓ,ρ_{y}l_{y},ρ_{z}l_{z} [symbol] (93)

and then

$$∇ g = \frac{〈 {ρ}_{x} {l}_{x} , {ρ}_{y} {l}_{y} , {ρ}_{z} {l}_{z} 〉}{\sqrt{{ρ}_{x} {x}^{2} + {ρ}_{y} {y}^{2} + {ρ}_{z} {z}^{2}}} \qquad ( 94 )$$

so that

$$\hat{N} = ∇ g = \frac{∇ f}{\vert ∇ f \vert} = \frac{〈 {ρ}_{x} {l}_{x} , {ρ}_{y} {l}_{y} , {ρ}_{z} {l}_{z} 〉}{\sqrt{{ρ}_{x}^{2} {l}_{x}^{2} + {ρ}_{y}^{2} {l}_{y}^{2} + {ρ}_{z}^{2} {l}_{z}^{2}}} . \qquad ( 95 )$$

Thus, the normal to both f and g are the same

\hat{N} [symbol] f and \hat{N} [symbol] g. (96)

Therefore, it is also true that

νₑ [symbol] ω²(k) and S [symbol] ω²(k). (97)

Next, we need explicit expressions for the dispersion relation ω(k) and its square ω²(k). The uniaxial case is much simpler mathematically than the biaxial case and has very practical properties for engineering of optical systems. Therefore, for simplicity, only the case of uniaxial crystals are provided here. In no way does focusing on this uniaxial example diminish the biaxial case for this disclosure.

In particular, if Eqs. 66-67 are combined assuming that the magnetic permeability is a scalar μ₀ then

k×(k×E)+ω²μ₀∈̅E=0 (98)

which for a crystal in the eigen symmetry basis has ∈̅=∈₀ diag[εₓ, ∈_{y}, ∈_{z}], so that in matrix form

$$( \begin{matrix}{ω}^{2} {μ}_{0} {ϵ}_{0} {ϵ}_{x} - {k}_{y}^{2} - {k}_{z}^{2} & {k}_{x} {k}_{y} & {k}_{x} {k}_{y} \\ {k}_{y} {k}_{x} & {ω}^{2} {μ}_{0} {ϵ}_{0} {ϵ}_{y} - {k}_{x}^{2} - {k}_{z}^{2} & {k}_{y} {k}_{z} \\ {k}_{z} {k}_{y} & {k}_{z} {k}_{y} & {ω}^{2} {μ}_{0} {ϵ}_{0} {ϵ}_{z} - {k}_{x}^{2} - {k}_{z}^{2}\end{matrix} ) ( \begin{matrix}{E}_{x} \\ {E}_{y} \\ {E}_{z}\end{matrix} ) = 0 \qquad ( 99 )$$

and the determinant of the 3×3 matrix must be zero. Then for uniaxial materials with εₓ=ε_{y}=nₓ²=n_{y}² and ∈_{z}=n_{z}² we have after factoring and using μ₀∈₀=1/c² that there are two dispersion relations

$${\underbrace{( \frac{{k}^{2}}{{n}_{x}^{2}} - \frac{{ω}^{2}}{{c}^{2}} )}}_{Ordinary Waves} {\underbrace{( \frac{{k}_{x}^{2} + {k}_{y}^{2}}{{n}_{z}^{2}} + \frac{{k}_{z}^{2}}{{n}_{x}^{2}} - \frac{{ω}^{2}}{( {i}^{2}} )}}_{Extraordinary Waves} = 0 \qquad ( 100 )$$

where c is the free-space speed of light. This shows that there are always two dispersion relations—one for each set of parentheses. These dispersion relations correspond to two specific cases of electric and magnetic configuration for uniaxial crystals called the ordinary and extraordinary field configurations.

Uniaxial Case-I is when E and D are parallel to each other and perpendicular to the optical axis of a uniaxial crystal. This is the case of ordinary wave (o-wave) propagation where the Poynting vector S is always parallel to the wave vector k. Uniaxial Case-II is when H and B are parallel to each other and perpendicular to the optical axis of a uniaxial crystal. This is the case of extraordinary wave (e-wave) propagation where the Poynting vector S is not parallel to the wave vector k. Additionally, for Case-II D, E, k, and S are all in the plane that is normal to H and B.

o-wave⇒(E∥D)⊥\hat{z} (101)

e-wave⇒(H∥B)⊥\hat{z} (102)

where \hat{z} is the unit vector in the direction of the optical axis. Let's take nₓ=n_{y}=nₒ(ordinary) and n_{z}=nₑ (extraordinary) then the dispersion is

$${\underbrace{\frac{{k}_{x}^{2}}{{n}_{e}^{2}} + \frac{{k}_{y}^{2}}{{n}_{e}^{2}} + \frac{{k}_{z}^{2}}{{n}_{o}^{2}}}}_{Wave - Vector Indicatrix} = \frac{{ω}^{2}}{{c}^{2}} . \qquad ( 103 )$$

This is to be compared to the indicatrix from Eq. 73 when nₓ=n_{y}=nₒ, so conservation of energy becomes

$${\underbrace{\frac{{D}_{x}^{2}}{{n}_{o}^{2}} + \frac{{D}_{y}^{2}}{{n}_{o}^{2}} + \frac{{D}_{z}^{2}}{{n}_{e}^{2}}}}_{Displacement - Vector Indicatrix} = 2 {ϵ}_{0} {u}_{D} . \qquad ( 104 )$$

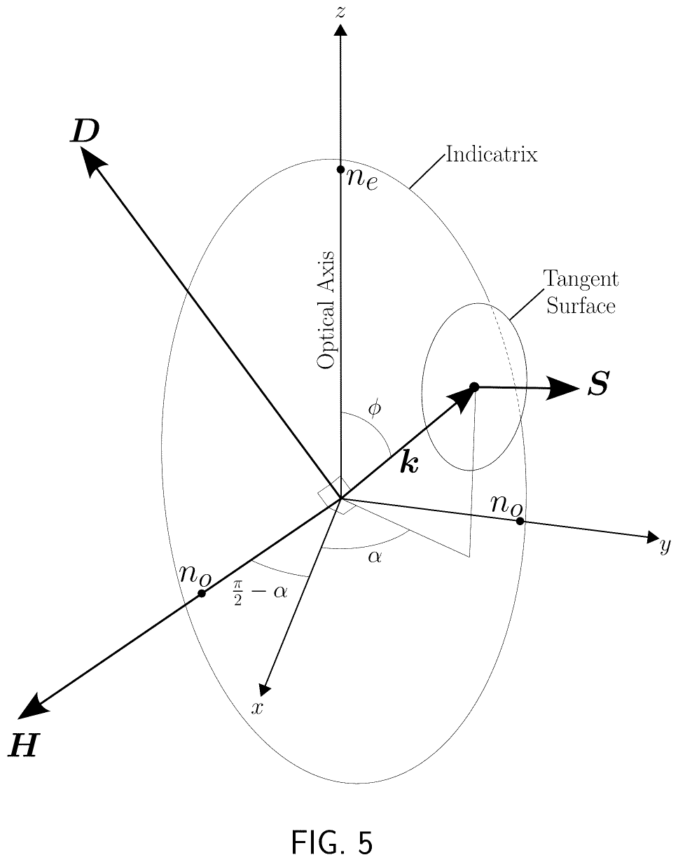

Next, let's consider FIG. 5, which is an indicatrix for a uniaxial crystal. The z-axis in FIG. 5 is chosen to be along the optical axis of the crystal so that the indicatrix has a circular cross section in the x-y plane. Let's further focus on e-wave (extraordinary wave) optics, which occurs for fields where H and B are parallel to each other and perpendicular to the optical axis (z-axis). From Eq. 70 we know that H [symbol] k and D [symbol] k in the crystal. For e-wave optics we can then write

k= [symbol] kₓ,k_{y},k_{z} [symbol] (105)

H [symbol] \hat{z}⇒H= [symbol] Hₓ,H_{y},0 [symbol] (106)

H [symbol] \hat{k}⇒H·k=0⇒Hₓkₖ+H_{y}k_{y}=0. (107)

Next, let's exploit Eq. 67 and rewrite it as

k×H=−ωD (108)

and using the above expressions for H and k we find that

$${D}_{x} = \frac{{H}_{y} {k}_{z}}{ω} \qquad ( 109 )$$

$${D}_{y} = \frac{- {H}_{x} {k}_{z}}{ω} \qquad ( 110 )$$

$${D}_{z} = \frac{{H}_{y} {k}_{x} - {H}_{x} {k}_{y}}{ω} . \qquad ( 111 )$$

Plugging these expressions for the displacement fields back into Eq. 104 and including Eq. 107 we find after some algebra

$$\frac{{k}_{x}^{2}}{{n}_{e}^{2}} + \frac{{k}_{y}^{2}}{{n}_{e}^{2}} + \frac{{k}_{z}^{2}}{{n}_{o}^{2}} = \frac{2 {ϵ}_{0} {u}_{D} {ω}^{2}}{( 1 + \frac{{k}_{y}^{2}}{{k}_{x}^{2}} ) {H}_{y}^{2}} \qquad ( 112 )$$

and on taking kₓ=k cos α sin ϕ and k_{y}=k sin α sin ϕ, where α is the polar angle and ϕ the zenith angle of the wave-vector we find the denominator becomes (1+tan² α)H_{y}²=H_{y}²/cos² α=H² because the projection of the k onto the xy-plane is π/2 radians displaced from H, see FIG. 5. Therefore,

$$\frac{{k}_{x}^{2}}{{n}_{e}^{2}} + \frac{{k}_{y}^{2}}{{n}_{e}^{2}} + \frac{{k}_{z}^{2}}{{n}_{o}^{2}} = \frac{2 {ϵ}_{0} {u}_{D} {ω}^{2}}{{H}^{2}} \qquad ( 113 )$$

However, the stored magnetic energy is u_{B}=H·B/2=μ₀H²/2, therefore H²=2u_{H}/μ₀ and Eq. 113 becomes

$$\frac{{k}_{x}^{2}}{{n}_{e}^{2}} + \frac{{k}_{y}^{2}}{{n}_{e}^{2}} + \frac{{k}_{z}^{2}}{{n}_{o}^{2}} = {ϵ}_{0} {μ}_{0} {ω}^{2} \frac{{u}_{D}}{{u}_{H}} , \qquad ( 114 )$$

but the stored energy in the magnetic fields is equal to the stored energy in the electric fields so that u_{D}=u_{H} and then on using ∈₀μ₀=1/c² we arrive at

$$\frac{{k}_{x}^{2}}{{n}_{e}^{2}} + \frac{{k}_{y}^{2}}{{n}_{e}^{2}} + \frac{{k}_{z}^{2}}{{n}_{o}^{2}} = \frac{{ω}^{2}}{{c}^{2}} . \qquad ( 115 )$$

Thus, Eq. 103 is formally the same as Eq. 104 when we account for the fields and the associated directions. Therefore, by Eq. 97 we can find the direction of the output ray energy \hat{ν}ₑ given the input ray wave vector \hat{k} simply by using Eq. 77.

Finally, take Eq. 68 and plug it into the expression for the average Poynting vector [symbol] S [symbol] =Re(E×H*)/2 and using the well known vector triple cross product identity as well as explicitly showing the polarization E=E\hat{m} we find

[symbol]

S [symbol] ×I₀[\hat{k}−\hat{m} cos κ] (116)

where the irradiance I₀=ncu/2 and cos κ=\hat{m}·\hat{k} is the cosine of the angle between the electric field polarization and the wave vector. Only for an isotropic medium is the unit wave vector \hat{k} orthogonal to the electric field polarization \hat{m} and the Poynting vector in the same direction as the unit wave vector \hat{k}.

### Chaotic NP Colloids With Oriented Dispersions

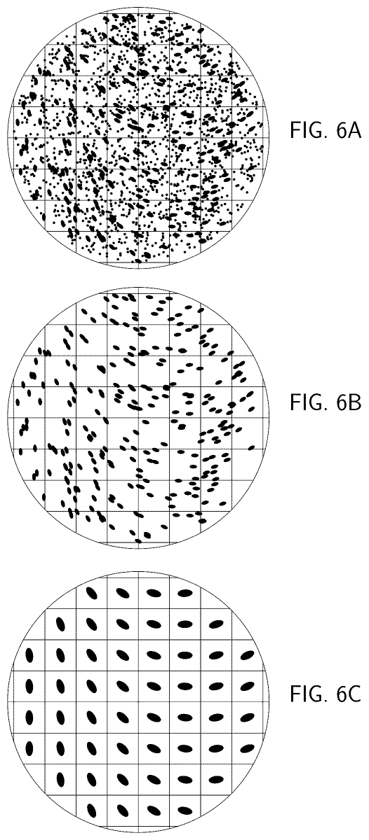

A typical colloid is a mixture of liquid molecules and larger NPs typically in the size range of 1 nm to 1,000 nm. This mixture is spatially chaotic, even when the average NP volume fraction is a constant. To make the optics of such system more understandable we can in general overlay a grid that defines tiny volume elements (voxels)—see FIG. 6A. On “conceptually” removing the liquid molecules in FIG. 6B a pattern of NP rotations is seen so that it becomes possible to assign an average NP orientation on a grid as in FIG. 6C. The easiest is that of a three dimensional cubic grid, however any arbitrary tiling of voxels in an arbitrary curved coordinate system is also possible. For example, one might choose to have 1 μm³ (cubically shaped) voxels containing 10 nm diameter spherical NPs with a 1% volume fraction, i.e. about 25,000 NPs per cubic micron, and a titanium dioxide (TiO₂) crystal structure that effectively makes the spherical NPs ellipsoidal electromagnetically. In a constant volume fraction system, every single voxel would have the same average RI matrix relative to the principal symmetry axis of the NPs, but would also have a different (rotated) RI matrix relative to some arbitrary global coordinate system. Then optical properties are defined by the voxel-to-voxel rotations of the optical axis, which corresponds to rotations of the diagonal RI matrix. This is much easier to understand compared to the chaotic mixture of NPs in a colloid. Thus, a colloid that looks like FIG. 6C is easier to model mathematically than a colloid that looks like FIG. 6A. It is also easy to see why each voxel is to have approximately constant orientations, but orientations can change moving through the colloid.

Let's express the wave vector components in terms of its polar coordinates. Then kₓ=k cos α sin ϕ, k_{y}=k sin α sin ϕ, k_{z}=k cos ϕ, and k=nω/c, which when plugged into Eq. 115 provides that

$$\frac{1}{{n}^{2} ( ϕ )} = \frac{{sin}^{2} ϕ}{{n}_{e}^{2}} + \frac{{cos}^{2} ϕ}{{n}_{o}^{2}} , \qquad ( 117 )$$

where n is the effective RI for the phase wave in the direction ϕ of the wave vector relative to the optical axis of the ellipsoid, and nₒ and nₑ are form the principal-axis RIs, as given by the diagonal elements of Eq. 36. Thus, by electronically specifying the rotations of NPs, and by extension the RI ellipsoids from voxel-to-voxel, it is possible to specify local RI distributions in a colloid, and this can redirect the phase-wave in a controlled way, and the associated phase-ray, in the direction of the wave vector.

Therefore, given the input wave vector field k=k(r), and the light's input electric field polarization \hat{m}=\hat{m}(r), such that E=E\hat{m}(r), which are both calculated by a method detailed in the next section; and the NP orientation field \hat{q}=\hat{q}(r), i.e. by averaging the optical axes orientations of tens of thousands of NPs per voxel, then we can then appreciate if o-wave or e-wave propagation is occurring and determine the vector field of energy flow from Eq. 77. This provides the energy-rays in the colloid, which is what is typically considered to be a “light ray.” These energy rays are generally along curved trajectories. Thus, the technique of replacing a chaotic NP mixture with a grid of RI ellipsoids helps to reduce the optics problem to an understandable form that is addressable mathematically.

### Eikonals, Fermat's Principle, and Geodesics

This disclosure is primarily focused on utilizing a GRadient INdex (GRIN) colloid to bend, steer, concentrate, and even diffract light. The RI may be isotropic (I-GRIN) or anisotropic (A-GRIN). I-GRIN, where n=n(r) has historically been utilized [8]. However, herein we consider A-GRIN, where n=n(r, k, \hat{m}, \hat{q}) is a function of position r, wave vector k, electric field polarization \hat{m}, and the orientation \hat{q} of the indicatrix from point-to-point. The added complexity provides new and unexpected advantages that are discussed throughout this disclosure. The principles are esoteric enough that it requires a further review, which builds on basic crystal optics, for predicting ray trajectories in non-trivial distributions of anisotropic media.

Consider the linear momentum of a photon [symbol] as given by quantum mechanics as [symbol] =ℏk=(ℏk₀)n\hat{k}, where ℏ is the reduced Planck's constant and k is the wave vector, k₀ is the free-space wavenumber, n is a scalar RI derived from isotropic or anisotropic media and \hat{k} is the unit wave vector. The normalized phase-wave momentum, also called the linear optical momentum, is defined as

$$p = \frac{ℏ {k}_{0}}{} = n \hat{k} ≡ ∇ ℒ , \qquad ( 118 )$$

where [symbol] = [symbol] (r) is the optical path length (OPL) at position r. The OPL is defined as a function that has iso-surfaces with normals thereto that are the linear optical momentum. The normals are given by the gradient operation. Taking the dot product of Eq. 118 with itself we find a well known version of an Eikonal equation

$${( \frac{\partial ℒ}{\partial x} )}^{2} + {( \frac{\partial ℒ}{\partial y} )}^{2} + {( \frac{\partial ℒ}{\partial z} )}^{2} = {n}^{2} . \qquad ( 119 )$$

So that given n and appropriate boundary conditions, the constant iso-contours [symbol] (r)=constant can be found and the phase rays are determined by p=∇ [symbol] . Unfortunately, Eq. 119 is a very difficult equation to solve, but it clearly shows that RI specifies the OPL. Also, another form of the eikonal is obtained by taking the derivative of Eq. 118 with respect to the arc length s of the ray trajectory, then

$$\begin{matrix}\frac{dp}{ds} = \frac{d}{ds} ( n \hat{k} ) \\ = \frac{d}{ds} ∇ ℒ \\ = \frac{dr}{ds} \cdot \frac{\partial }{\partial r} ∇ ℒ \\ = \frac{dr}{ds} \cdot ∇ ∇ ℒ \\ = \hat{k} \cdot ∇ ∇ ℒ \\ = \frac{∇ ℒ}{n} \cdot ∇ ∇ ℒ \\ = \frac{1}{2 n} ∇ {[ ∇ ℒ ]}^{2} \\ = \frac{1}{2 n} ∇ {n}^{2} \\ = ∇ n\end{matrix} \qquad ( 120 )$$

Thus, there are two more forms of the eikonal

$$\frac{dp}{ds} = ∇ n \qquad ( 121 )$$

$$\frac{d}{ds} ( n \frac{dr}{ds} ) = ∇ n . \qquad ( 122 )$$

Note that Eq. 121 tells us how linear optical momentum changes. For example, on integrating Eq. 121 we obtain

p₂−p₁=∇nΔs. (123)

If there is a flat optical boundary between two different glass regions, each having different RI, then we could appreciate the consequences by taking the dot product of Eq. 123 with a tangent unit vector \hat{τ} to the optical boundary so that ∇n·\hat{τ}=0, whereby we find the boundary momentum matching condition as

p₁·\hat{τ}=p₂·\hat{τ}, (124)

which is noting more than Snell's law of refraction n₁ sin θ₁=n₂ sin θ₂ in the special case of both media being isotropic. Moreover, at an abrupt boundary between two media we can also rewrite Eq. 123 using the relation ∇nΔs=Δn \hat{ν}₁₂=(n₂−n₁)\hat{ν}₁₂, which is the unit normal vector in the direction from the first to the second medium. Therefore, phase-ray refraction (and reflection) are described in terms of optical momentum by

p₂=p₁+(n₂−n₁)\hat{ν}₁₂, (125)

which in combination with the momentum matching condition at the boundary, depends on the dispersion relation, defines refraction at a boundary, even between isotropic and anisotropic media. In a very real sense tracking the phase-rays p through an optical system is more important for beam steering than tracking the energy-rays because the refraction and reflection at a boundary have a phase ray description. This is somewhat surprising in retrospect and not the standard thinking of prior researchers. Obviously, the energy-ray still needs to be tracked too, to ensure that energy is not deposited into a sub-optimal location.

Next, let's derive Fermat's principle from optical momentum considerations. The objective is not to just reproduce the well known variational integral, but rather to understand if Fermat's principle provides light rays that are associated with the phase velocity, group velocity, or energy velocity. This is a very subtle and important point in this disclosure where an anisotropic medium is utilized. The scientific literature that this author has examined has gotten this association, i.e. between the ray trajectories from Fermat's principle and type of ray velocity (phase, group, or energy) wrong. Thus, deriving Fermat's principle in integral form is not a pedantic exercise. Instead, it will allow a greater understanding of Fermat's principle and how it is to be applied to an anisotropic colloid. This is central to understanding how a colloid can steer light into ANY arbitrary direction and how to predict its performance.

To proceed let's now take the curl of Eq. 118 and use the identity ∇×∇ [symbol] =0 to find that the linear optical momentum has no circulation

∇×(n\hat{k})=0. (126)

Next, applying Stokes integral theorem

[symbol]

∇×(n\hat{k})·dA= [symbol] n\hat{k}·dr=0, (127)

where the last equality is Lagrange's integral invariant. The integration is taken around the contour ∂A of an area A where phase-rays pass. An example of this area is now shown in actually developing Fermat's principle.

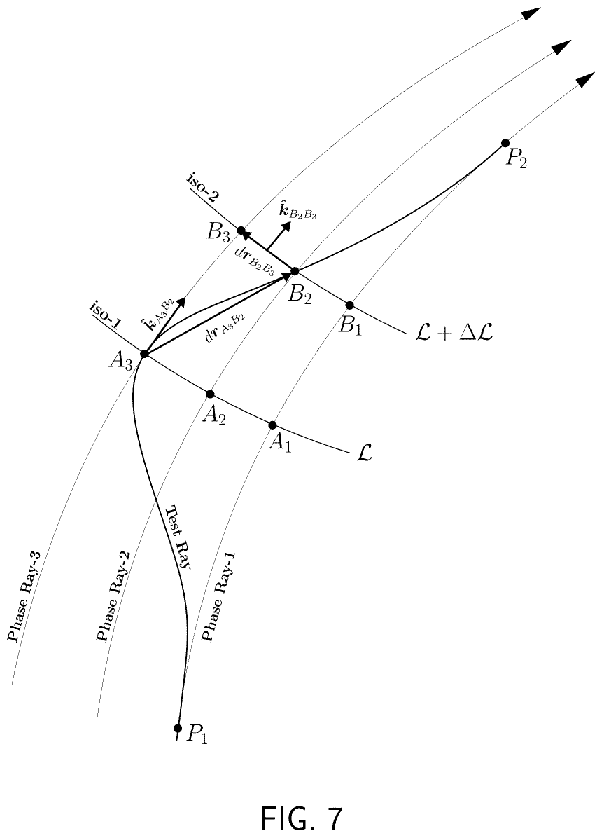

In particular, consider FIG. 7, which shows three curved and slightly converging phase-ray trajectories, which are labeled as Phase Ray-1, Phase Ray-2, and Phase Ray-3. Also shown are two iso-surfaces called iso-1 and iso-2, which represent the phase-wavefronts having OPL of [symbol] and [symbol] +Δ [symbol] respectively as shown. Along iso-1 are the points A₁, A₂, and A₃. Along iso-2 are the points B₁, B₂, and B₃. A curved test ray passes from point P₁ on Phase Ray-1 to point P₂ on Phase Ray-1 via points A₃ on iso-1 and Phase Ray-3; and B₂ on iso-2 and Phase Ray-2 is also shown. It is now possible to ingrate along the closed contour ∂A=A̅₃̅B̅₂̅+B̅₂̅B̅₃̅+B̅₃̅A̅₃̅ so that

[symbol]

n\hat{k}·dr=[n\hat{k}·dr]_{A}_{₃}_{B}_{₂}+[n\hat{k}·dr]_{B}_{₂}_{B}_{₃}+[n\hat{k}·dr]_{B}_{₃}_{A}_{₃}=0 (128)

where perpendicular vectors provide that the second term is zero

[n\hat{k}·dr]_{B}_{₂}_{B}_{₃}=n\hat{k}_{B}_{₂}_{B}_{₃}·dr_{B}_{₂}_{B}_{₃}≡0 (129)

and on reversing the order of the path of the third term then

[n\hat{k}·dr]_{A}_{₃}_{B}_{₂}−[n\hat{k}·dr]_{A}_{₃}_{B}_{₃}=0. (130)

Therefore,

[n\hat{k}·dr]_{A}_{₃}_{B}_{₃}=[n\hat{k}·dr]_{A}_{₃}_{B}_{₂} (131)

and

[nds]_{A}_{₁}_{B}_{₁}=[n\hat{k}·dr]_{A}_{₃}_{B}_{₃}=[n\hat{k}·dr]_{A}_{₃}_{B}_{₂}≤[nds]_{A}_{₃}_{B}_{₃}. (132)

On Integrating the first and last term, we obtain

∫_{Ray-1}nds≤∫_{Ray-3}nds, (133)

which is a statement of the extremum nature of the integral of the RI integrated along the actual path compared to any other path given that the optical momentum is perpendicular to the wavefronts such as iso-1. We would conclude that the variation is such that

δ∫nds=0. (134)

In no way has the group velocity or the energy velocity been utilized in Eq. 134. The fundamental idea is that there exists linear optical momentum that points in a normal direction to the phase wavefronts [symbol] . This means phase-rays are predicted by Fermat's principle. If the RI is anisotropic then we would obtain expressions such as Eq. 117 where the effective RI in still the direction of the wave vector \hat{k} is obtained. This can still be used in Eq. 134, but the formulation still only provides the phase-ray trajectory. This is a significant conclusion.

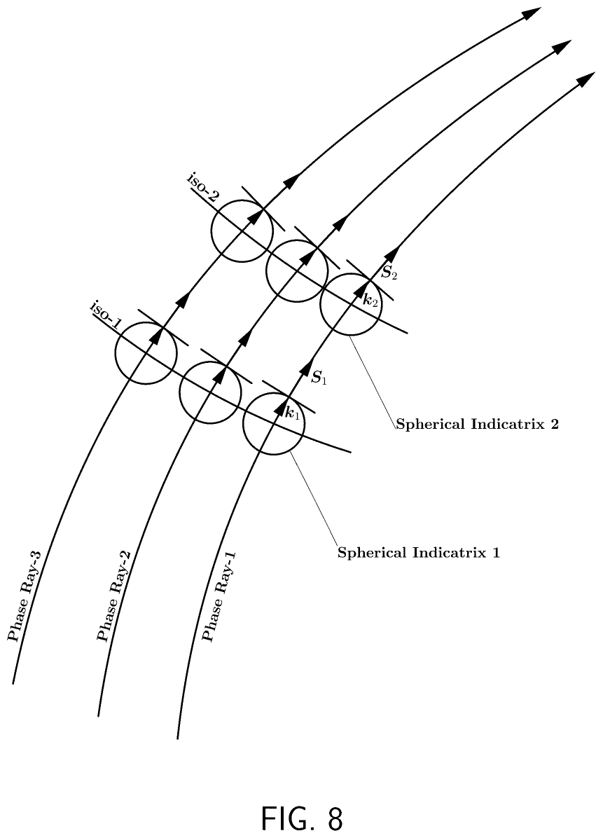

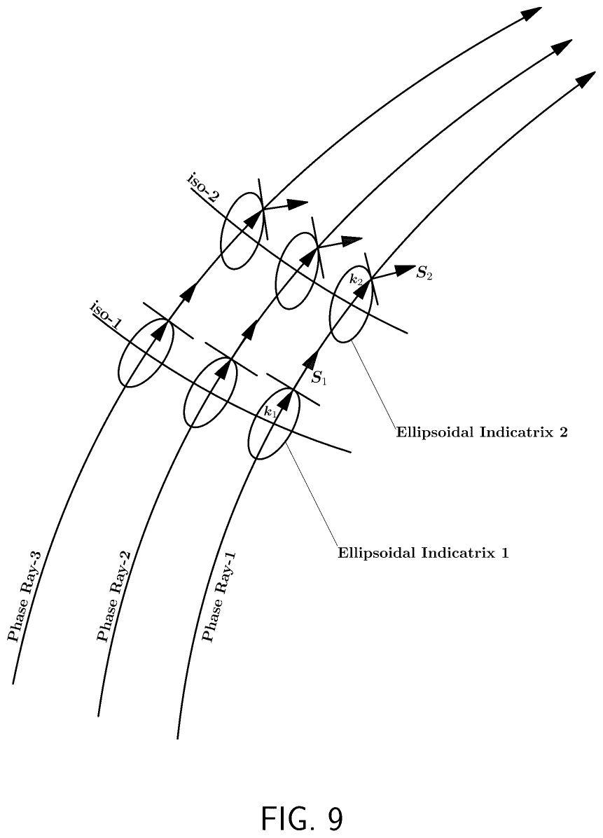

In summary: Fermat's principle can be adapted to take as an input both isotropic and anisotropic refractive index distributions. However, in all cases the output ray trajectories are tangent to the phase velocity νₚ. So the output of an analysis by Fermat's principle are phase-rays. In the case of case of isotropic media, the energy velocity νₑ is the same as the phase velocity νₚ because the dispersion relation is spherical for all polarization states. In the case of anisotropic media the energy velocity may be (but does not have to be) different from the phase velocity, depending on if the electric fields or magnetic fields are locally perpendicular to the local optical axis of the NPs. When the electric field is perpendicular to the local optical axis then the dispersion relation is spherical and o-waves are propagated. When the magnetic field is perpendicular to the local optical axis then the dispersion relation is oblate or prolate spheroidal (for uniaxial anisotropy) and e-waves are propagated. For both e-wave and o-wave propagation the energy velocity is νₑ=∇ₖω(k, r). Also, because each indicatrix may be at different orientations relative to the local wave vector k it is possible that o-wave propagation can turn into e-wave propagation at different locations within the colloid medium and vice versa. Thus, it is necessary to track the position r, the electric field polarization \hat{m}, the wave vector k, and the orientation \hat{q} of the indicatrix at each step of any analysis. FIG. 8 shows phase-ray trajectories, phase-wavefronts, and energy-ray trajectories in an isotropic medium having a spherical dispersion relation. FIG. 9 shows phase-ray trajectories, phase-wavefronts, and energy-ray trajectories in an isotropic medium having a prolate spheroidal dispersion relation. Notice that the energy velocity may be aligned or not aligned with the phase-ray trajectories even in FIG. 9 depending on the direction of the wave vector relative to the indicatrix. Also note that it is possible to design the colloid so that the rate of rotation of indicatrix from point-to-point matches the curvature of the phase-rays so that νₑ=νₚ at all points. This is not a requirement, but it simplifies understanding the system. Finally, it is critical to note that boundary conditions are handled with phase-rays not energy-rays. For example, Eq. 125 applied to an abrupt boundary between an isotropic glass plate and an anisotropic colloid governs refraction of phase-rays not energy rays!! Prior art authors appear to focus on the energy-rays as the actual “rays” to monitor, however it is the position here that the phase-rays need to be tracked for beam steering, while making sure that energy does not go into an undesired direction—e.g. away from output port. Thus, phase-rays have been plotted in this author's current and prior disclosures.

Next, let's generalize Eq. 134 so that more general coordinates can be used. In particular, Fermat's general variational principle for phase-ray trajectories becomes

δl=δ∫(gᵢⱼdxⁱdx^{j})^{1/2}=0, (135)

where l is the Optical Path Length (OPL), gᵢⱼ are the covariant metric tensor components, dxⁱ are the contravariant coordinate differentials along the desired trajectory of light, and S here is the variational operator. Also, the Einstein summation convention of summing over variables with a lower an upper position is in effect. Equation 135 clearly simplifies to Eq. 134 if gᵢⱼ=n² δᵢⱼ, where δᵢⱼ is the Kronecker delta function and we have then that the OPL is dl=n ds. However, the generalized equation Eq. 135 is capable of investigating more interesting cases.

Different cases of engineering interest can be specified by providing the associated OPL line element and then applying a result of differential geometry wherein the variation of the OPL is zero when the trajectory is given by a geodesic equation [9],

$$\frac{{d}^{2} {x}^{i}}{{dl}^{2}} + {Γ}_{jk}^{i} \frac{{dx}^{j}}{dl} \frac{{dx}^{k}}{dl} = 0 where \\ {Γ}_{jk}^{i} = \frac{{g}^{il}}{2} ( \frac{\partial {g}_{lj}}{\partial {x}^{k}} + \frac{\partial {g}_{kl}}{\partial {x}^{j}} - \frac{\partial {g}_{jk}}{\partial {x}^{l}} ) \qquad ( 136 )$$

where xᵢ=xᵢ(l), the affine connection is given by Γⱼₖⁱ, which are Christoffel symbols of the second kind, g^{il} are the contravariant metric components and the Einstein summation convention is again utilized.

In what follows, we will set a convention where x¹=x and x²=y are along orthogonal beam steering panel edges, and x³=z in a direction normal to the panel. Two GRIN systems of engineering interest, which are compared in sections below for beam steering in the xz-plane, have line elements

$${dl}^{2} = \{ \begin{matrix}{n}_{xx}^{2} {dx}^{2} + {n}_{zz}^{2} {dz}^{2} & I - GRIN ( Spherical NPs ) \\ {n}_{xx}^{2} {dx}^{2} + 2 {n}_{xz}^{2} dxdz + {n}_{zz}^{2} {dz}^{2} & A - GRIN ( Ellipsoidal NPs )\end{matrix} \qquad ( 137 )$$

where for spherical NPs any coordinate system is equally equivalent as the principal-axis coordinate system. This is not the case for ellipsoidal NPs, where mixing of the x and z coordinates by NP rotations in an A-GRIN system provides a game changing capability that overcomes many of the optics and electrode challenges of prior art beam steering methods and can be extended to complete beam steering into x, y, and z directions easily. Also, note that the factor of 2 in the A-GRIN line element is due to the fact that n_{xz}²=n_{zx}² as permittivity is a symmetric tensor and the terms associated with n_{xz} and n_{zx} were simply added to generate the middle A-GRIN term.

The solution of the geodesic Eq. 136 allows for complicated book keeping of the RI from point-to-point. Moreover, the geodesic solution is for the phase-ray trajectory. In examining the scientific literature it appears to the current author that this point has been miss understood by many in the general scientific community, because of the convenient situation that the phase-ray and the energy-ray are one and the same for I-GRIN. This is not the general case for A-GRIN.

Simplifying Eqs. 136 using the I-GRIN line element of Eq. 137 for isotropic media n̅=nI̅, where dl=n ds, s is arc length, and n≥1 (to avoid the need for absolute values of n) again gives the eikonal Eq. 122, which can be rewritten as

$$\ddot{r} + \frac{d}{ds} [ ln n ( r ) ] \dot{r} = ∇ [ ln n ( r ) ] , \qquad ( 138 )$$

where r is a ray's position vector, \dot{r}=dr/ds=\hat{τ} is a unit tangent vector to the trajectory, and \ddot{r}=−\hat{ρ}/ρ is the “instantaneous” principal normal to the trajectory with radius of curvature ρ, as seen by setting r(s)=r₀+ρ [symbol] cos[s/ρ], sin[s/ρ] [symbol] in Eq. 138. Therefore,

$$∇ [ ln n ( r ) ] = - \frac{\hat{ρ}}{ρ} + \frac{d}{ds} [ ln n ( r ) ] \hat{τ} , \qquad ( 139 )$$

$$or$$

$$[ ∇ - \hat{τ} \frac{d}{ds} ] ln n ( r ) = - \frac{\hat{ρ}}{ρ} . \qquad ( 140 )$$

On expanding by using d/ds=\dot{x}∂ₓ+\dot{y}∂_{y}+ż∂_{z}=\hat{τ}·∇ we find that

$$[ {I}^{=} - \hat{τ} \hat{τ} ] \cdot ∇ ln n ( r ) = - \frac{\hat{ρ}}{ρ} , \qquad ( 141 )$$

or solving for the RI factor

$$∇ ln n ( r ) = - {[ {I}^{=} - \hat{τ} \hat{τ} ]}^{- 1} \frac{\hat{ρ}}{ρ} , \qquad ( 142 )$$

where I̅ is the identity tensor, and \hat{τ}\hat{τ} is a dyadic product forming a matrix. So that on taking the inner product of Eq. 141 with itself we find that

$$∇ ln n ( r ) \cdot ∇ ln n ( r ) - {[ \hat{τ} \cdot ∇ ln n ( r ) ]}^{2} = \frac{1}{{ρ}^{2}} . \qquad ( 143 )$$

These equations relates curvature along a phase-ray trajectory to derivatives of the quantity ln n(r) and the fundamental quantities of a curve in differential geometry, i.e. the tangents to the trajectory and the principle normal. In the special case of circular trajectories of phase-rays having a radius curvature of curvature ρ, we find that \hat{τ} is perpendicular to the gradient of the RI, so that Eq. 139 becomes

$$∇ [ ln n ( r ) ] = - \frac{\hat{ρ}}{ρ} , \qquad ( 144 )$$

so that in cylindrical or spherical coordinates we can write (with different meanings for r) that

$$\frac{\partial ln n ( r )}{\partial r} = \frac{- 1}{ρ} \qquad ( 145 )$$

and by quadrature we find that

n(r)=n₀e^{-r/ρ} (146)

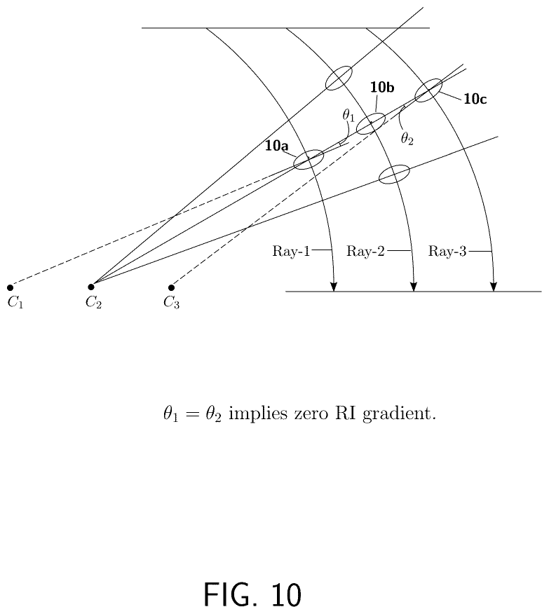

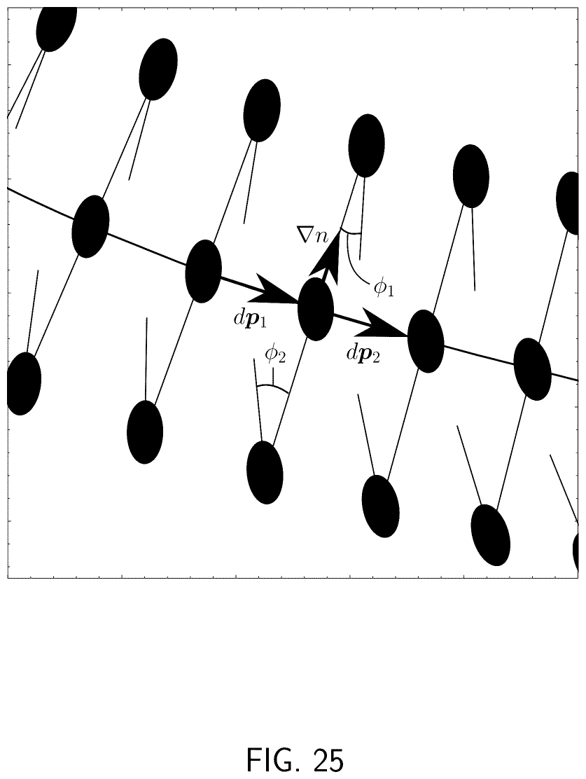

Eqs. 146 ensures that an isotropic RI can provide the needed conditions to move both the phase-ray and energy-ray along a circular trajectory. However, as it turns out, it is not sufficient to ensure that an anisotropic phase-ray will move along a circular trajectory. In FIG. 10 three circular segments of the same radius represent ray trajectories: Ray-1, Ray-2, and Ray-3. These segments are also translated along a line and have centers C₁, C₂ and C₃ respectively. It can be shown by geometric analysis that the angle between the optical axis of indicatrix-1 10a and the optical axis of indicatrix-2 10b is identical to the angle between the optical axis of indicatrix-2 10b and the optical axis of indicatrix 10c. This corresponds to θ₁=θ₂ in the image. Under such a condition ray bending is not possible as no RI gradient exists. Compare that to the situation in FIG. 25 where phase-ray bending can occur for non-circular trajectories. If segments of a circle are desired for the ray trajectory, then translational DEP can be used to change the volume fraction. While this disclosure has focused on rotational and orientational manipulations, some embodiments of the electrodes can easily be adapted to provide the signals needed for both translation and orientation of NPs. Finally, the reader may wish to see an example of I-GRIN circular segment ray trajectories, to compare to the above discussed case of circular trajectory A-GRIN optics. Therefore, see the APPENDIX in this disclosure.

### Spatial Indicatrix Distributions

The position and angular distributions of NPs can be either homogeneous or non-homogeneous. The composition of these particle can be isotropic or anisotropic. That is a total of eight combinations. These considerations lead to different representations of materials, based on the configuration of indicatrix on a gird. The following are some examples.

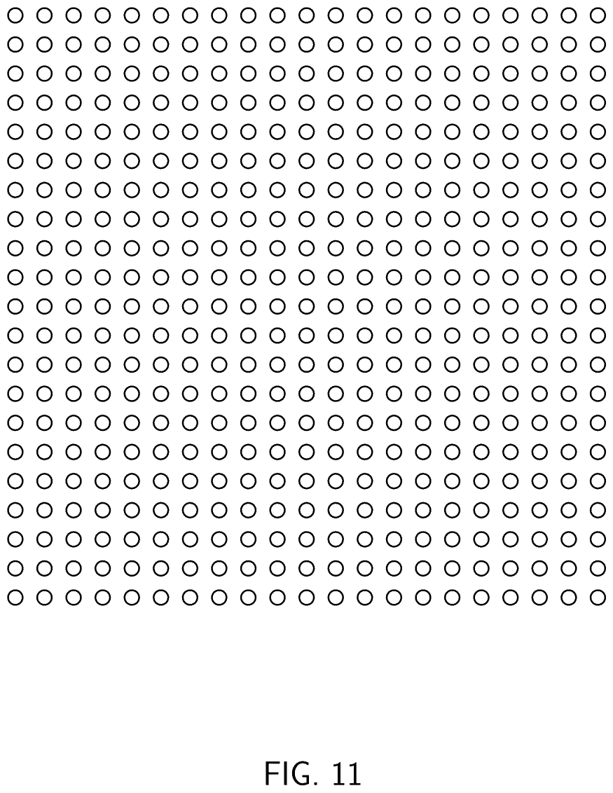

FIG. 11 shows in cross section the indicatrix representation of a homogeneous and isotropic medium, such as an amorphous glass or a colloid with spherical glass nanoparticles dispersed uniformly and randomly throughout the dispersion. Note again that even when the NPs are spatially distributed randomly the representation of the material dispersion on a grid is systematic and ordered.

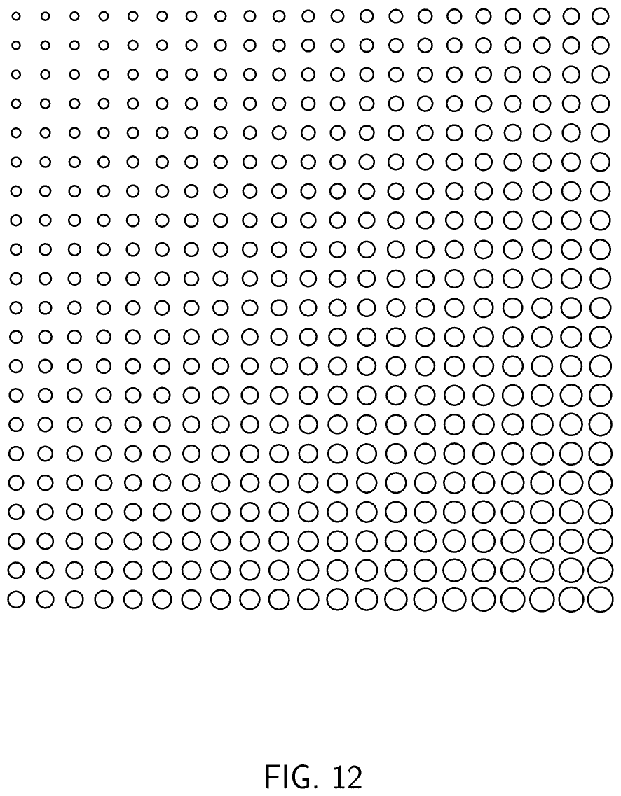

FIG. 12 shows in cross section the indicatrix representation of an inhomogeneous and isotropic medium comprising an isotropic graded refractive index (I-GRIN) medium that has a constant gradient (linear increase in RI) from the upper left corner to the lower right corner of the image. For example, this type of medium can be synthesized by dielectrophoresis of spherical isotropic nanoparticles dispersed randomly with a gradient in the volume fraction of the nanoparticles suspended in a colloid.

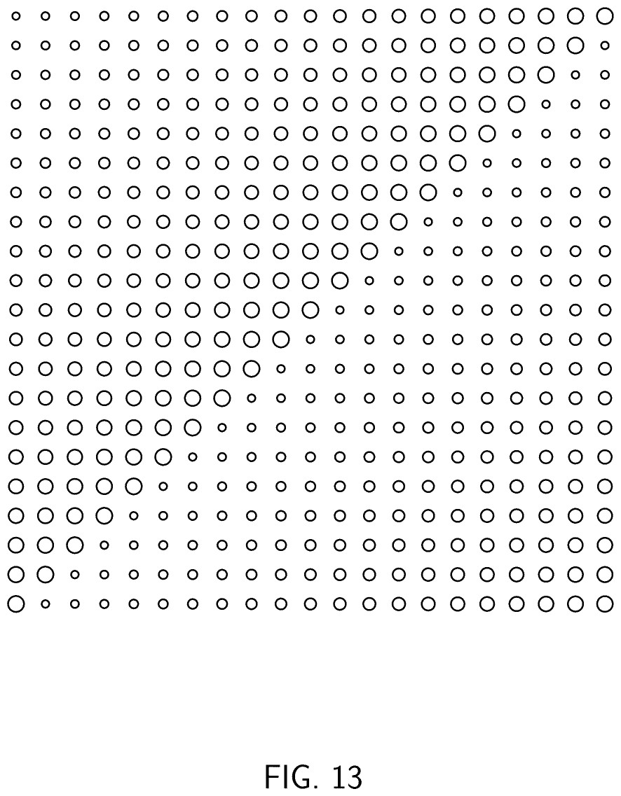

FIG. 13 shows in cross section the indicatrix representation of a graded refractive index medium with a reset at a step discontinuity across the diagonal from lower left to upper right. This step discontinuity type of behavior is required in many prior-art beam steering technologies and is difficult to achieve correctly. The discontinuity is called a “fly-back” in the review article by Morris [8].

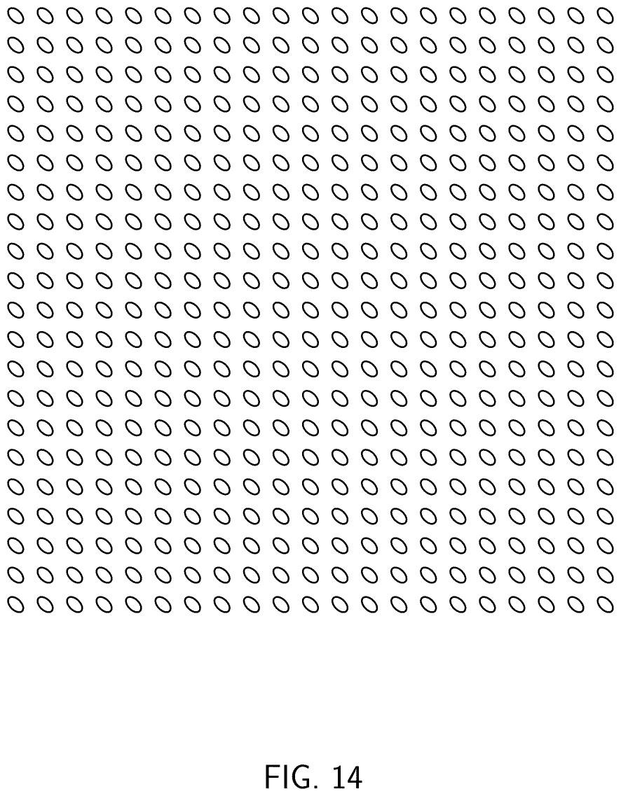

FIG. 14 shows in cross section the indicatrix representation of a positive uniaxial crystal with the optical axis running from the upper left hand corner to the lower right hand corner. For example, this is a representation of a cut through a positive uniaxial quartz crystal. This can also be achieved with a colloid having all of the identical anisotropic NPs with the same orientation.

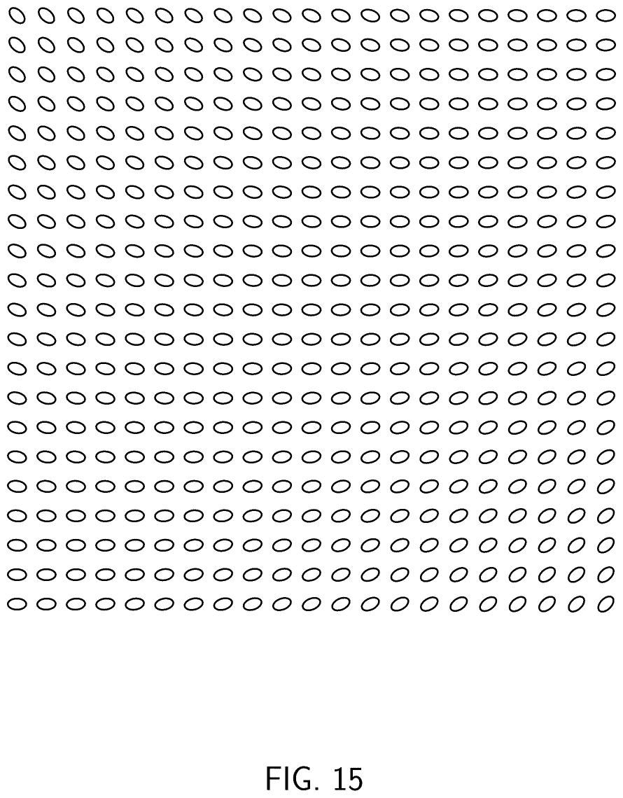

FIG. 15 shows in cross section the indicatrix representation of a positive uniaxial crystal with the optical axis changing orientation from the upper left hand corner to the lower right hand corner by π/2 radians via a constant gradient (i.e. linear change in angle spatially).

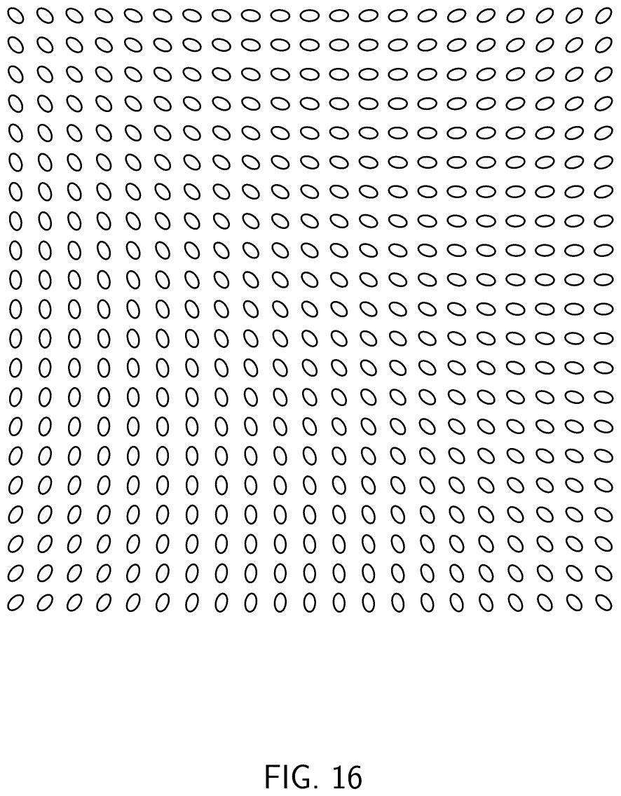

FIG. 16 shows in cross section the indicatrix representation of a positive uniaxial crystal with the optical axis changing orientation from the upper left hand corner to the lower right hand corner without the need for a step discontinuity as is the case for isotropic gradient refractive index media. The indicatrix just keeps on rotating as needed to accomplish the optical function needed. This can be achieved with an increased gradient the rotation angle of NPs in a colloid.

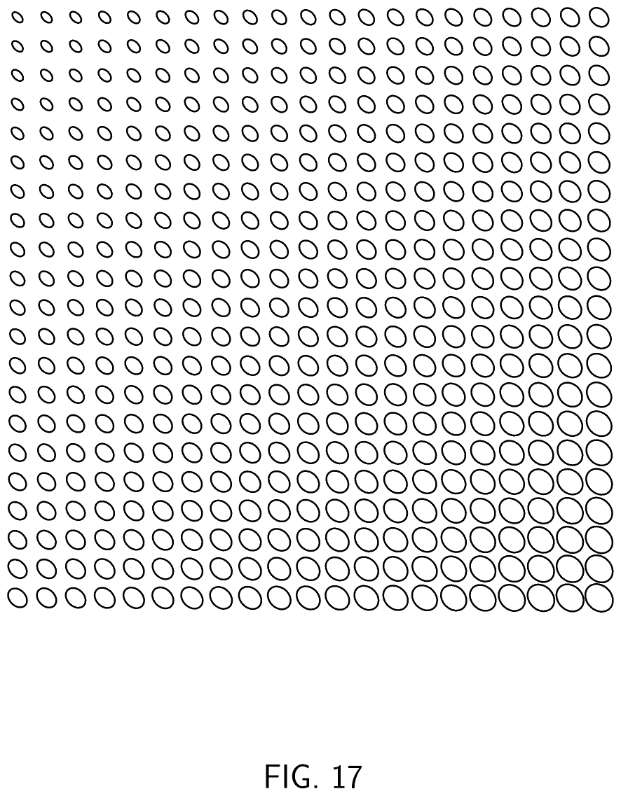

FIG. 17 shows in cross section the indicatrix representation of a fluidic meta material comprising a positive uniaxial crystal with the optical axis in a fixed orientation from the upper left hand corner to the lower right hand corner and with a simultaneous increase in the volume fraction of nanoparticles in the same direction.

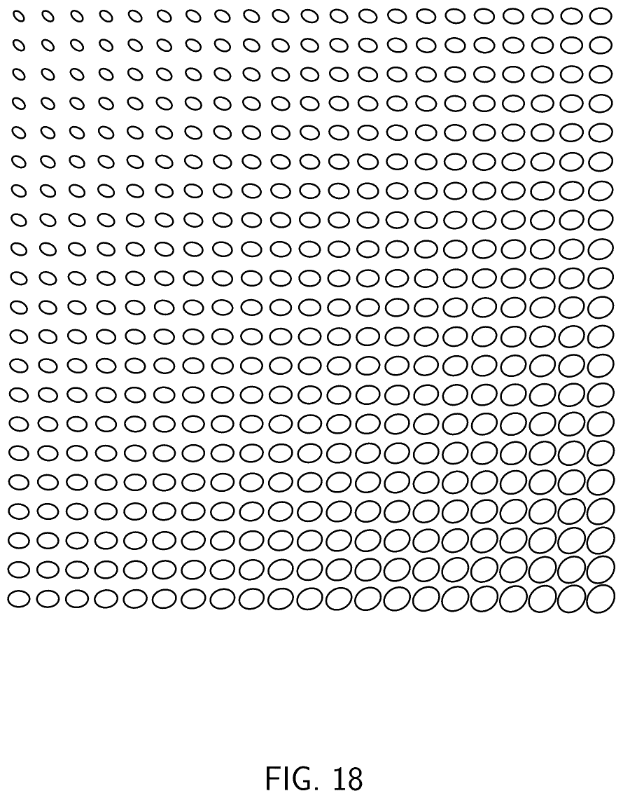

FIG. 18 shows in cross section the indicatrix representation of a fluidic meta material comprising a positive uniaxial crystal with the optical axis changing orientation from the upper left hand corner to the lower right hand corner and with a simultaneous increase in the volume fraction of nanoparticles in the same direction. Note that the direction of the gradient of the volume fraction of NPs can also be in a different direction than the direction of the gradient in the orientation angle of the optical axis of the NPs. This provides incredible new degrees of freedom for optical materials that have not been available previously.

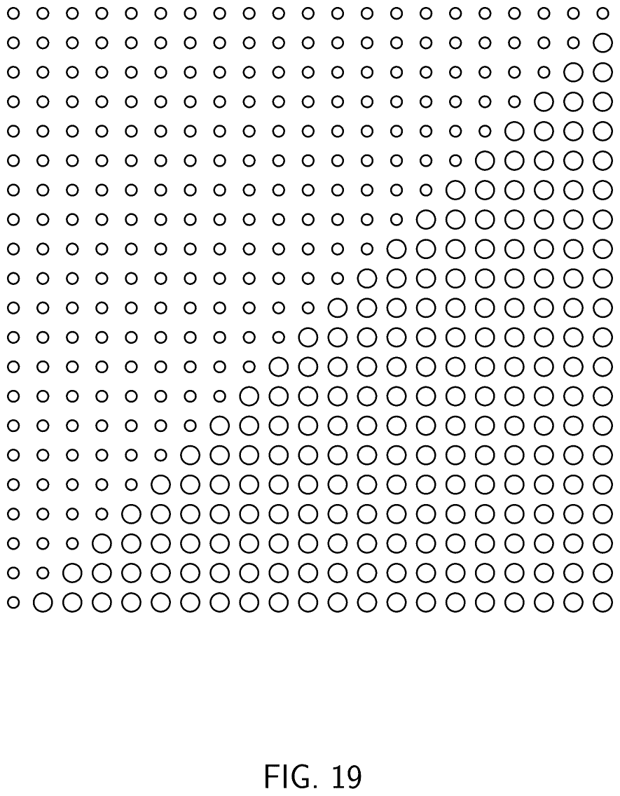

FIG. 19 shows in cross section the indicatrix representation of a boundary between two isotropic and homogeneous optical media. This is typical of the type of boundary found between a conventional lens and the air. This image is provided as an education aid.

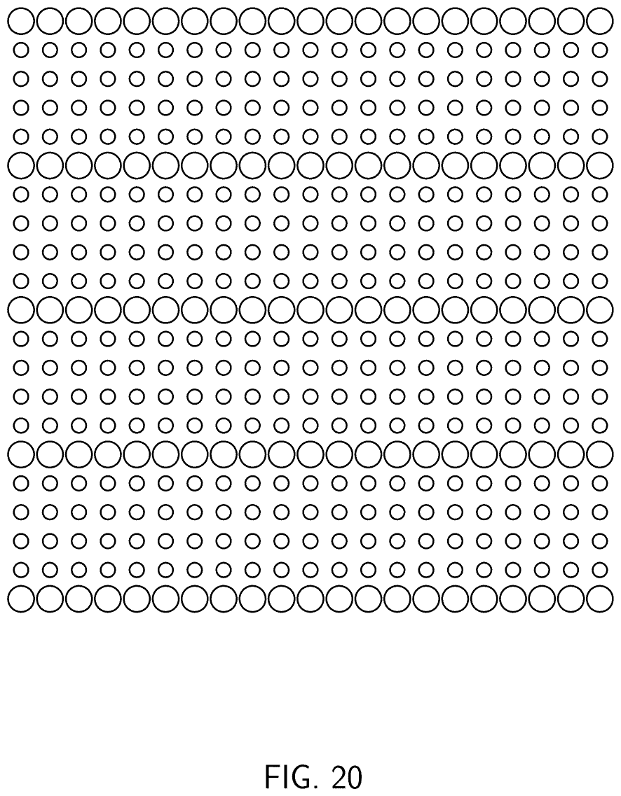

FIG. 20 shows in cross section the indicatrix representation of a simple diffractive optical element, comprising periodic and isotropic variations in the refractive index to provide diffraction. Clearly, the diffractive optical element could also comprise anisotropic media by the inclusion of anisotropic NPs (not shown).

It is to be understood that there are other variations on how a fluidic meta material can be configured, which though not shown here, should now be obvious to those skilled in the art.

### A-GRIN Optics

A-GRIN optics is that of effectively non-spherical NPs, i.e. when both the material properties and shape are taken into account then we find that the NPs are electromagnetically non-spherical. A-GRIN has the property that RI is a function of position, phase-ray direction, indicatrix orientation, and electric field polarization. Let's consider here a simplified One Degree Of Freedom (1-DOF) beam steering system with curved light trajectories in the xz-plane and electronics linearly distributed along the x-direction. The line element is provided in Eq. 137 and the metric tensor G̅ is obtained as

G̅=n̅(r)n̅(r)^{T}=R̅(r)n̅₀(r)n̅₀(r)^{T}R̅(r)^{T}, (147)

where T is the transpose and n̅ is from Eq. 35. Assuming NP material uniaxial (e.g. rutile and anatase phase titanium dioxide TiO₂) then n̅_{P}=diag(nₒ, nₒ, nₑ) for spheroids of revolution. Therefore, active NP rotations θ about each NP's local y-axis requires

$${R}^{=} ( x , z ) = [ \begin{matrix}cos θ ( x , z ) & 0 & sin θ ( x , z ) \\ 0 & 1 & 0 \\ - sin θ ( x , z ) & 0 & cos θ ( x , z )\end{matrix} ] . \qquad ( 148 )$$

Moreover, by Eqs. 35, 137, 147, and 148 we find the metric tensor for Eq. 136 as

$${G}^{=} = [ {g}_{ij} ] = \qquad ( 149 )$$

$$[ \begin{matrix}{n}_{o}^{2} {cos}^{2} θ ( x , z ) + {n}_{e}^{2} {sin}^{2} θ ( x , z ) & 0 & ( {n}_{e}^{2} - {n}_{o}^{2} ) cos θ ( x , z ) sin θ ( x , z ) \\ 0 & {n}_{o}^{2} & 0 \\ ( {n}_{e}^{2} - {n}_{o}^{2} ) cos θ ( x , z ) sin θ ( x , z ) & 0 & {n}_{o}^{2} {sin}^{2} θ ( x , z ) + {n}_{e}^{2} {cos}^{2} θ ( x , z )\end{matrix} ] ,$$

where volume fraction νₚ is now a constant. Perpendicular to the optical axis the RI is nₒ=n_{L}+(nₒ−n_{L})σ_{Pxx}ν_{P} and along the optical axis the RI is nₑ=n_{L}+(nₑ−n_{L})σ_{Pzz}ν_{P}. In anticipation of sections on DEP and NP orientation control assume that angular rotation is impressed on colloidal NPs point-to-point in the xz-plane with a gradient magnitude γ and in a gradient direction β such that NP rotation obeys

θ(x,z)=θ₀+γ[(x−x₀)cos β+(z−z₀)sin β], (150)

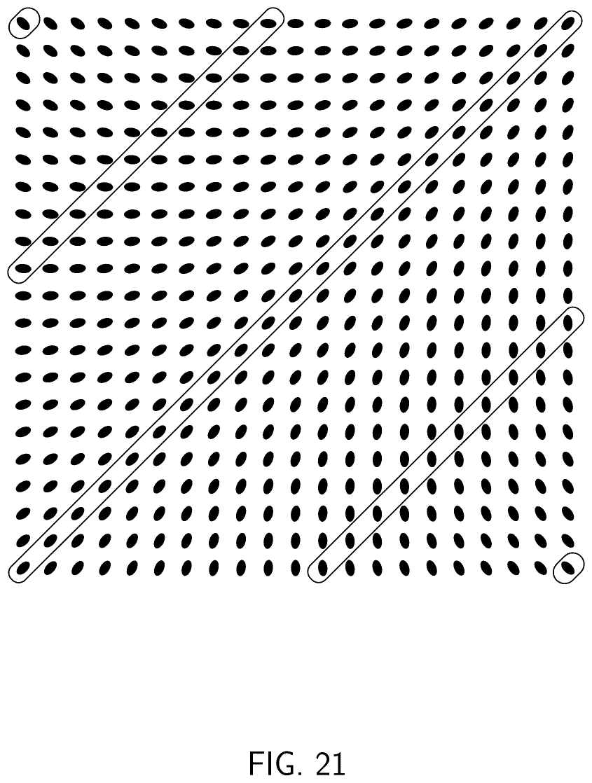

which is similar to Eq. 269. Eq. 150 is not a strict requirement, but it is convenient and illustrative of how to implement Eq. 150 electronically is discussed later in this document in the section on DEP. Note, a constant ν_{P} is set during colloid synthesis, θ₀ is set by the electronic initialization and {γ, x₀, z₀} are dynamically set by the electronics, as discussed in the next sections. Due to difficulty in obtaining analytic geodesics, numerical solutions of Eqs. 136, 149, and 150 are shown in FIGS. 21-25.

A more advanced OMP system might be desired to have more than just simple beam steering. For example, it is often desired to focus light with point-to-point ordering for image magnification and processing. As another example, it is often desired to focus light without point-to-point order, but rather with strict control on the energy distributions. This is often the case in non-imaging optics. In these cases it may be more useful to provide higher order orientations of NP according to

$$θ ( x , z ) = {θ}_{0} + {\sum }_{m = 1}^{{M}_{θ}} {γ}_{m} [ {( x - {x}_{m} )}^{m} cos {β}_{m} + {( z - {z}_{m} )}^{m} sin {β}_{m} ] \qquad ( 151 )$$

and even more extensive distributions of orientation, comprising NP zenith angles θ(x, y, z) and azimuth angles ϕ(x, y, z) are possible.

FIG. 21 shows a regular grid sampling of the rotation state of the index ellipsoid with nₑ>nₒ in the xz-plane The rotation varies from point-to-point as specified by Eq. 150. In the upper left hand corner the RI ellipsoid has θ₀=π/4, then the direction of the gradient is β=−π/4 towards the lower right hand corner, and the gradient sign and magnitude is set to provide π radians of counter clock wise NP rotation from the upper left corner to the lower right corner. Encircled regions demonstrate several examples of iso-contours of the rotation-angle θ(x, z).

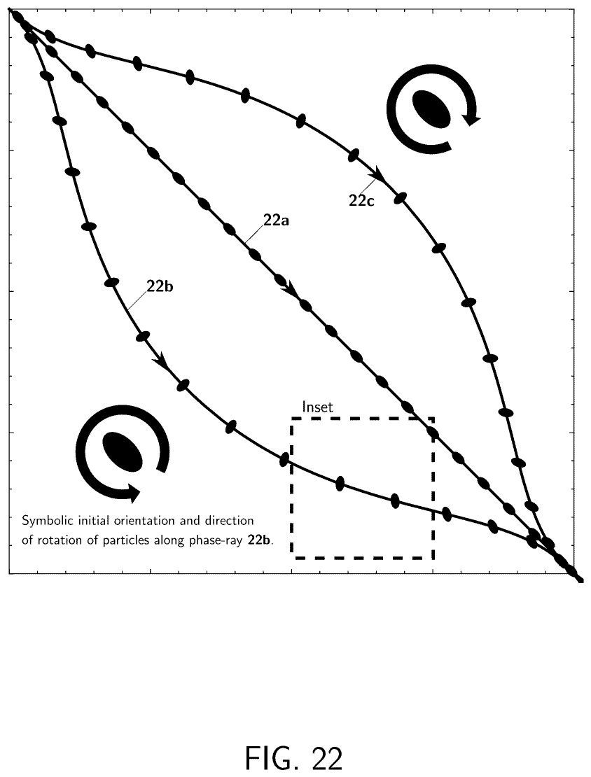

FIGS. 22-25 are symbol coded to specify rotation direction: counter-clockwise and clockwise. A RI ellipsoid's initial orientation is represented by an ellipse surrounded by a rotation arrow to reinforce NP rotation direction along a ray.

In FIG. 22 the phase-ray trajectories of light, which is initially propagating from the upper left corner to the lower right corner, for three different values γ∈{−1, 0, +1} to provide as much as π radians of rotation. In the trivial case, when the rotation gradient is zero, the orientation of the RI-ellipsoids does not change and the light propagates along a straight line as shown by the null angular rotation ray 22a. RI ellipsoids also provide a positive angular rotation ray 22b and a negative angular rotation ray 22c. Notice that the initial angular orientation of the RI-ellipsoid in the upper-left and corner is with the long axis of the RI-ellipsoid parallel to the input light ray. The initial conditions and rotation direction are also shown schematically in the figure. The inset of FIG. 22 is expanded and discussed later regarding FIG. 25.

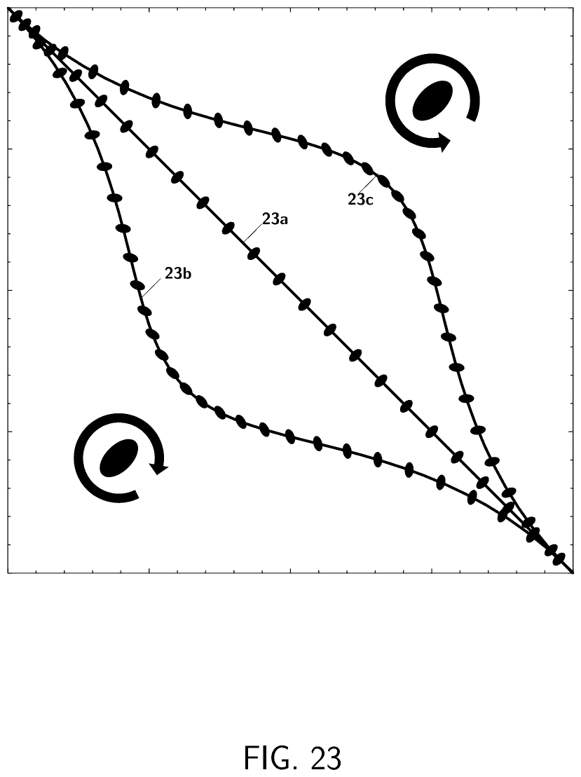

FIG. 23 shows the resulting trajectories of a phase-ray initially propagating from the upper left corner to the lower right corner when the index ellipsoid's short axis is aligned with the direction of propagation and for three different values γ∈{−1, 0, +1} to provide as much as π radians of rotation of the NPs. In the trivial case, when the rotation gradient is zero, the orientation of the RI-ellipsoids does not change and the light propagates along a straight line as shown by the null angular rotation ray 23a. RI ellipsoids also provide a positive angular rotation ray 23b and a negative angular rotation ray 23c. Notice that when the short axis of the RI ellipsoid is initially aligned with the input light that the direction of rotation of the NP (and RI ellipsoids) provides ray propagations in the opposite directions to that in FIG. 22. Also, the spacing between the RI-ellipsoids in both FIG. 22 and FIG. 23 is the same optical path length.

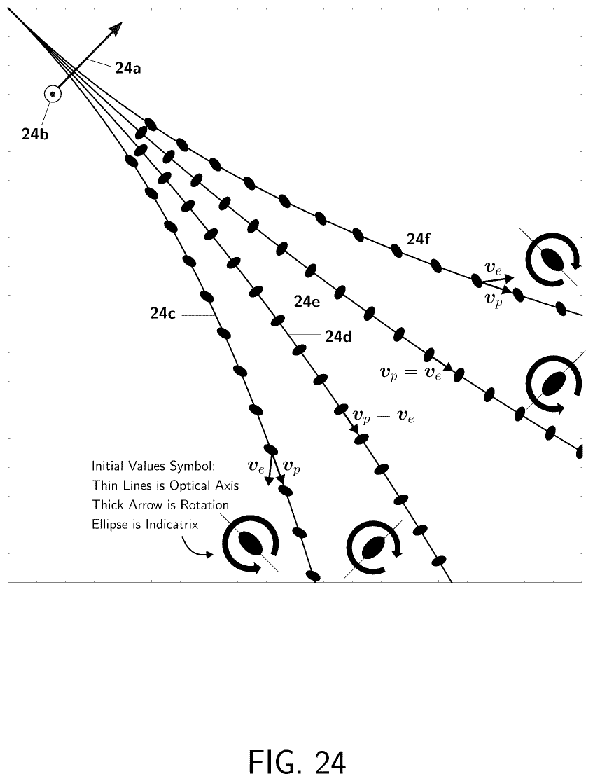

In FIG. 24 we see important examples that show how the alignment of an indicatrix impacts the phase ray and energy ray trajectories. Four cases are provided that have different initial conditions and corresponding outputs. The initial value symbols show the initial state of the indicatrix, the direction of the optical axis in a uniaxial system, the impressed rotation direction of NPs by DEP along the shown phase-ray trajectories. The in-page field is 24a and the out-of-page field 24b can be either electric fields or a magnetic fields as will be indicated in the case by case analysis below.

Phase ray-1 24c shows NPs that rotate counter-clockwise. This ray has an NPs that are initially orientated so that the optical axis is aligned along the phase-ray trajectory. Moreover, the phase velocity νₚ and energy velocity νₑ (both shown) are generally not pointing in the same direction as can be seen by the vectors shown attached to phase ray-1 24c explicitly. If at least one of the in-page field 24a and the out-of-page field 24b are magnetic fields that are perpendicular to the assumed initial optical axis then the e-wave will be redirected on a curved trajectory as shown. If the in-page field 24a is an electric field that is perpendicular to the assumed initial optical axis then the e-wave will not be supported and the light will simply pass through the colloid region as an o-wave without being redirected. If the out-of-page field 24b is an electric field that is perpendicular to the assumed initial optical axis then the e-wave will not be supported and the light will simply pass through the colloid region as an o-wave without being redirected. This case is not shown in the figure to reduce clutter.

Phase ray-2 24d shows NPs that rotate clockwise, have initial orientation of NPs with the optical axis perpendicular to the phase-ray trajectory and the phase velocity νₚ and energy velocity νₑ (both shown) are pointing in the same direction. If the in-page field 24a is an electric field that is parallel to the assumed initial optical axis then the e-wave will be supported and the phase-ray will bend as it makes its way through the colloid region as an e-wave without being redirected. If the out-of-page field 24b is an electric field that is perpendicular to the assumed initial optical axis then the e-wave will not be supported and the light will simply pass through the colloid region as an o-wave without being redirected. This case is not shown in the figure to reduce clutter. Phase ray-3 24e and Phase ray 4 24f are mirrors of the Phase ray 2 and Phase ray 1 respectively.

The main points to take from FIG. 24 are: (1) aligning the optical axis of the NPs with the electric field at the entry point of the light into the colloid allows easy coupling to the e-wave for one polarization, (2) the other orthogonal polarization can be redirected with another layer of colloid or by converting all input polarizations into the desired e-wave polarization, (3) the direction of rotation of the NPs in the colloid chooses the direction of the bending of the phase-rays, (4) there is an optimal rotation angle gradient value γ that keeps the electric field parallel to the optical axis of the NPs while the beam is bent and redirected so that that νₚ=νₑ always, and (5) it is possible to set up the geometry so that νₚ≠νₑ, but this is a bit complex to see, (6) whenever the out-of-page electric field is perpendicular to the in-page optical axis only o-waves propagate and there is no bending of the phase-ray or energy-ray, and (7) it is possible for the energy to start to travel backwards, see for example νₑ of Phase ray-4 24f.

Thus, it is clear that the initial angle of the RI indicatrix, the direction of indicatrix rotation along a phase ray, the optical electric field polarization, and the rate of NP rotation γ all have a significant impact on the resulting light trajectory. Again, engineering design within this beam steering system is easiest with optical electric field that are polarized parallel to the optical axis of the indicatrix at each point in the colloid. This is a nice attribute to apply to engineering designs, but it is not a necessity.

FIG. 25 shows what is going on in a magnified view from FIG. 22. In particular, the phase-ray trajectory curvature is controlled by the gradient in the effective RI, such that RI ellipsoids normal to the light trajectory present angles ϕ₁<ϕ₂ so that n(ϕ₁)>n(ϕ₂), whereby light with linear optical momentum dp₁ is transformed into light with linear optical momentum dp₂, thereby forming the next segment of the phase-ray light trajectory by Eq. 123. In this way the light curves towards the increasing RI that is perpendicular to the light trajectory.

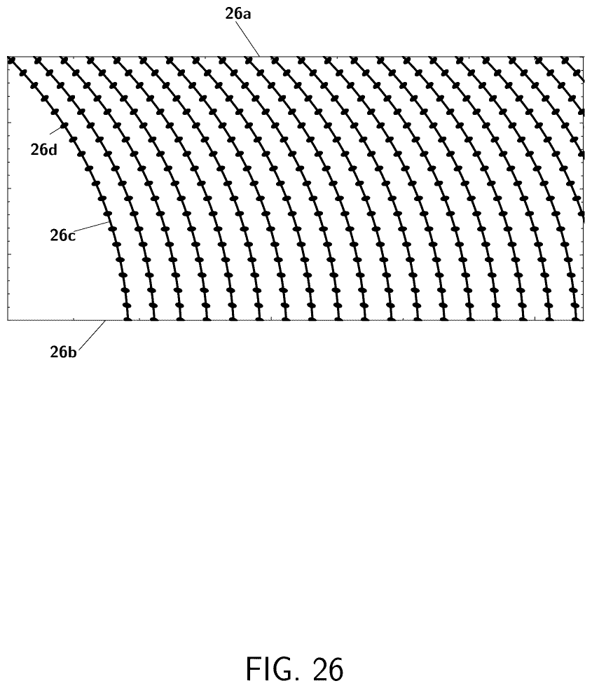

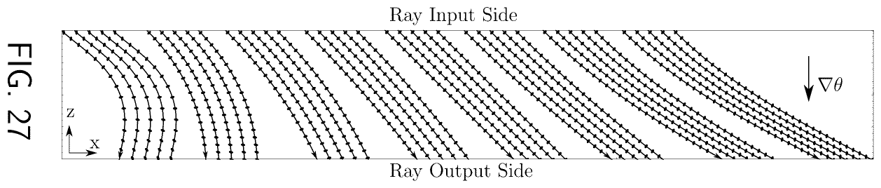

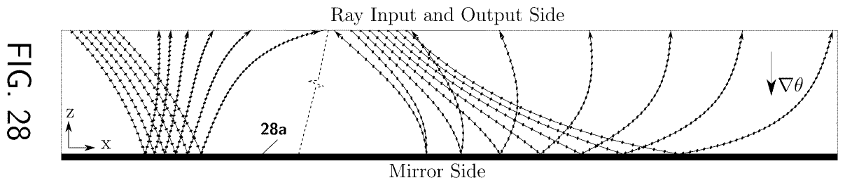

FIG. 26 shows a section of colloid with a plurality of rays propagating from a colloid input surface 26a to a colloid output surface 26b. The configuration was chosen so that νₚ=νₑ for an electric field that is parallel to the optical axis. An example ray 26c is show curved downward. Along the example ray are a plurality of RI-ellipsoids 26d spaced at a constant optical path length. Notice that unlike I-GRIN optics this A-GRIN optic, in principle, has no need for a “fly back” region as described by Morris [8] this is a major advantage over many prior-art refractive beam steering methods. Similarly, in landscape FIG. 27 several different examples or beam steering through a colloid sheet are shown so that the reader may appreciate the extent of the beam steering process. For the avoidance of doubt these colloid sheets would in practice have transparent sheets, e.g. glass, that sandwich them and provide appropriate electronic signals. This will be described in more detail shortly. FIG. 28 is similar to FIG. 27, except that a mirror 28a is used to so that an active mirror is demonstrated.

### Pondermotive Forces & Torques in DEP Processes

An electrically neutral NP in a liquid that is subjected to a nonuniform electric field Eᵢₙ(r,ω) will become polarized with a charge −q(ω) at r and +q(ω) at r+d. The total average force and torque are respectively

$$F ( r , ω ) = \frac{1}{2} Re \{ q ( ω ) {E}_{in}^{*} [ r + \frac{d}{2} , ω ] + \{ - q ( ω ) \} {E}_{in}^{*} [ r - \frac{d}{2} , ω ] \} \qquad ( 152 )$$

$$T ( r , ω ) = \frac{1}{2} Re \{ \frac{d}{2} \times q ( ω ) {E}_{in}^{*} [ r + \frac{d}{2} , ω ] + \frac{- d}{2} \times \{ - q ( ω ) \} {E}_{in}^{*} [ r + \frac{d}{2} , ω ] \} \qquad ( 153 )$$

where x is the cross product and pₚₐᵣ=q(ω)d. By Taylor expansion of Eqs. 152-153 and exploiting Eq. 2 we obtain

$$F = \frac{1}{2} Re [ {p}_{p a r} \cdot ∇ {E}_{i n}^{*} ] and T = \frac{1}{2} Re [ {p}_{p a r} \times {E}_{i n}^{*} ] , \qquad ( 154 )$$

where pₚₐᵣ=∈_{med} [symbol] Eᵢₙ.

It should be noted that torques and rotations are easier to establish in a colloid than forces and translations. Consider the ratio of torque to the forces times the moment arm d (10 nm) associated with a torque so that a colloid in a gap of thickness g (10 μm) as a ratio

$$\frac{T}{F d} ∼ \frac{{E}^{2}}{E d ∇ E} ∼ \frac{E}{d ( E / g )} ∼ \frac{g}{d} ∼ \frac{10 μm}{10 nm} ∼ 1 , 000 \qquad ( 155 )$$

and it is expected that the electrical signals needed are 1,000 times less in amplitude for torquning rotations than for translating forces.

### Colloids With Memory

A particle that is translated, oriented, and deformed may have inherent memory of its state because it will tend to stay in its final position, orientation, and shape for some time, even under the influence of thermal Brownian movement. The viscosity of the medium may by high-enough to “pin” or “park” the particle position, orientation, and shape. This is effectively an analog memory, where relaxation of the state occurs over time when the system is not being forced by DEP. This property allows time division multiplexing of electrodes. Thus, a sub-set of electrodes can refresh the state of a thin optical device before the state of a particle has changed very much. Unlike a display that uses capacitance to hold the state of the pixel, these devices use viscosity to perform very much the same function.

### Pixel-By-Pixel Beam Steering & Concentration

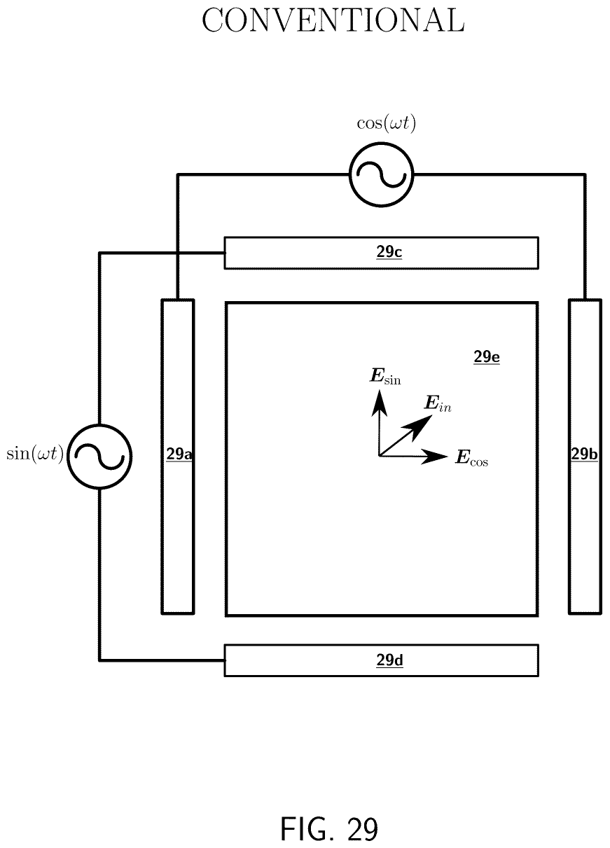

In FIG. 29 a prior-art quadrupole electrode configuration energizes a colloid volume. In particular, cos ωt voltage source energizes electrodes 29a and 29b and sin ωt voltage source energizes electrodes 29c and 29d so that within the colloid region 29e orthogonal electric fields that are in phase-quadrature are formed to provide Eᵢₙ=E_{cos}+iEₛᵢₙ, which is a rotating electric field that can be used to provide torques to rotate NPs. Unfortunately, this prior-art technique takes four electrodes and is not compatible with a thin gap between two transparent plates.

Therefore, consider ∇·B=0 so that B=∇×A. This result can be plugged back into Maxwell's equations to find, on choosing a Lorentz gauge, that

$${∇}^{2} ϕ - ( \frac{ω}{c} ) \frac{{\partial }^{2} ϕ}{\partial {t}^{2}} = - \frac{{ρ}_{f}}{ϵ} and {∇}^{2} A - {( \frac{ω}{c} )}^{2} \frac{{\partial }^{2} A}{\partial {t}^{2}} = - μ J \qquad ( 156 )$$

such that

$${E}_{i n} = - ∇ ϕ - \frac{\partial A}{\partial t} . \qquad ( 157 )$$

However, for quasielectrostatic (MHz-scale) DEP harmonic signals with ∝(w/c)²<<1, scalar ϕ and vector potential A wave-equations reduce to the phasor equations

$${∇}^{2} ϕ = - \frac{ρ f}{ϵ} ,$$

∇²A=−μJ, with Eᵢₙ=(−∇ϕ)+i(−ωA)≡E_{⊥}+iE_{∥}. (158)

However, from the theory of Green's functions [10] the solutions to Poisson equations Eqs. 158 are convolution integrals

$$ϕ ( r ) = \frac{1}{4 πϵ} \int \frac{{ρ}_{f} ( {r}^{′} )}{\vert r - {r}^{′} \vert} {d}^{3} {r}^{′} and A ( r ) = \frac{μ}{4 π} \int \frac{{J}_{f} ( {r}^{′} )}{\vert r - {r}^{′} \vert} {d}^{3} {r}^{′} \qquad ( 159 )$$

with primed “source points.” For a colloid very close to an electrode, the shape of the electrode is not important away from its edges, therefore for convenience let a circle approximate a square electrode. For f(r′)=F₀δ(z′) then

$$\int \frac{f ( {r}^{′} )}{\vert r - {r}^{′} \vert} {d}^{3} {r}^{′} \approx 2 π {F}_{0} {\int }_{{η}^{′} = 0}^{w / 2} \frac{{η}^{′} d {η}^{′}}{\sqrt{{( {η}^{′} )}^{2} + {z}^{2}}} \approx π w {F}_{0} [ - \frac{2 \vert z \vert}{w} + \sqrt{1 + \frac{4 {z}^{2}}{{w}^{2}}} ] \qquad ( 160 )$$

which can be shown by simply plotting, is very nearly

$$\int \frac{f ( {r}^{′} )}{\vert r - {r}^{′} \vert} {d}^{3} {r}^{′} \approx π {wF}_{0} {e}^{- 2 \vert z \vert / w} \qquad ( 161 )$$

For a voltage-sheet take F₀=ρ_{fs}/(4π∈), where ρ_{fs} is the free surface charge, so that ϕ≈ωρ_{fs}/(4∈)e^{-2|z|/ω} and at z=0 the electrode potential is V₀=ωρ_{fs}/(4∈₀). Therefore, ϕ=(V₀/∈ᵣ)e^{-2|z|/ω} and the field is

$${E}_{⊥} \approx \pm [ \frac{2 {V}_{0}}{{wϵ}_{r}} ] {e}^{- 2 \vert z \vert / w} \hat{z} \qquad ( 162 )$$

For a current-sheet F₀=μJₓₛ/(4π)=μ₀I₀/(4πω), where I₀ is the current through the electrode's edge at z=0 and

$${E}_{‖} \approx - [ \frac{ω {μ}_{0} {I}_{0}}{4 {ϵ}_{r}} ] {e}^{- 2 \vert z \vert / w} \hat{x} , \qquad ( 163 )$$

where the factor of ∈ᵣ is included to reduce the field from induced polarization charges in the colloid. Note that ∈ᵣ cancels out of the electric field factor in any ratio, e.g. as in Eq. 165 below.

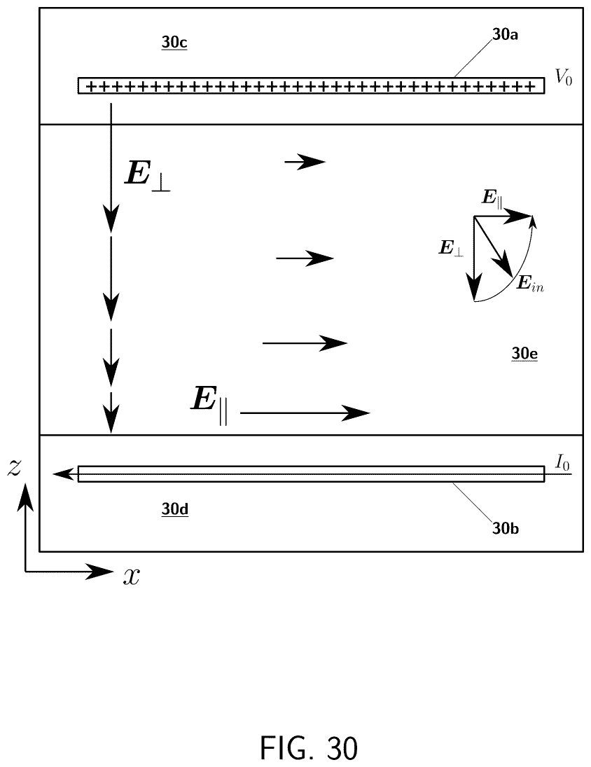

Having developed the electric fields now consider an alternative approach to manipulating NPs where each light-steering “pixel” may comprise one or two transparent electrodes—e.g. indium tin oxide. In FIG. 30, there are two electrodes. A voltage electrode 30a and a current electrode 30b. These electrodes are embedded in a first transparent plate 30c and a second transparent plate 30d respectively and sandwich a colloid 30e. The electric fields E_{⊥} and E_{∥} are shown in FIG. 30 to decay exponentially in strength away from the electrodes. Notice that if the DEP frequency is ω=0 then E_{∥}=0. Thus, when the DEP frequency is not zero at every point within the colloid 30e there is a rotating electric field Eᵢₙ=E_{⊥}+iE_{∥} from orthogonal and phase-quadrature fields. The resulting field is used to manipulate NP orientation, as will be discussed later.

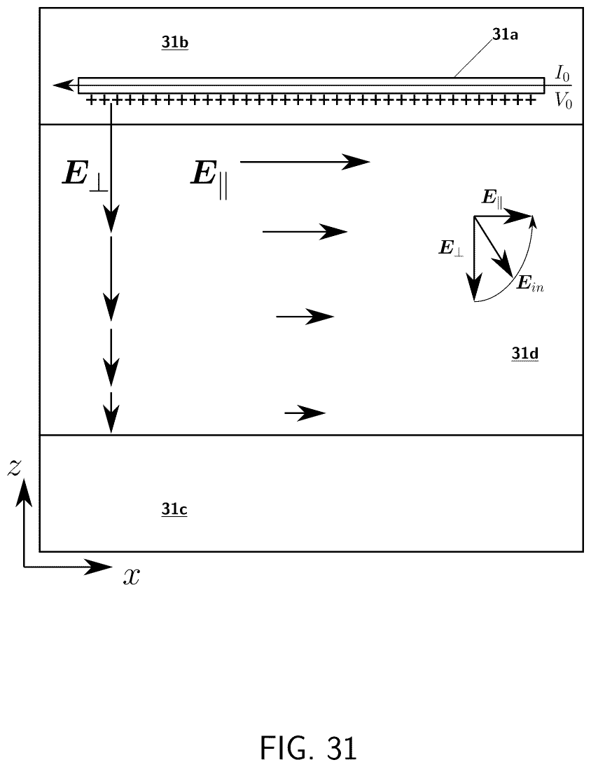

In FIG. 31, there is one hybrid electrode 31a that provides the function of a voltage electrode and a current electrode. These electrodes are embedded in a first transparent plate 31b, while a second transparent plate 31c has no electrodes. The resulting electric fields E_{⊥} and E_{∥} are shown in FIG. 31 to decay exponentially in strength away from the electrodes. As in the prior figure, if the DEP frequency is ω=0 then E_{∥}=0. Thus, when the DEP frequency is not zero at every point within the colloid 31d there is a rotating electric field Eᵢₙ=E_{⊥}+iE_{∥} from orthogonal and phase-quadrature fields. The hybrid electrode 31a is implemented with suitable current and voltage sources connected to the electrode. Again, the resulting field is used to manipulate NP orientation.

Thus, electrodes are energized to provide a voltage-sheet and a current-sheet or a hybrid voltage-current sheet respectively. Voltage-sheets provide normal z-directed electric fields and current-sheets provide parallel electric fields to the electrodes and in potentially two orthogonal directions {x, y}, where the y direction is into the page of the figures, for two-degree-of-freedom beam steering. From Eq. 150 and FIGS. 22-28, A-GRIN beam-steering requires: a specific rotation angle θ₀ in the xz-plane of RI-ellipsoids at the optical input surface; and conveniently a specific angle-gradient γ along (±\hat{z}).

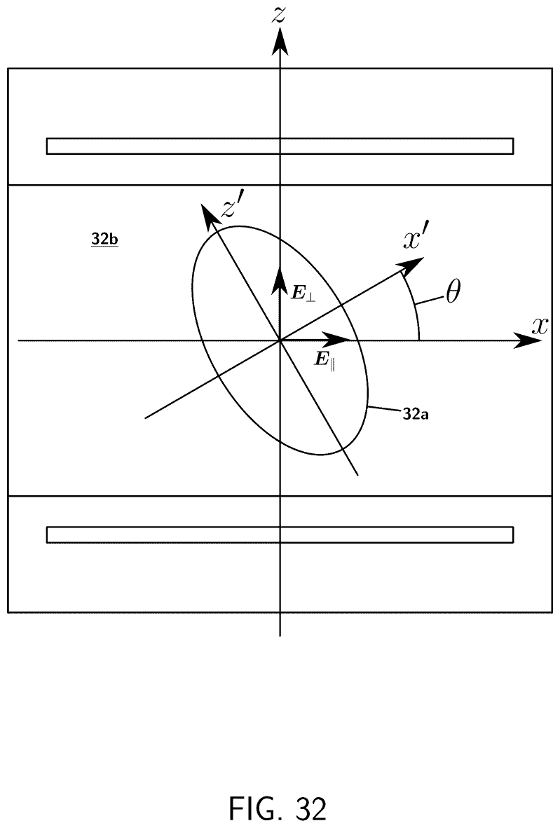

Consider FIG. 32, where a schematic of a RI ellipsoid 32a is provided in a colloid 32b as was discussed in the prior two figures. The RI ellipsoid (indicatrix) is at an angle θ to the x-axis. Therefore, an electric field perpendicular to a voltage sheet is given by E_{⊥}=E_{⊥}\hat{z}=E_{⊥}[sin θ\hat{x}′+cos θ\hat{z}′] and an electric field parallel to a current sheet is E_{∥}=E_{∥}\hat{x}=E_{∥}[cos θ\hat{x}′−sin θ\hat{z}′]. Phase quadrature fields are Eᵢₙ=E_{⊥}+iE_{∥}, where i=\sqrt{−1}. Writing a colloid's frequency response of Eq. 3 as χ̅(ω)=iχ̅_{R}(W)+iχ̅_{I}(ω), then Eqs. 154 become

$$T = \text{} \frac{{ϵ}_{m e d} V {\hat{y}}^{′}}{2} [ \text{} {E}_{⊥ \text{}} {E}_{‖} ( {χ}_{I {x}^{′} {x}^{′}} + {{χ}_{I}}_{{z}^{′} {z}^{′}} ) - \frac{1}{2} ( {E}_{⊥}^{2} - {E}_{‖}^{2} ) ( {χ}_{{Rx}^{′} {x}^{′}} - {χ}_{{Rz}^{′} {z}^{′}} ) sin ( 2 θ ) ] . \qquad ( 164 )$$

There are two ways to use this NP torque. First, if NPs rotate by the Born-Lertes effect [11], i.e. whenever E_{⊥}=E_{∥} and/or χ_{Rz′z′}=χ_{Rx′,x′}, then NP torque is balanced out by viscous frictional forces as described again in reference [11]. As electric fields decay away from the electrodes the rotation rate decreases and over a short rotation-pulse time Δt the RI-ellipsoids rotate to different angles for beam steering. Second, setting NP torque of Eqs. 164 to zero, when E_{⊥}≠E_{∥} and χ_{Rz′z′}≠χ_{Rx′,x′}, provides the steady-state RI-ellipsoid (and NP) orientation angles θ as

$$sin ( 2 θ ) = [ \frac{2 {E}_{⊥} {E}_{‖}}{{E}_{⊥}^{2} - {E}_{‖}^{2}} ] ( \frac{{χ}_{{Ix}^{′} {x}^{′}} + {χ}_{{Iz}^{′} {z}^{′}}}{{χ}_{{Rx}^{′} {x}^{′}} - {χ}_{{Rz}^{′} {z}^{′}}} ) . \qquad ( 165 )$$

In summary, harmonic voltage and current sheets in proximity of colloid layer induce orthogonal phase-quadrature electric fields that decay exponentially (but are nearly linearly across a thin colloid sheet) away from the electrodes. By adjusting voltage, current, and DEP frequency then RI-ellipsoids, and the associated NPs, are configured in angle in the z-direction by one of a switched NP rotation process or a steady state DEP process for beam steering of light.

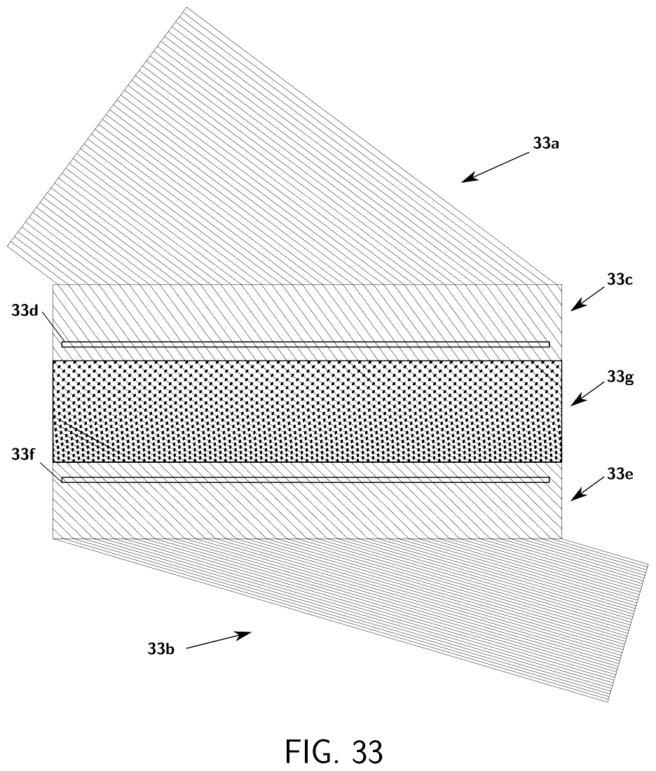

In FIG. 33 input light 33a is converted into output light 33b that is propagating into a different direction. The beam steering pixel comprises a first transparent layer 33c with a first electrode 33d. The beam steering pixel also comprises a second transparent layer 33e with a second electrode 33f. Sandwiched between the first transparent layer 33c and the second transparent layer 33e is a colloidal layer 33g where nanoparticles are rotated by the electric signals on the first electrode 33d and the second electrode 33f. One of the electrodes is to be a harmonic voltage electrode and the other is to be a harmonic current electrode. This will provide orthogonal electric fields that are in phase quadrature (π/2 radians) out of phase. With the correct application of voltages and currents the NPs create an orientation gradient so that light can be bent to effect light steering and concentration. This is all completely controllable with DEP voltages, currents, and frequencies.

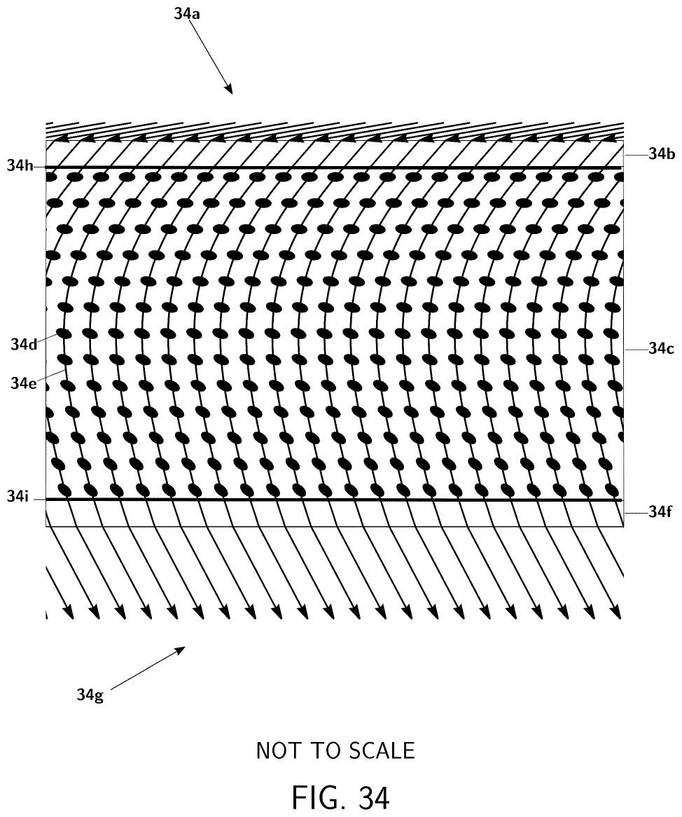

FIG. 34 shows a beam steering device based on optometaphoresis having input rays 34a that refract through a first transparent panel (also called a plate) 34b into a thin colloid layer 34c comprising a plurality of spatially averaged refractive index ellipsoids, such as refractive index ellipsoid 34d. The rays in the colloid layer 34c are generally curved as shown by the representative curved ray 34e. These curved rays refract out of the colloid layer through a second transparent panel 34f and exit the beam steering device as output rays 34g. On or in proximity to the input surfaces of the first and second transparent panels 34b and 34f there are electrodes. For example, a voltage sheet electrode 34h and a current sheet electrode 34i are shown in the figure. These electrodes provide rotating electric fields that provide torques that provide a diffusive type rotation of NPs to a final state that is consistent with a specific angular orientation distribution of the nanoparticles and the refractive index ellipsoids. In the specific case of FIG. 34 the angular rotation varies linearly from the proximity of the voltage sheet electrode 34h to the current sheet electrode 34i, as provided by Eq. 150 with specific selection of β so that the direction of the gradient is from voltage to current sheet electrodes. This is only an example and other spatial distributions of the refractive index ellipsoid is possible. For example, instead of maintaining parallel rays, it might be desired to have converging or diverging rays for a specific optical system. Carefully note that in FIG. 34 that the orientation of the NPs and refractive index ellipsoids are constant at each colloid-transparent panel boundary. This is a nice convenience as it simplifies the ray trajectories to be the same throughout the colloid for beam steering. Said another way, the refractive index ellipsoids along the voltage sheet electrode 34h and the refractive index ellipsoids along the current sheet electrode 34i are constant, but rotated relative to each other. Also note that the placement of the voltage and current sheet electrodes may be reversed, though the distribution of NPs may have to change the basic principles are the same and light steering and control remains possible.

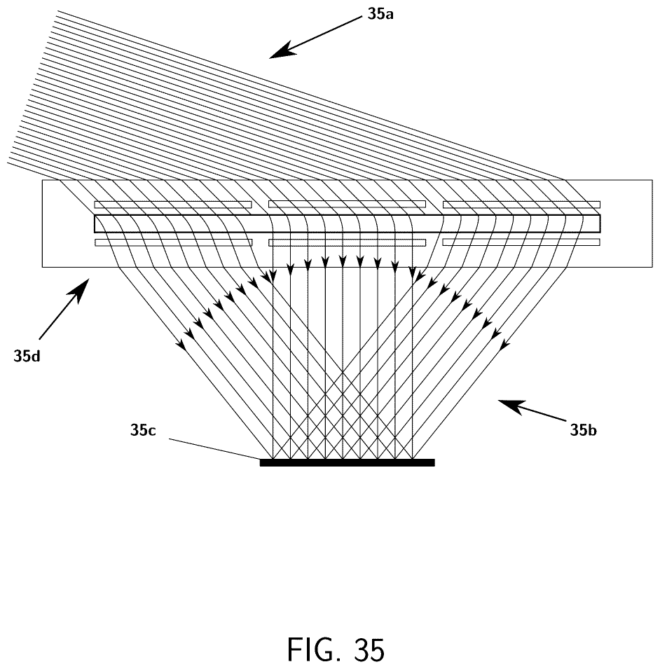

In FIG. 35 shows a beam steering array in cross-section, where each light beam steering pixel is configured to steer light to a specific focus region. An input light beam 35a is transformed into a plurality of output light beams 35b that focus to a common focus region 35c by means of a plurality of beam steering pixels 35d that are individually controlled to by voltage and current sheet electrodes, as depicted here in FIG. 35 and explained in detail in the prior figures and teachings of this document.

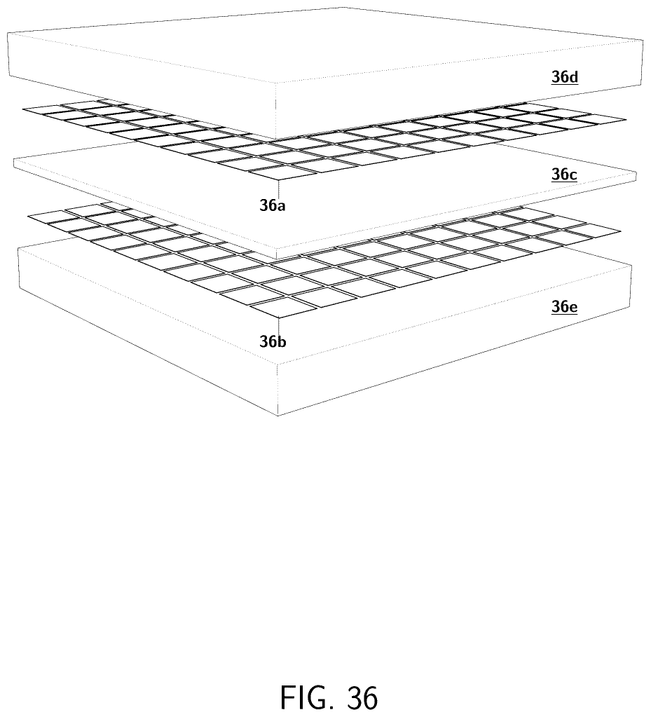

FIG. 36 shows a three dimensional perspective and exploded view of a beam steering array that comprises a plurality of voltage electrodes 36a and current electrodes 36b that surround a nanoparticle colloid 36c. The system is supported by a first transparent layer 36d and a second transparent layer 36e.

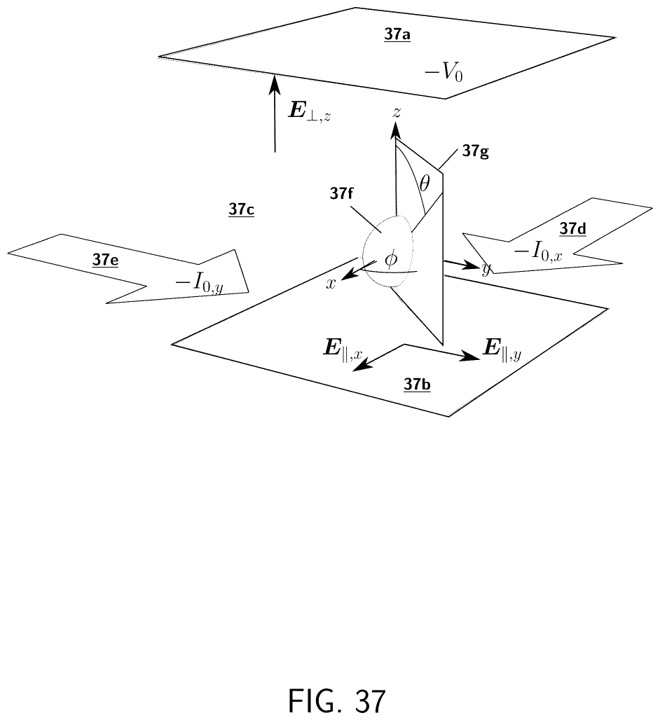

Finally, it should be noted that while Eq. 150 shows an example “zenith” angle θ as a function of position, it is also true that an “azimuth” angle ϕ (not to be confused with electric potential) can also be controlled by DEP simply by allowing the current electrode to support currents in different orthogonal directions as shown in FIG. 37. In particular, for a Two Degree Of Freedom (2-DOF) beam steering system a voltage electrode 37a and a current electrode 37b sandwich a colloid region 37c therebetween. The voltage electrode 37a is energized at a frequency ω with a phasor amplitude V₀ to generate an electric field E_{⊥,z} in the colloid region 37c. The current electrode 37b can be driven by an x-current sheet 37d of magnitude I_{0,x} to generate electric field E_{∥,x} in the colloid region 37c. The current electrode 37b can also be driven by a y-current sheet 37e of magnitude I_{0,y} to generate electric field E_{∥,y} in the colloid region 37c. The total field is then given by

Eᵢₙ=E_{⊥,z}+iE_{∥,y}+iE_{∥,x} (166)

where i=\sqrt{−1}, provides an orientation to each three dimensional RI ellipsoid 37f. This orientation is provided as a point function within the colloid by θ=θ(r) and ϕ=ϕ(r), where r is the position vector of a colloid voxel. In this way it is possible to set a beam steering plane 37g and bend light along arbitrary trajectories for beam steering, concentration, and other optical functions.

### Large-Area Electrodes for Translation & Orientation of NPs

The conventional “sheet” electrodes of the prior section have advantages in some applications and shortcomings in other applications. First, conventional electrodes of the previous section have fringing fields that are not perfectly parallel or perpendicular to a planar electrode sheet and this is not always desired. Second, it is less reliable and more complex to have many small conventional electrodes with separate drive electronics and interconnects unless it is absolutely needed for the desired application. Third, many applications naturally require beam steering over large areas so in these cases the small electrodes are not matched to the scale of the application. Fourth, some applications require both focusing and wavefront compensation of light over large areas. For example, steering and focusing sunlight with thousands of meter-square panels for a solar energy application is best done with larger electrodes just due to the scale of the problem. Additionally, control over beam steering, focusing, and coupling into and out of guided modes is often needed to improve the performance in 3D printing or in augmented reality applications.

In a first use-case it is desired to have large electrodes, even up to many square meters or more. In a second use-case it is desired to provide nuanced control over the electrodes fields to provide optical focusing, ingress to optical guided waves, egress from guided waves, and general wavefront control. In both use cases the more ideal the electrodes the greater the flexibility of use for optics. This is highly desired. Therefore, in this section alternatives are provided to the small sheet-electrodes used to introduce the subject in the previous section.

Recall, that in the prior section conventional electrodes were sized small enough to provide a linearly decreasing field strength into the colloid sheet according to e^{-2|z|/ω}≈1−2|z|/ω. Notice that as an electrode gets larger ω→∞, then the electric field goes to a constant, e.g. see Eqs. 162-163. This undermines the ability to create a colloid with linearly varying NP orientation.

To overcome this problem let's first begin with an observation: a point-charge has an electric field that falls off as r⁻², an infinitely long line-charge has an electric field that falls off as r⁻¹, and an infinite area charge-sheet has an electric field that falls off as r⁻⁰. Thus, a line-charge has an electric field that decays spatially away from the source and this can be utilized to provided the needed electric field decay within a colloid sheet to provide an orientation gradient of NPs. The vector electric field points radially away from the line-charge. Therefore, a strategy is to combine a plurality of separate long line-sources, all in parallel, to make a large-area charge sheet with the needed linear electric field decay, for an electric field pointing normal to the electrode plane. The charges are induced by voltages on the electrodes. Neighboring line-charges in a source-plane will cancel electric fields that are also tangent to a plane, while enhancing electric field that are normal to the source-plane. An additional advantage of this discrete segmentation strategy for electrode design is that it becomes possible to separately adjust the amount of charge on each line-charge in the source-plane and to even adjust the position of the line-charges away form the original source-plane to control the linearity, uniformity, and directionality of the electric fields so that the deleterious effects of fringing fields are nullified and a desired decaying electric field is provided. This strategy is to be called the electrode segmentation strategy. The electrode segmentation strategy may also be used for current electrodes with electric fields tangent to the source plane.

There is much to discuss to understand the electrode segmentation strategy, including: (1) Electric fields of line-charges, i.e. induced from voltages, (2) Electric fields of line-currents, (3) Apodization of segmented line-sources to manage fringing fields, (4) Apodization of segmented line-sources to focus light, (5) Apodization to manage parasitic capacitive coupling, (6) Apodization to Manage parasitic inductive coupling, (7) The complication of charge neutrality for line-currents, (8) Electrodes on one or both sides of a colloid sheet, (9) Static electrode embodiments, and (10) Reconfigurable electrode embodiments with each line individually controlled with additional electronics.

The form of the electric fields for both line-charges and line-currents may be derived by starting with Eq. 159. In this disclosure the simplifying assumption of an infinitesimally thin, but finite length L wire is assumed. Then both equations of Eq. 159 take the form of a convolution so for a line source s(r′) of length L where the line is along the x-axis from x=−L/2 to x=+L/2 then

$$\begin{matrix}ψ ( r ) = \frac{1}{4 π} \int \frac{s ( {r}^{′} )}{\vert r - {r}^{′} \vert} {d}^{3} {r}^{′} \\ = \frac{{S}_{0}}{4 π} \int \frac{δ ( {y}^{′} ) δ ( {z}^{′} ) {dx}^{′} {dy}^{′} {dz}^{′}}{\sqrt{{( x - {x}^{′} )}^{2} + {( y - {y}^{′} )}^{2} + {( z - {z}^{′} )}^{2}}} \\ = \frac{{S}_{0}}{4 π} {\int }_{- \frac{L}{2}}^{+ \frac{L}{2}} \frac{{dx}^{′}}{\sqrt{{( x - {x}^{′} )}^{2} + {y}^{2} + {z}^{2}}}\end{matrix} \qquad ( 167 )$$

$$= \frac{{S}_{0}}{4 π} {\int }_{- \frac{L}{2}}^{+ \frac{L}{2}} \frac{{dx}^{′}}{\sqrt{{( x - {x}^{′} )}^{2} + {r}^{2}}} let ( x - {x}^{′} ) = r sin h θ = \frac{{S}_{0}}{4 π} {\int }_{{sinh}^{- 1} [ \frac{x - L / 2}{r} ]}^{{sinh}^{- 1} [ \frac{x + L / 2}{r} ]} d θ = \frac{{S}_{0}}{4 π} \{ {sinh}^{- 1} [ \frac{x + L / 2}{r} ] - {sinh}^{- 1} [ \frac{x - L / 2}{r} ] \} .$$

Also note that we can (1) Taylor expand Eq. 167 about x=0 for a first result and take the limit (without the Taylor expansion) as L tends to infinity for a second result, then

$$ψ ( r ) \approx \frac{{S}_{0}}{2 π} {sinh}^{- 1} [ \frac{L}{2 r} ] \qquad ( 168 )$$

$${lim}_{L \to ∞} [ - ∇ ψ ( r ) ] = \frac{{S}_{0}}{2 π r} \hat{r} \qquad ( 169 )$$

Note that the gradient is independent of any \hat{x} component. Therefore, from Eqs. 158 with the appropriate S₀ used by inspection we obtain

$${E}_{C u r r e n t} = - ω \frac{{μ}_{0} {I}_{0}}{2 π} {sinh}^{- 1} [ \frac{L}{2 r} ] \hat{x} \qquad ( 170 )$$

$${E}_{Charge} = \frac{{ρ}_{L}}{2 π ε} \frac{\hat{r}}{r} \qquad ( 171 )$$

where ρ_{L} is the charge per unit length and I₀ is the current. Note, that it's easy to check E_{Charge} by an application of Gauss's law to ∇·E=ρ_{f}/∈. however it is not easy to obtain the result for E_{Current} by an application of Gausses law or Stokes law, because L taken to infinity requires setting the potential at infinity to something other than zero.

By way of review, an oscillating charge distribution on an infinitely long wire is induced by an oscillating voltage and will produce an electric field that is radially directed from each wire. Its magnitude extinguishes as r⁻¹ so that it is zero at infinity. Similarly, an oscillating current distribution on a finite length wire, which is induced by a current source, will produce an electric field that is directed along the line-wire and the electric field extinguishes as, very roughly, r⁻¹ so that it too is zero at a radial distance of infinity.

The exact geometry of the wires has been keep simple, comprising only an infinitely thin current or charge. In reality the wire will have a three dimensional structure. The solution of Poisson's equation ∇²ϕ>=−ρ_{f}/∈ can then be used to determine exactly how charges are related wire geometry and electrical potential. To save space here the simple model is used. Also, for the sake of simplicity and brevity, it will be assumed that geometry factors gₓ and g_{y} relates the charge to the impressed voltage on a thin wires in the x and y directions respectively. Then ρ_{L}_{ₓ}=gₓVₓ and ρ_{L}_{_{y}}=g_{y}V_{y}, where the voltages Vₓ and V_{y} are the voltages placed on or across the resistive wires running in the x and y directions. When the voltages are “on” the resistive wires then both sides of the wire are at the same elevated potential to induce charges on the wire, but no current flows. When the voltages are “across” the resistive wires then both sides of the wire are at different potentials to induce current through the wire, but no static charge is induced.

By means of hardware we may (1) modify the thickness of the wires to change the resistance, (2) change the shape of the lines, (3) change the spacing between wires to change capacitive and inductive loads, (4) add different layers of electrodes to increase, (5) provide field effect transistors (FETs) (and other types of electronics) inline with each wire to dynamically change the resistance, and (7) provide impedance matching stubs and other wave impedance control devices. Thus, even though the majority of this disclosure is focused on the orientation of NPs, the electrode technology introduced here is very general and can be applied generally. By way of example, if the wire-to-wire anodization alternates in phase by π radians than translational DEP forced normal to the electrodes are produced. If the wire-to-wire anodization rotates in phase by π/2 radians than translational DEP forced tangent to the electrodes are produced via traveling waves. This means that Eq. 36 can have the volume fraction controlled electronically as well as the orientation of the NPs in the lab frame. See for example, FIGS. 11-20.

By means of software and support electronics we can (1) send a different amplitude and (2) phase signals to each wire digitally to synthesize the desired modal field structure within an adjacent colloid. There is a lot of potential control that can occur here by changing the weighting dynamically. This is very analogous to the weighting of a phased array antenna, but without the need to process coherent optical signals. Electronically controlled apodization weights directly allow control of translational, rotational, orientational, and deformational DEP to allow fluidic metamaterials with unique NP distributions and optical properties.

Next, four electrodes are synthesized by placing many wires, or approximations of a wire, in parallel in the x and y direction. While only three segmented electrodes are needed for beam steering, an optional fourth electrode is provided to allow greater flexibility in operation, e.g. to allow conversion from refractive beam steering to reflective beam steering or to allow light to be coupled into or out of guide modes within a colloid. Then the resulting electric field in space is simply the sum of the individual electric fields from each wire forming the electrode. In particular,

$${E}_{∥ , x} ( r ) = - ω \frac{{μ}_{0} {I}_{x}}{2 π} {\sum }_{{m}_{x} = - {M}_{x}}^{+ {M}_{x}} {u}_{{m}_{x}} {sinh}^{- 1} [ \frac{{L}_{x}}{2 \sqrt{{( y - {y}_{{m}_{x}}^{′} )}^{2} + {( z + {L}_{{z}_{1}} / 2 )}^{2}}} ] \hat{x} \qquad ( 172 )$$

$${E}_{∥ , y} ( r ) = - ω \frac{{μ}_{0} {I}_{y}}{2 π} {\sum }_{{m}_{y} = - {M}_{y}}^{+ {M}_{y}} {u}_{{m}_{y}} {sinh}^{- 1} [ \frac{{L}_{y}}{2 \sqrt{{( x - {x}_{{m}_{y}}^{′} )}^{2} + {( z + {L}_{{z}_{2}} / 2 )}^{2}}} ] \hat{y} \qquad ( 173 )$$

$${E}_{⊥ , {z}_{2}} ( r ) = + \frac{{g}_{x} {V}_{x}}{2 πϵ} {\sum }_{{m}_{x} = - {M}_{x}}^{+ {M}_{x}} {v}_{{m}_{x}} [ \frac{( y - {y}_{{m}_{x}}^{′} ) \hat{y} + ( z - {L}_{{z}_{2}} / 2 ) \hat{z}}{{( y - {y}_{{m}_{x}}^{′} )}^{2} + {( z - {L}_{{z}_{2}} / 2 )}^{2}} ] \qquad ( 174 )$$

$${E}_{⊥ , {z}_{1}} ( r ) = + \frac{{g}_{y} {V}_{y}}{2 πϵ} {\sum }_{{m}_{y} = - {M}_{y}}^{+ {M}_{y}} {v}_{{m}_{y}} [ \frac{( x - {x}_{{m}_{y}}^{′} ) \hat{x} + ( z - {L}_{{z}_{1}} / 2 ) \hat{z}}{{( x - {x}_{{m}_{y}}^{′} )}^{2} + {( z - {L}_{{z}_{1}} / 2 )}^{2}} ] \qquad ( 175 )$$

where the set of complex valued apodization weights {uₘ_{ₓ}, uₘ_{_{y}}, ωₘ_{ₓ}, ωₘ_{_{y}}} can be applied to the wires in the electrodes by means of static hardware or dynamic hardware and software. These comprise different embodiments with different levels of complexity. The source voltage and current amplitudes are {Vₓ, V_{y}, Iₓ, I_{y}}, which show the direction of the wires and the excitation type (voltage or current).

A resulting phasor signal is then created within the colloid. This phasor signal rotates at a rate ω in a plane selected by an azimuth signal. An elevation signal then sets the final curvature of the bending of the light beam towards the desired direction by setting γ from Eq. 150 based on the slope of the electric field decay rate from the electrodes. This provides beam steering. The overall steering, focusing, and general wavefrom control comes from the electric field formed form the impressed voltages and currents. The azimuth and elevation angles are thus controlled by

$$E = {\underbrace{\{ {E}_{⊥ , {z}_{1}} ( r ) + {E}_{⊥ , {z}_{2}} ( r ) \}}}_{Zenith Angle Steering} + i {\underbrace{\{ {E}_{∥ , x} ( r ) + {E}_{∥ , y} ( r ) \}}}_{Azimuth Angle Steering} . \qquad ( 176 )$$

Equations 172-176 correspond to a system of four electrodes used to control the state of a colloid for A-GRIN optics.

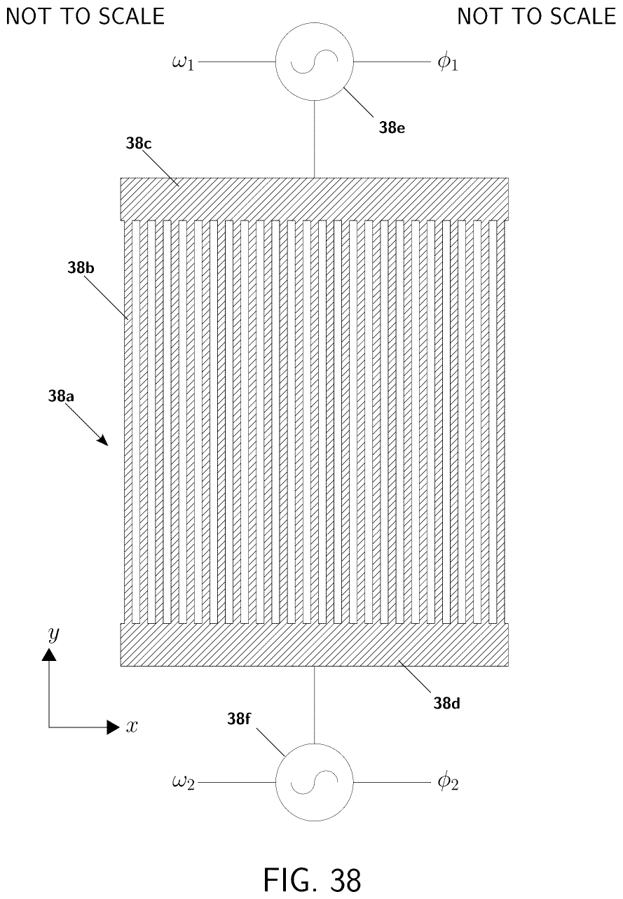

For example, Eq. 173 and Eq. 175 are both embodied in the arrayed-strip (i.e. arrayed-wire) electrode hardware of FIG. 38. Where there are a plurality of (2M_{y}+1) arrayed wires 38a that run in the y-direction in parallel. Each wire 38b is parallel to its neighbor. The wires are created by strips of resistive material that can support at least one of a voltage and a current at any given time. Additionally the arrayed wires 38a are connected to a first resistive node 38c and a second resistive node 38d. These resistive nodes are further connected to a first signal source 38e and a second signal source 38f. The first signal source 38e provides a sine wave voltage signal at frequency ω₁=ω and amplitude V₀. The second signal source 38f provides a sine wave voltage signal at frequency ω₂=ω and amplitude V₀. Other periodic waveforms may be able to drive the electrode, such as square waves from a digital device, as long as the DC components are eliminated or not an interference. Therefore, when the phase difference ϕ₂−ϕ₁=0 then there is no voltage difference between the first and second resistive nodes and no current flows. However the resistive wires experience a common oscillating voltage and charges (and voltages) are induced on the wires. Because, in this simple example, (1) the wires are identical, (2) have with no parasitic capacitance, (3) have no parasitic inductance, and (4) are lumped parameters components with the wavelength of the signal much larger than the length of the wires to avoid reflections within the electrode; then resulting electric field above and below the electrode is a simple superposition of the electric fields of the individual wires and points in the ±z-direction. That is into or out of the page of FIG. 38. Alternately, if the phase difference ϕ₂−ϕ₁=π then there is a current that flows in the y-direction. Again, for the idealized system without parasitic inductance and capacitance, a superposition of electric fields from the individual wires add and the resulting electric field is in the y-direction and proportional to ω.

Therefore, for amplitude-balanced signals at the same frequency, selecting the phase selects the direction of the electric fields as normal to the electrode or parallel to the wires of the electrode. This can be selected by a combination of software and electronics, which is not explicitly shown here to avoid clutter. Again, by way of review, note that the electric fields, independent of direction, always decay away from the electrode even if the electrode is very large. This overcomes the shortcoming of the small conventional electrodes.

For the avoidance of doubt and to extend the form of the embodiment, the voltage sources in this paragraph can be replaced by current sources with suitable modifications made to electronics as needed to provide the desired electric fields by phase switching. This may be considered a Thévenin-Norton equivalency.

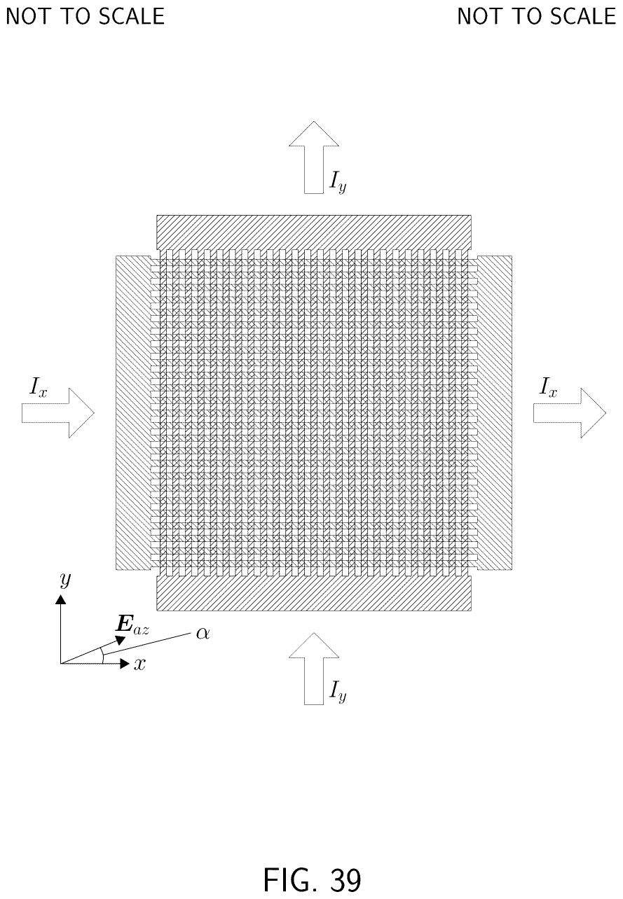

In FIG. 39 two of the array-strip electrodes are stacked on top of each other, with a small space between them, which is not shown. The electrodes operate at the same frequency and again with balanced voltage sources. Now harmonic currents Iₓ and I_{y} are sourced into the wires by choosing π radians phase difference across the first and second resistive nodes in each of the stacked electrodes. The resulting electric fields are parallel to the plane of the electrodes and decay away from the electrodes. In this way the electric field azimuth angle, a, is selected by the magnitude of the currents in orthogonal directions. Therefore, the azimuth light steering electric field is E_{az}=−i(E_{∥,x}+E_{∥,y}).

Again, for the avoidance of doubt, these same stacked electrodes can be configured to have zero phase difference across them. This stops the flow of both currents Iₓ and I_{y} so that only voltages Vₓ and V_{y} induce charges on the wires. This provides normally directed electric fields into and out of the page of FIG. 39.

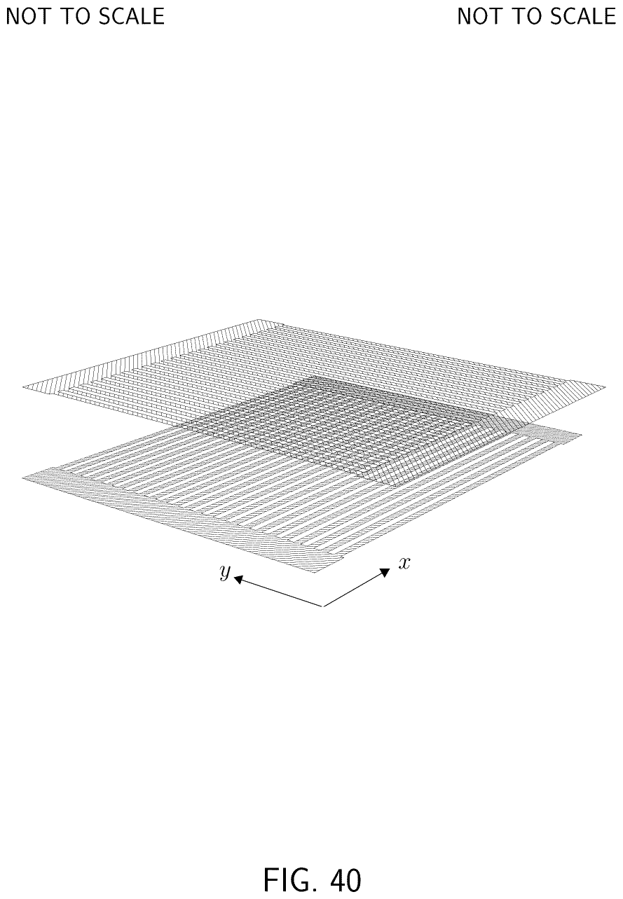

In FIG. 40 the two separate layers of the electrodes are shown in an exaggerated form, i.e. where scale is distorted to provide an understandable perspective. These two electrodes are intended to be formed on one side of a colloid sheet—not shown in this figure. Another set of two similar electrodes may also be formed on the other side of a the colloid sheet—also not shown in this figure.

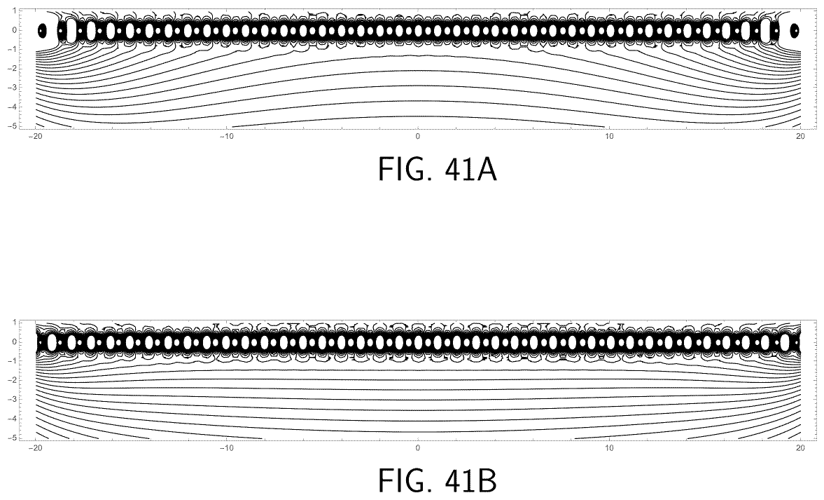

In FIG. 41A an array of charged wires produces iso-contours of the magnitude of the electric field. The apodization strength is the same on each wire and the magnitude of the electric field follows as iso-contour lines that are not parallel to the plane of the electrode, as required for uniform beam steering. However, in FIG. 41B an array of charged wires produces iso-contours of the magnitude of the electric field, but with a slight parabolic perturbation in charge amplitude across the array. As a result the magnitude of the electric fields, shown as iso-contour lines, are now substantially parallel to the plane of the electrode as required for uniform beam steering. For longer arrays the effect will be even more significant.

### Integrated Beam Steering

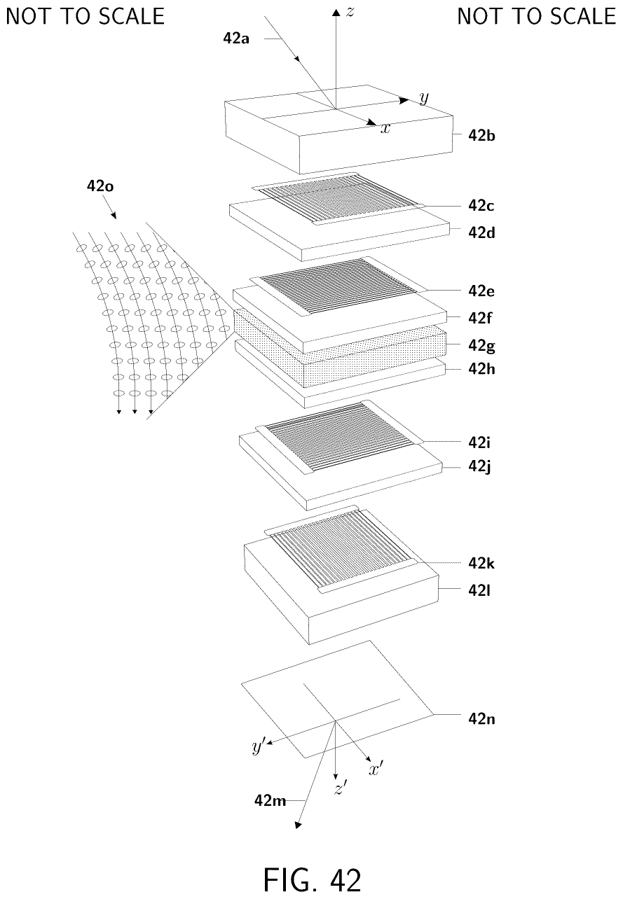

Consider the not-to-scale FIG. 42 of an integrated light beam steering device. FIG. 42 shows an incident light ray 42a. This ray works its way through the light beam steering device as described below.

Step-1: the incident light ray 42a refracts at a first external cover 42b. This layer protects the internal opto-electronics and transitions the light from the outside environment to the opto-electronic system.

Step-2: the refracted ray passes undeviated, i.e. without significant refraction, reflection, or absorption, through a first hybrid segmented electrode array comprising (1) a first segmented electrode 42c, (2) a first electro-optic insulator 42d, (3) a second segmented electrode 42e. The first segmented electrode 42c and the second segmented electrode 42e are arranged so that the associated directed wire segments are orthogonal to each other so that impressed oscillating line currents are also orthogonal to each other to provide orthogonal electric fields that select the azimuth direction as already described in FIGS. 38-40 and their corresponding descriptions. The planes of the first and second electrodes are also substantially parallel to each other. This sub-system may be manufactured as a single unit with the electro-optic insulator 42d acting as a temporary carrier of the electrodes in a roll-to-roll manufacturing process.

Step-3: the refracted ray passes into a colloid control volume comprising: (1) a first internal cover 42f, (2) a colloid layer 42g, and (3) a second internal cover 42h. The internal covers are transparent, linear, homogeneous, and isotropic e.g. amorphous glass or plastic. The internal covers sandwich and protect the colloid layer. This sub-system may be manufactured as a single unit with the edges hermetically sealed to ensure that the colloid remains between the internal covers. Also, there may be small spacers (not shown) distributed in the colloid to ensure that the internal covers remain at a constant separation distance independent of external mechanical loads and torques. It is here in the colloid control volume that light bending occurs.

Step-4: the refracted ray passes undeviated, i.e. without significant refraction, reflection, or absorption, through a second hybrid segmented electrode array comprising (1) a third segmented electrode 42i, (2) a second electro-optic insulator 42j, (3) a fourth segmented electrode 42k. The third segmented electrode 42i and the fourth segmented electrode 42k are arranged so that the associated directed wire segments are orthogonal to each other so that impressed oscillating line currents, and the resulting electric fields, are also orthogonal to each other as already described in FIGS. 38-40 and the corresponding descriptions. The third and fourth electrodes are also substantially parallel to each other. This sub-system may be manufactured as a single unit with the electro-optic insulator 42j acting as a temporary carrier of the electrodes.

Step-5: the light ray refracts at a second external cover 42l. This layer protects the internal opto-electronics and transitions the light from the inside opto-electronic system to the external environment as an output ray 42m.

Note that in some applications an optional mirror layer 42n is included to allow controlled reflected light. In other applications, the ability to switch between refracted and reflected light is based on the signal provided to the colloid.

From an operational point of view, an oriented indicatrix distribution 42o bends e-wave phase-rays as shown. It also passes o-waves without angular deviation. In the particular case shown, the optical birefringence is positive, the optical axis is aligned with the electric field, and the phase-rays have a trajectory that is identical the energy-rays by design.

For the avoidance of doubt, note that the light beam system, as currently shown, is symmetric about the colloid sheet. Also, for the avoidance of doubt, note that only three electrode layers are actually needed for simple beam steering refraction. The redundant electrode can be used to reinforce the voltage sheet electrode. The fourth electrode is provided so that there is greater flexibility in creating mirror modes as well as refractive modes form one beam steering device.

The hybrid segmented electrode arrays are: “hybrid” because they comprise two separate electrodes that have wires that are orthogonal in orientation to each other and “segmented” because of the separate wires that are used to induce an electric field that decays away from the electrode array. The word “wire” can mean literally wires or conductive traces that are rectangular in cross section. Thus, the first hybrid segmented electrode array is comprised of an x-directed electrode with wires that run parallel the x-direction, and a y-directed electrode with wires that run parallel the y-direction.

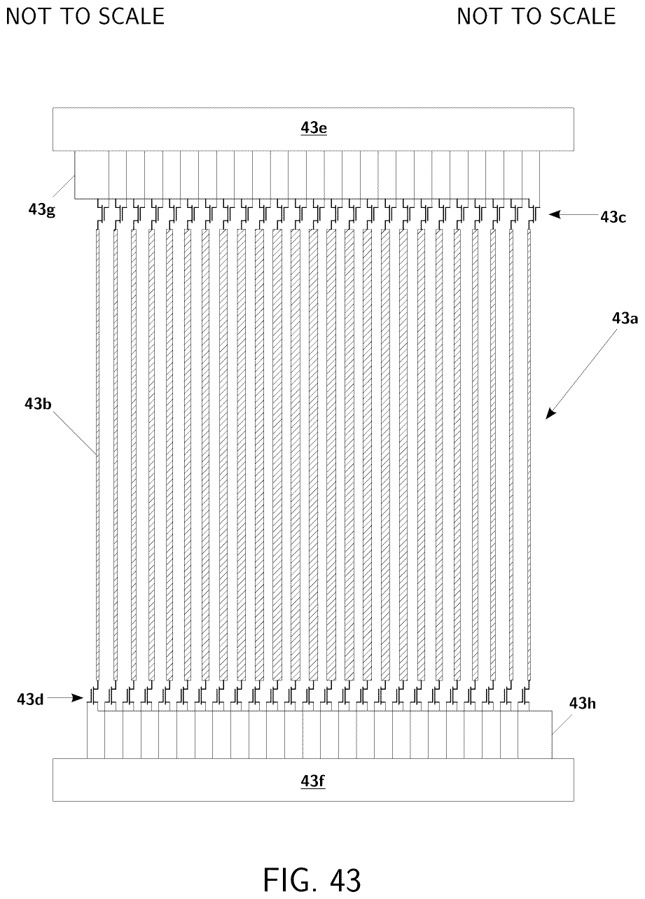

The description of FIG. 42 used passive segmented electrode arrays. It is also possible to have active segmented electrode arrays, an example of which is shown in FIG. 43. In particular, a segmented wire array 43a comprising individual wires such as example wire 43b. This wire can take many forms. In the figure it is provided by planar resistive traces of transparent indium tin oxide, or another equivalent material. The wires in the segmented wire array 43a have different widths to allow a baseline electrode that minimizes the effects of fringing fields. This can alternately be accomplished in software, instead of patterned wires with different sizes, as is described shortly.

At one side of the segmented wire array 43a is a first transistor array 43c and on the other side of the segmented wire array is a second transistor array 43d. Field Effect Transistors (FETs) are shown here, but there may be other technologies, such as bipolar junction transistors, and others that may be more appropriate for certain environments. A FET provides a near ideal resistive switch that can be shorted or open circuited by means of the FETs control signal. The FET can also be used as a controllable resistor so that the FET channel resistance can range almost linearly from near zero to near infinite Ohms.

The first transistor array 43c has its control lines connected to a first electronic controller 43e. The second transistor array 43d has its control lines connected to a second electronic controller 43f.

Additionally, the first transistor array 43c has its source or drain terminals connected to the first electronic controller 43e signal source, i.e. for a phase controllable sine wave. This is a first DEP signal connection 43g. The second transistor array 43d has its source or drain terminals connected to the second electronic controller 43f signal source, i.e. for a phase controllable sine wave. This is a first DEP signal connection 43h.

Thus, with a very simple configuration the OMP beam steering device can act very much like a phased array antenna, but without some of the shortcomings of a phased array antenna. The OMP beam steering device is broad band and can handle high power, beam steering, beam focusing, and even beam steering into or out of internal guided light modes within the OMP device.

### Charge Neutrality in Segmented Electrodes

It is the assertion of this section that charge neutrality of a wire can actually generate an electric field along a wires length that is distinctly different in character than that provided by a purposely impressed emf (electromotive “force”) from a voltage source, such as a battery or function generator [12, 13]. Let's start by considering ω=0, i.e. direct currents, in a wire. Here we find that an incorrect assertion in many highly regarded texts on electromagnetism, both at the undergraduate and graduate level. This belief has also diffused into the many research papers on electromagnetics.

For example, in The Feynman Lectures on Physics [14], on page 13-7, where the italics in the following quote is by the current author.
We return to our atomic description of a wire carrying a current. In a normal conductor, like copper, the electric currents come from the motion of some of the negative electrons—called the conduction electron—while the positive nuclear charges and the remainder of the electrons stay fixed in the body of the material. We let the density of the conduction electrons be ρ₋ and their velocity in S be ν. The density of the charges at rest in S is ρ₊, which must be equal to the negative of ρ₋, since we are considering an uncharged wire. There is thus no electric field outside the wire, and the force on the moving particle is just F=qν×B.
   Feynman's description remains essentially the same for both DC and AC currents, though with AC currents there is a stronger magnetic field near the center of the wire that induces a counter emf (i.e. Lenz's law) that sets up a counter-directed current in the wire. The net effect is that all the current flows near the surface of the wire. It is called the skin effect. The skin effect reduces the effective cross-sectional area of the wire, thereby increasing the resistance to current flow and the dissipation of energy as electrical resistive heat. However, the wire is still charge neutral. Thus, following the logic of Feynman and many others, if the wire is charge neutral to begin with then there can be no electric field parallel to the wire, even if there is a current traveling along the wire and this is true for both direct and alternating, i.e. DC and AC, currents.

However, the discussion provided so far is really only a zeroth order model and it is not the complete story. Let's model a wire as a cylinder and use cylindrical coordinates {r, θ, x}. Then we consider Poisson's equation ∇²ϕ=−ρ_{f}/∈, where ρ_{f} is the free-charge density. The electric potential ϕ can be written as ϕ(r, θ, z)=F(r, θ) Z(z) so that the solution of the homogeneous partial differential equation (i.e. a charge neutral wire) requires solving Laplace's equation according to

$${∇}^{2} [ F ( r , θ ) Z ( z ) ] = Z ( z ) {∇}_{T}^{2} F ( r , θ ) + F ( r , θ ) \frac{{\partial }^{2} Z ( z )}{\partial {z}^{2}} = 0 \qquad ( 177 )$$

where ∇_{T} is the traverse operator for variables {r, θ}. Therefore, by the method of separation of variables

$$\frac{1}{F} {∇}_{T}^{2} F = - \frac{1}{Z} \frac{{\partial }^{2} Z}{\partial {z}^{2}} ≡ {κ}^{2} \qquad ( 178 )$$

where κ² is a constant, and therefore in the z-direction, i.e. along the wire, we have that

$$\frac{{d}^{2} Z ( z )}{{dz}^{2}} + {κ}^{2} Z ( z ) = 0 \qquad ( 179 )$$

The solutions for Z are therefore oscillating, linear, or exponential functions, which depends on if κ² is positive, zero, or negative. Now, given the geometric angular symmetry of the wire F should not be a function of θ. Additionally, for DC currents F would not be a function of r either for long wires. At zero frequency, we must have F as a constant, which implies that κ=0 so that

Z(z)=c₁z+c₂ (180)

where {c₁, c₂} are constants of integration. Then ϕ(z)=F₀(c₁ z+c₂), where F₀ is a constant such that F(r, θ)=F₀. Thus, integrated charge neutrality is maintained by the electric field in the wire, by forming surface charges of different polarity on the wire on either side of z=0, where z=0 at the mid-point of the wire. Thus, we may conclude that the equipotential surfaces within the conductor are planes that are perpendicular to the z-axis. This neglects any radial component of the electric field, which is very small. This is generally true at large distances from the wire terminations and also far from sources of emf that are used to maintain the current in the wire.

Moreover, the solution for the potential outside the wire must have at least a factor linear in z to match the potential functions at the boundary of the wire. Consequently there must be an electric field component outside the wire that is parallel to the wire and this electric field solution is consistent with Laplace's equation ∇²ϕ=0. Thus, we find that the potential inside and outside the wire take the form

ϕᵢₙ(r,θ,z)=A+Bz (181)

ϕₒᵤₜ(r,θ,z)=(α+βz)G(r), (182)

where G(r) is yet to be determined. Then, the surface charge density must be given by the difference in the displacement field such that

σ=∈(∇ϕᵢₙ−∇ϕₒᵤₜ)·\hat{r}. (183)

So as an intermediate summary, a DC current in a wire provides both z-directed and r-directed electric fields outside the wire, and only z-directed electric fields inside the wire. This is not the standard result normally anticipated.

A more detailed form of the electric fields can be derived by first solving for the potential around the wire more generally.

$$ϕ ( r , z ) = \frac{1}{4 πϵ} {\int }_{{θ}^{′} = 0}^{2 π} {\int }_{{z}^{′} = - L / 2}^{+ L / 2} \frac{[ {σ}_{A} ( z / L ) + {σ}_{B} ] d {θ}^{′} {dz}^{′}}{\sqrt{{r}^{2} + {a}^{2} - 2 ar cos {θ}^{′} + {( z - {z}^{′} )}^{2}}} \qquad ( 184 )$$

and when a<<r<L and |z|<<L, where a is the wire radius and L the wire length. Then after integration we find that

$$ϕ ( r , z ) = \frac{a [ {σ}_{a} ( z / L ) + {σ}_{B} ]}{ϵ} ln [ \frac{L}{a} ] when r \leq a \qquad ( 185 )$$

$$ϕ ( r , z ) = \frac{a [ {σ}_{A} ( z / L ) + {σ}_{B} ]}{ϵ} ln [ \frac{L}{r} ] when r \geq a . \qquad ( 186 )$$

Next, the electric fields are given by E=−∇ϕ so that

$$E = \frac{- a {σ}_{A}}{L ϵ} ln [ \frac{L}{a} ] \hat{z} when r \leq a \qquad ( 187 )$$

$$E = \frac{a [ {σ}_{A} ( z / L ) + {σ}_{B} ) ]}{ϵ} \frac{\hat{r}}{r} - \frac{a {σ}_{A}}{L ϵ} ln [ \frac{L}{r} ] \hat{z} when r \geq a . \qquad ( 188 )$$

Notice that inside the wire it is also possible to set Eq. 185 equal to

$$ϕ ( r , z ) = ( \frac{{ϕ}_{R} - {ϕ}_{L}}{L} ) z + ( \frac{{ϕ}_{R} + {ϕ}_{L}}{2} ) \qquad ( 189 )$$

so that on using Ohm's law (ϕ_{R}−ϕ_{L})=IR where R=L/(gπa²) with g the wire conductivity, then gives

$${σ}_{A} = - \frac{IR ϵ}{a ln [ \frac{L}{a} ]} \qquad ( 190 )$$

$${σ}_{B} = \frac{ϵ ( {ϕ}_{R} + {ϕ}_{L} )}{2 a ln ( L / a )} = \frac{ϵ ( IR + 2 {ϕ}_{R} )}{2 a ln ( L / a )} \qquad ( 191 )$$

Finally, we can insert these results and convert to the coordinates used throughout this disclosure, i.e. where z→x, to find that outside the wire the charge neutrality field (CN) is

$${E}_{CN} = \frac{- 1}{ln ( L / a )} ( \frac{IR}{L} x - \frac{IR + 2 {ϕ}_{R}}{2} ) \frac{\hat{r}}{r} + \frac{IR}{L} \frac{ln ( L / r )}{ln ( L / a )} \hat{x} \qquad ( 192 )$$

and this is to be compared to the electric field of Eq. 170-171, which is repeated here for convenience with I=I₀ then

$${E}_{Current} = - ω \frac{{μ}_{0} I}{2 π} {sinh}^{- 1} [ \frac{L}{2 r} ] \hat{x} \qquad ( 193 )$$

$${E}_{Charge} = \frac{{ρ}_{L}}{2 πϵ} \frac{\hat{r}}{r} . \qquad ( 194 )$$

Equation 192 was derived for a DC field. However, it should also be valid under quasielectrostatic conditions where ω≠0 and ω is not excessively large. By comparing Eq. 192 to Eqs. 193-194 it is clear that there is a potential for an interfering signal to be injected into the colloid. To avoid this possibility, the value of the DEP harmonic drive frequency ω in Eq. 193 may need to be large enough and current I low enough so that these charge neutrality fields E_{CN} are substantially overcome by the DEP fields designed for OMP based beam steering and light control. Finally, it should also be noted that the charge neutrality fields are not in phase quadrature so they are not easily used for OMP by themselves.

### Dynamic Polarization Control and Conversion

This section shows how to dynamically control the polarization (spin angular momentum) of light using OMP. A first application of Polarization Beam Steering (PBS) is to modulate an input light-beam having a fixed polarization state into different polarization states in different directions. An example of where this useful is in high-density optical data storage, where the information is recorded and read in different parts of a medium with the polarization state of the laser light. A second application of PBS is to convert many different polarization states of a light field into just one output polarization state. An example of this is converting random polarization states of sunlight into a single polarization state that is optimum for arbitrary beam steering of solar energy for concentrating solar power plants.

For light that is already polarized all that is needed for PBS is uniaxial anisotropy in the colloid. For example, natural randomly polarized sunlight can be decomposed into components that are parallel and perpendicular to the incident plane. Therefore, using techniques already shown, the e-wave formed from parallel-polarized light can be steered. The perpendicular component will simply pass through unsteered due to a spherical dispersion relation even in an anisotropic colloid, but this unsteered electric field component can be re-polarized with a suitable anisotropic layer and then subsequently beam steered. This typically takes three layers: (1) a beam steering layer for available e-waves, (2) a polarization converter layer for converting o-waves into e-waves, and (3) another beam steering layer for the newly converted e-waves. However, we can do better with two and even one layer OMP by carefully designing the colloid adding additional degrees of colloid manipulation of (for example) bi-axial crystal NPs with segmented phased-array electrodes.

In particular, it is shown below, for more generalized dynamic control of the polarization of light it may be necessary to use either natural or synthesized bi-axial anisotropy. This can manifest itself as a colloid formed as dispersed bi-axial and uniaxial structures comprising substantially
Spherical NPs that have an underlying bi-axial crystal structure
Spheroidal (i.e. non-spherical in general) NPs that have an underlying uniaxial crystal structure, such that the symmetry eigenbasis of the NP's shape is different from the symmetry eigenbasis of the geometry of the spheroid. By Eq. 36 this will produce a bi-axial anisotropic colloid. Example-1: Prolate spheroidal NPs that have an underlying bi-axial crystal structure, Example-2: Oblate spheroidal NPs that have an underlying bi-axial crystal structure.
NPs that have an underlying uni-axial anisotropy by at least one of either NP shape or compositional crystal structure, wherein a bi-axial anisotropy is synthesized by DEP induced orientations between close sub-optical-wavelength neighboring regions, thereby forming bi-axial anisotropy using dimerized NPs (meta-atoms) forming meta-molecules.
Other ways to combine particles to form synthesized bi-axial structures may also be possible so that the most general form of polarization control synthesizes bi-axial anisotropy controlled by DEP to impact optical polarization.

These synthesized NPs are typically formed with less than an optical wavelength of space between neighboring NPs. The needed control of the NPs is now accomplished by introducing a π/2 phase shift between orthogonal DEP electric fields, which are formed parallel to wires in the segmented phased-array electrodes.

For example, recall that in Eq. 176 there was a phase shift of π/2 between the orthogonal zenith and azimuth electric fields. This same orthogonal phase-quadrature technique applied to the DEP electric fields can be used for PBS. The proper phasing and apodization of the segmented electrodes can accomplish the needed dynamic control of the NPs for PBS. So, for example, it is possible to energize segmented electrode arrays with currents only, where the currents have a ±π/2 phase difference so that

E=E_{∥,x}(r)±iE_{∥,y}(r). (195)

These phase quadrature fields apply DEP torques in planes that are parallel to the segmented electrode arrays.

Next, the basics of polarization are reviewed and then used to show how to build dynamic PBS devices using colloids controlled by DEP as part of a OMP system. To avoid confusion between DEP fields and optical fields the following convention is adopted in this disclosure:
DEP fields are denoted by capital letters such as E
Optical fields are denoted by script fields, such as ε

The general approach to be followed to develop PBS below is as follows. A review of the Jones and Stokes parameters are provided. This review will highlight how the amplitude and phase of propagating and super imposed electric fields at the same optical frequency provides coherently polarized light with an ellipsoidal locus of points swept out by the electric fields. This will lead to a different set of parameters, i.e. the ellipticity angle and the ellipse rotation angle, for specifying a polarization ellipse. It will also lead to polarization states being described more abstractly with complex Jones vectors on a Poincaré sphere. Such complex Jones vectors can possess orthogonality over the complex field of numbers. Therefore, orthogonal polarization states are developed to expand the arbitrary polarization states found at the input and output of a PBS device. Mathematical relations are then developed connecting the input polarization states to the output polarization states and symmetry arguments are provided to narrow down the range of free parameters and allowing a Jones matrix description of a PBS device. The PBS Jones matrix is then interpreted in the context of the unique characteristics of a metafilm, which is the optical material used in OMP systems. Many of the mathematical ideas developed here mirror the efforts of prior researchers in metasurfaces, except that now a new symmetry is used to establish functionality of a dynamic PBS, i.e. over a static polarization converting surfaces of metasurface. Additionally, the restrictions of metasurfaces are overcome as the full three-dimensional volume of the metafilm is utilized, and the ability to both statically an dynamically synthesize bi-axial anisotropy is developed for PBS. The great advantage of the metafilms used in OMP for PBS over the metasurfaces used in polarization conversion in metasurface optics is that OMP allows dynamic beam steering and polarization control right form the start. These are two separate functions. In contradistinction, metasurface optics struggles to find a means to control beam direction, and the polarization states are currently fixed by the fixed layout of the metasurfaces, which are unable to reconfigure. Also, there are more options on how to dimerize meta-atoms and form a bi-axial anisotropy for polarization control.

Next, let's consider a plane wave that is propagating in a isotropic medium along the z-direction such that

ε=εₓ₀ cos[ωt−kz+ϕₓ]\hat{x}+ε_{y0} cos[ωt−kz+ϕ_{y}]ŷ (196)

so we may write

ε=εₓ\hat{x}+ε_{y}ŷ (197)

εₓ=εₓ₀ cos[(ζ+ϕₓ] (198)

ε_{y}=ε_{y0} cos[(ζ+ϕ_{y}] (199)

ζ=ωt−kz. (200)

### Therefore,

$$\frac{{ℰ}_{x}}{{ℰ}_{x 0}} = cos ζ cos {ϕ}_{x} - sin ζ sin {ϕ}_{x} \qquad ( 201 )$$

$$\frac{{ℰ}_{y}}{{ℰ}_{y 0}} = cos ζ cos {ϕ}_{y} - sin ζ sin {ϕ}_{y} \qquad ( 202 )$$

and by multiplying Eqs. 201-202 by sin ϕ_{y} and sin ϕₓ respectively and subtracting we get

$$\frac{{ℰ}_{x}}{{ℰ}_{x 0}} sin {ϕ}_{y} - \frac{{ℰ}_{y}}{{ℰ}_{y 0}} sin {ϕ}_{x} = cos ζ sin [ {ϕ}_{y} - {ϕ}_{x} ] \qquad ( 203 )$$

and similarly multiplying Eqs. 201-202 by cos ϕ_{y} and cos ϕₓ respectively and subtracting we get

$$\frac{{ℰ}_{x}}{{ℰ}_{x 0}} cos {ϕ}_{y} - \frac{{ℰ}_{y}}{{ℰ}_{y 0}} cos {ϕ}_{x} = sin ζ sin [ {ϕ}_{y} - {ϕ}_{x} ] . \qquad ( 204 )$$

Now define

δ=ϕ_{y}−ϕₓ (205)

so that on squaring and adding Eqs. 203-204, then

$${( \frac{{ℰ}_{x}}{{ℰ}_{x 0}} )}^{2} + {( \frac{{ℰ}_{y}}{{ℰ}_{y 0}} )}^{2} - 2 ( \frac{{ℰ}_{x}}{{ℰ}_{x 0}} ) ( \frac{{ℰ}_{y}}{{ℰ}_{y 0}} ) cos δ = {sin}^{2} δ , \qquad ( 206 )$$

which describes the locus of points swept out by the electric field as it propagates. Let's define

$$tan α = \frac{{ℰ}_{y 0}}{{ℰ}_{x 0}} \qquad ( 207 )$$

$$tan χ = \frac{{ℰ}_{y 0}^{″}}{{ℰ}_{x 0}^{″}} \qquad ( 208 )$$

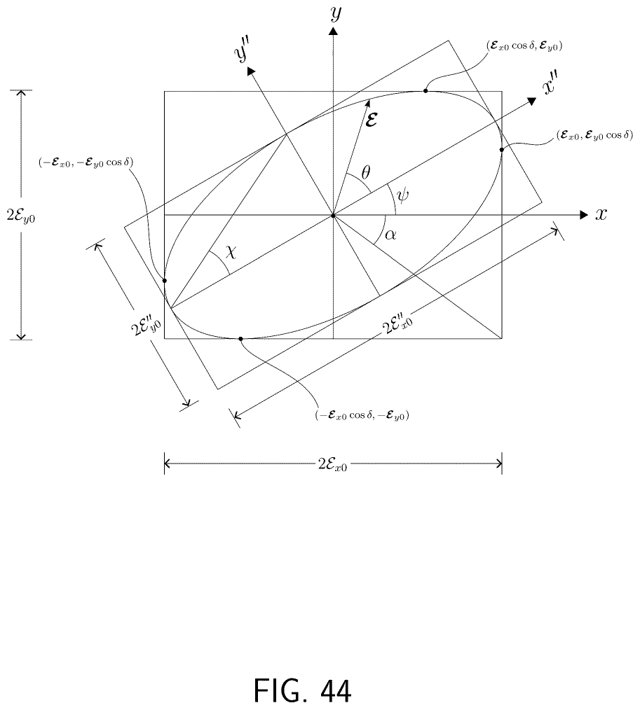

which are shown graphically in FIG. 44, where Eq. 206 is plotted. The angle χ is called the ellipticity angle, angle ψ is called the ellipse rotation angle, angle α is called the auxiliary angle, angle θ is called the electric field rotation angle, and angle δ is called the relative phase angle.

It is easy to show that the double-primed coordinates and unprimed coordinates in FIG. 44 are related as follows

$$[ \begin{matrix}x \\ y\end{matrix} ] = {\underbrace{[ \begin{matrix}cos ψ & - sin ψ \\ sin ψ & cos ψ\end{matrix} ]}}_{{R}^{=}} [ \begin{matrix}{x}^{″} \\ {y}^{″}\end{matrix} ] \qquad ( 209 )$$

which may be written compactly as

r=R̅(ψ)r″ (210)

and its inverse as

r″=R̅(−ψ)r (211)

where R̅ is the rotation matrix. With the rotation matrix in hand we can express the optical electric field in the primed (eigen) basis in terms of the unprimed (observer) basis, using Eq. 211, as follows

$$[ \begin{matrix}{ℰ}_{x}^{″} \\ {ℰ}_{y}^{″}\end{matrix} ] = [ \begin{matrix}cos ψ & sin ψ \\ - sin ψ & cos ψ\end{matrix} ] [ \begin{matrix}{ℰ}_{x} \\ {ℰ}_{y}\end{matrix} ] ≡ [ \begin{matrix}+ {ℰ}_{x 0}^{″} cos ( ζ + {δ}_{0} ) \\ - {ℰ}_{y 0}^{″} sin ( ζ + {δ}_{0} )\end{matrix} ] , \qquad ( 212 )$$

where the sign convention used on the right-most column vector provides for right-handed rotation of the electromagnetic field in space (i.e. left handed rotation in time). Also, from Eqs. 201-202

$$[ \begin{matrix}{ℰ}_{x} \\ {ℰ}_{y}\end{matrix} ] = [ \begin{matrix}cos ζ & - sin ζ \\ sin ζ & - cos ζ\end{matrix} ] [ \begin{matrix}{ℰ}_{x 0} \\ {ℰ}_{y 0}\end{matrix} ] . \qquad ( 213 )$$

Now insert Eq. 213 into Eq. 212 and equate factors of cos ζ and sin ζ, whereby we find that

εₓ₀ cos ϕₓ cos ψ+ε_{y0} cos ϕ_{y} sin ψ=εₓ₀″ cos δ₀ (214)

−εₓ₀ sin ϕₓ sin ψ+ε_{y0} sin ϕ_{y} cos ψ=ε″_{y0} cos δ₀ (215)

εₓ₀ sin ϕₓ cos ψ+ε_{y0} sin ϕ_{y} sin ψ=εₓ₀″ sin δ₀ (216)

εₓ₀ cos ϕₓ sin ψ−ε_{y0} cos ϕ_{y} cos ψ=ε_{y0}″ sin δ₀. (217)

On taking Eqs. 214-217 squaring and adding we find that

(εₓ₀″)²+(ε_{y0}″)²=(εₓ₀)²+(ε_{y0})² (218)

which is nothing more than the preservation of the field magnitude independent of the coordinate system used. Next, multiply Eqs. 214 and 215 and separately multiply Eqs. 216 and 217, then add the resulting equations. The outcome is

εₓ₀″ε_{y0}″=εₓ₀ε_{y0} sin δ (219)

δ=ϕ_{y}−ϕₓ. (220)

Now, divide Eqs. 218-219 to obtain

$$\frac{2 {ℰ}_{x 0}^{″} {ℰ}_{y 0}^{″}}{{( {ℰ}_{x 0}^{″} )}^{2} + {( {ℰ}_{y 0}^{″} )}^{2}} = \frac{2 {ℰ}_{x 0} {ℰ}_{y 0} sin δ}{{( {ℰ}_{x 0} )}^{2} + {( {ℰ}_{y 0} )}^{2}} \qquad ( 221 )$$

which is easily shown to be equivalent to

sin(2χ)=sin(2α)sin δ. (222)

Next, divide Eq. 217 by Eq. 216, and separately divide Eq. 215 by Eq. 214 so that

$$\frac{{ℰ}_{y 0}^{″}}{{ℰ}_{x 0}^{″}} = \frac{{ℰ}_{x 0} cos {ϕ}_{x} sin ψ - {ℰ}_{y 0} cos {ϕ}_{y} cos ψ}{{ℰ}_{x 0} sin {ϕ}_{x} cos ψ + {ℰ}_{y 0} sin {ϕ}_{y} sin ψ} = \frac{- {ℰ}_{x 0} sin {ϕ}_{x} sin ψ + {ℰ}_{y 0} sin {ϕ}_{y} cos ψ}{{ℰ}_{x 0} cos {ϕ}_{x} cos ψ + {ℰ}_{y 0} cos {ϕ}_{y} sin ψ} \qquad ( 223 )$$

which reduces to

$$\frac{sin ( 2 ψ )}{cos ( 2 ψ )} = \frac{2 {ℰ}_{x 0} {ℰ}_{y 0} cos δ}{{( {ℰ}_{x 0} )}^{2} - {( {ℰ}_{y 0} )}^{2}} \qquad ( 224 )$$

or

tan(2ψ)=tan(2α)cos δ (225)

The left side of Eqs. 222 and 225 are associated with the observer (unprimed) coordinates of FIG. 44 and suggests that in the double-primed (eign) coordinates the essential coordinates are 2ψ and 2χ. In particular, the following Stokes Parameters are defined and expressed in terms of the unprimed and then the primed coordinates

sᵢ=Unprimed func.=Primed func.

s₀=(εₓ₀)²+(ε_{y0})²=(εₓ₀″)²+(ε_{y0}″)² (226)

s₁=(εₓ₀)²−(ε_{y0})²=s₀ cos(2χ)cos(2ψ) (227)

s₂=2εₓ₀ε_{y0} cos δ=s₀ cos(2χ)sin(2ψ) (228)

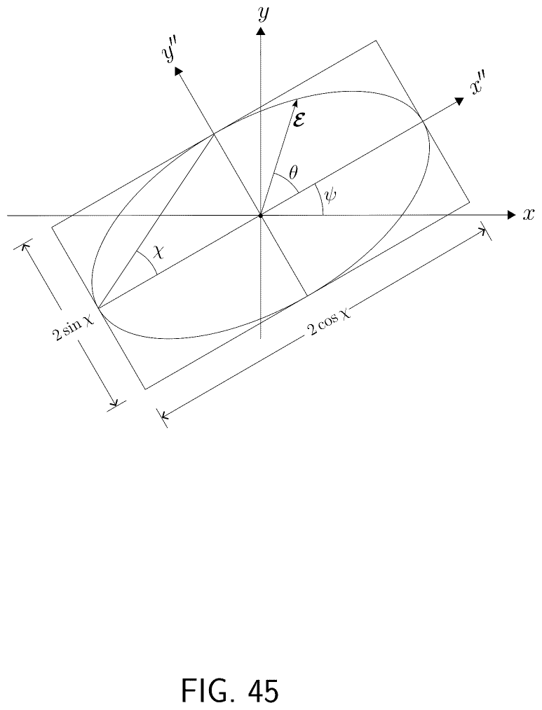

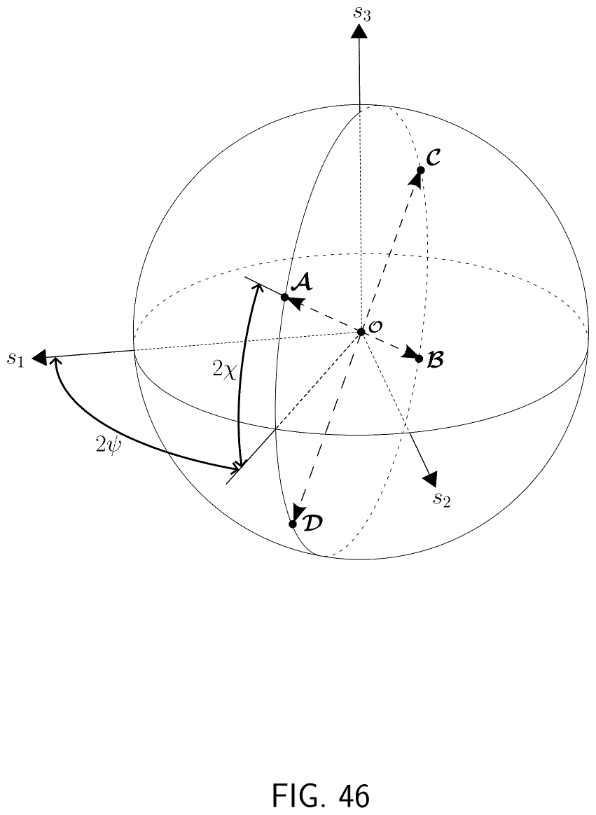

s₃=2εₓ₀ε_{y0} sin δ=s₀ sin(2χ) (229)

where Eq. 224 provides that s₂=s₁ tan(20), where Eqs. 221-222 gives s₃=s₀ sin(2χ), where Eqs. 227-228 shows that s₀²=s₁²+s₂²+s₃², so that solving for s₁ we find s₁=s₀ cos(2χ)cos(2ψ). These relations move the discussion from the locus of points defining the electric field polarization, as seen in FIG. 45, to a discussion of the Poincaré Sphere, as shown in FIG. 46.

These figures show how to normalize the electric field for a right-hand elliptically polarized. Look at FIG. 45, the locus of points defining the electric field is given in the time-domain as

ε_{A}″=cos χ cos(kz−ωt)\hat{x}″−sin χ sin(kz−ωt)ŷ″, (230)

where ϕₓ=ϕ_{y}=0 so that only the rotation angle ψ alone determines the rotation angle. Moving to a complex phasor-domain we define an electric field Jones vector as

$${ℰ}_{A} = {[ \begin{matrix}cos χ \\ - i sin χ\end{matrix} ]}^{″} \qquad ( 231 )$$

$$then$$

$$\begin{matrix}{ℰ}_{A} = {[ \begin{matrix}cos ψ & - sin ψ \\ sin ψ & cos ψ\end{matrix} ] [ \begin{matrix}cos χ \\ - i sin χ\end{matrix} ]}^{″} \\ = {R}^{=} ( ψ ) {ℰ}_{A}^{″} \\ = {R}^{=} ( ψ ) \{ {R}^{=} ( - \frac{π}{4} ) {R}^{=} ( + \frac{π}{4} ) \} {ℰ}_{A}^{″} \\ = \{ {R}^{=} ( ψ ) {R}^{=} ( - \frac{π}{4} ) \} \{ {{R}^{=} ( + \frac{π}{4} ) [ \begin{matrix}cos χ \\ - i sin χ\end{matrix} ]}^{″} \} \\ = {R}^{=} ( ψ - \frac{π}{4} ) {\frac{1}{\sqrt{2}} [ \begin{matrix}{e}^{+ i χ} \\ {e}^{- i χ}\end{matrix} ]}^{′} .\end{matrix} \qquad ( 232 )$$

where R̅ is given in Eq. 209. Note that for added certainty both double-primes and single-primes were added to column vectors so there is no confusion as to the basis set being used to represent a particular vector. In this way we can define another complex vector to provide an orthogonal basis set to represent arbitrary vectors. In particular, define

$$\begin{matrix}{ℰ}_{B} = {[ \begin{matrix}cos ψ & - sin ψ \\ sin ψ & cos ψ\end{matrix} ] [ \begin{matrix}cos χ \\ + i sin χ\end{matrix} ]}^{′′′} \\ = {R}^{=} ( ψ ) {ℰ}_{B}^{′′′} \\ = {R}^{=} ( ψ ) \{ {R}^{=} ( - \frac{π}{4} ) {R}^{=} ( + \frac{π}{4} ) \} {ℰ}_{B}^{′′′} \\ = \{ {R}^{=} ( ψ ) {R}^{=} ( - \frac{π}{4} ) \} \{ {{R}^{=} ( + \frac{π}{4} ) [ \begin{matrix}cos χ \\ + i sin χ\end{matrix} ]}^{′′′} \} \\ = {R}^{=} ( ψ - \frac{π}{4} ) {\frac{1}{\sqrt{2}} [ \begin{matrix}{e}^{+ i χ} \\ - {e}^{- i χ}\end{matrix} ]}^{′} .\end{matrix} \qquad ( 233 )$$

It is easy to show, e.g. using the expansion in the single-prime basis, that

ε_{A}^{†}·ε_{B}=0 (234)

where the dagger operator t is the adjoint (i.e. the complex conjugate transpose) operator for the complex vector inner product. Therefore, an arbitrary polarization state can be represented as an electric field vector in terms of the ellipticity angle χ and the rotation angle ψ.

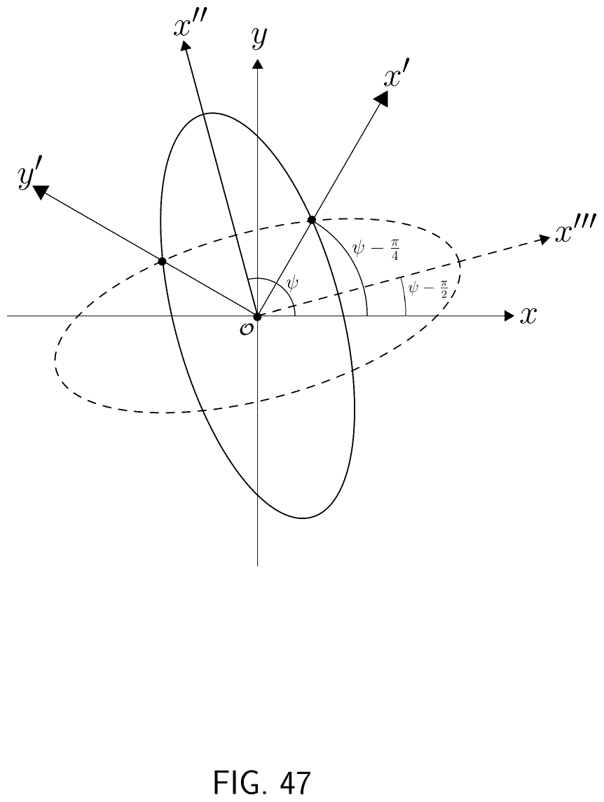

Thus, ε_{A} and ε_{B} represent an orthogonal basis set that can be used to expand a polarization state in the common single-primed coordinate system. In FIG. 47 the basis functions for expanding an arbitrary polarization state are shown with the solid and dashed ellipses.

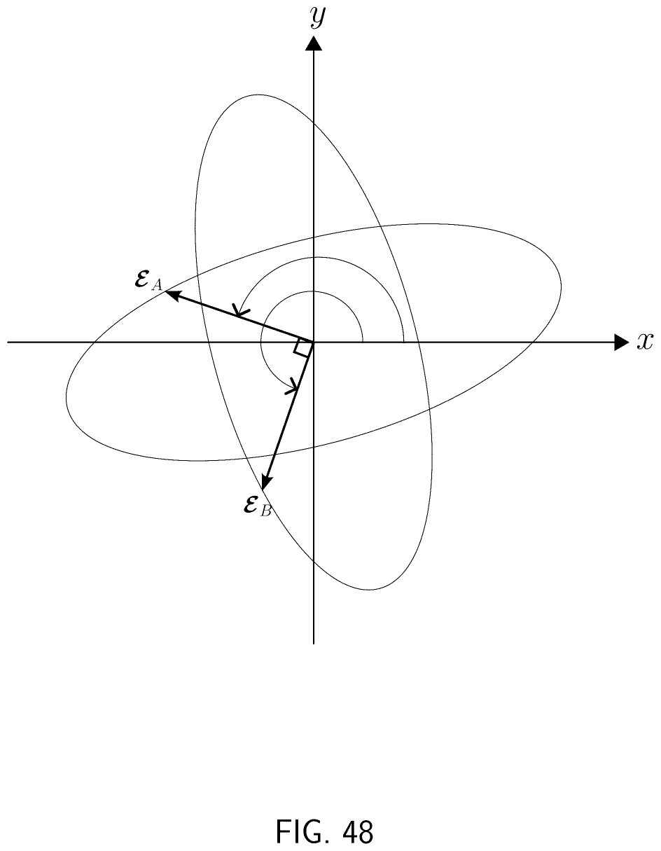

Physically, what is going on with the basis vectors is shown in FIG. 48. In particular, the two electric fields are spinning about the origin while maintaining π/2 radians angle between them at all times.

In terms of the Poincaré sphere of FIG. 46, ε_{A} and ε_{B} are in opposite hemispheres and on separated by π radians. Note carefully, while the handedness of these basis vectors is opposite, i.e. (+2χ) vs. (−2χ), the sense of the rotation of the vectors in FIG. 48 is in the same direction. This is because both the ellipticity angle and the rotation angle change to compel this outcome by geometry.

Next, let's carefully define some quantities before using them to develop PBS. In particular, the following Jones Vectors (JVs) are defined in a Device Frame Of Reference (DFOR) and a textbfSymmetry Frame Of Reference (SFOR):
ε—Arbitrary JV in DFOR
ε_{A}—First JV input basis in DFOR
ε_{B}—Second JV input basis in DFOR
ε_{A*}—First JV basis for output signals in DFOR
ε_{B*}—Second JV basis for output signals in DFOR
ε′_{A}—First basis vector in symmetry frame of reference (SFOR)
ε′_{B}—Second basis vector in SFOR
ε′ is a JV spanned by symmetry basis vectors ε′_{A} and ε′_{B} in SFOR
ε″ is a JV in a basis rotated by ψ relative to the DFOR
ε′″ is a JV in a basis rotated by

$$( ψ - \frac{π}{2} )$$

relative to the DFOR
ε^{AB} is an arbitrary input JV spanned by ε_{A} and ε_{B} in DFOR
(ε′)^{AB} is a JV spanned by symmetry basis vectors by ε′_{A} and ε′_{B} in SFOR
ε^{A*B*} is an output JV spanned by ε_{A} and ε_{B} in DFOR
(ε′)^{A*B*} is an output JV spanned by ε′_{A} and ε′_{B} in SFOR

In the big picture, there are input polarization signals and output polarization signals from the PBS device. Inputs are distinguished from outputs by the complex conjugate transform, because it is mathematically convenient. The input basis vectors are shown in FIG. 46 as polarization states [symbol] and [symbol] . The output basis vectors are shown in FIG. 46 as polarization states [symbol] and [symbol] such that [symbol] = [symbol] and [symbol] = [symbol] . The conjugation process sends 2χ→(−2χ). Additionally, there are two ways to represent a JV. The first is by a rotated JV from one basis to another basis. The second is as an eigen-state expansion using orthogonal basis vectors that are chosen to select how the PBS device converts polarization signals.

The input-to-output connection can be represented in DFOR and SFOR as follows:

εₒ=J̅εᵢ (235)

ε′ₒ=J̅′ε′ᵢ (236)

where εᵢ and εₒ are the input and output JVs in DFOR, and ε′ᵢ and ε′ₒ are the input and output JVs in SFOR. That said, it will prove to be easier to expand Eq. 236 using SFOR basis vectors

ε′ᵢ=Λ̅′ᵢ(ε′ᵢ)^{AB} (237)

ε′ₒ=Λ̅′ₒ(εₒ)^{CD} (238)

where

$${{Λ}_{i}^{′}}^{=} = [ {ℰ}_{A} , {ℰ}_{B} ] \qquad ( 239 )$$

$$= \frac{1}{\sqrt{2}} [ \begin{matrix}{e}^{i χ} & {e}^{i χ} \\ {e}^{- i χ} & - {e}^{- ι χ}\end{matrix} ] \qquad ( 240 )$$

$${{Λ}_{o}^{′}}^{=} = [ {ℰ}_{C} , {ℰ}_{D} ] \qquad ( 241 )$$

$$= \frac{1}{\sqrt{2}} [ \begin{matrix}{e}^{- i χ} & {e}^{- i χ} \\ {e}^{i χ} & - {e}^{i χ}\end{matrix} ] . \qquad ( 242 )$$

Therefore, on plugging Eqs. 237-241 into Eq. 236 we arrive at

$${( {ℰ}_{o} )}^{C D} = {( {ℰ}_{o}^{′} )}^{A B} \qquad ( 243 )$$

$$= {( {{Λ}_{o}^{′}}^{=} )}^{- 1} {{J}^{′}}^{=} {{Λ}_{i}^{′}}^{=} \qquad ( 244 )$$

Now, let's again start with Eq. 236, but instead of expanding with eigen basis vectors, as was just done above, now let's rotate vectors by using rotation matrices to connect the input to the output of the PBS device. In particular, by using

$${ℰ}_{i}^{′} = {R}^{=} ( ψ - \frac{π}{4} ) {ℰ}_{i}^{′} \qquad ( 245 )$$

$${ℰ}_{o}^{′} = {R}^{=} ( ψ - \frac{π}{4} ) {ℰ}_{o}^{′} \qquad ( 246 )$$

in Eq. 236 we arrive at

$${ℰ}_{o} = {J}^{=} {ℰ}_{i} \qquad ( 247 )$$

$${J}^{=} = {R}^{=} ( ψ - \frac{π}{4} ) {{J}^{′}}^{=} {R}^{=} ( \frac{π}{4} - ψ ) . \qquad ( 248 )$$

Observe carefully that Eq. 244 and Eq. 248 both have J̅′ as a factor. Moreover, the ideal behavior of the PBS in the DFOR is easily described by J̅ if [symbol] and J̅′ are known. It is now shown (below) that J̅′ can be calculated by symmetry considerations and that [symbol] specifies the ideal performance of the PBS device by “hot coding” the matrix entries with a single strategically placed “1” and the rest “0” entries.

Next, the objective is to find an expression for J̅′ only using the symmetry properties of the PBS colloid layer. There may be many possible configurations, however in this disclosure we will restrict the form to that which has mirror and inversion symmetry.

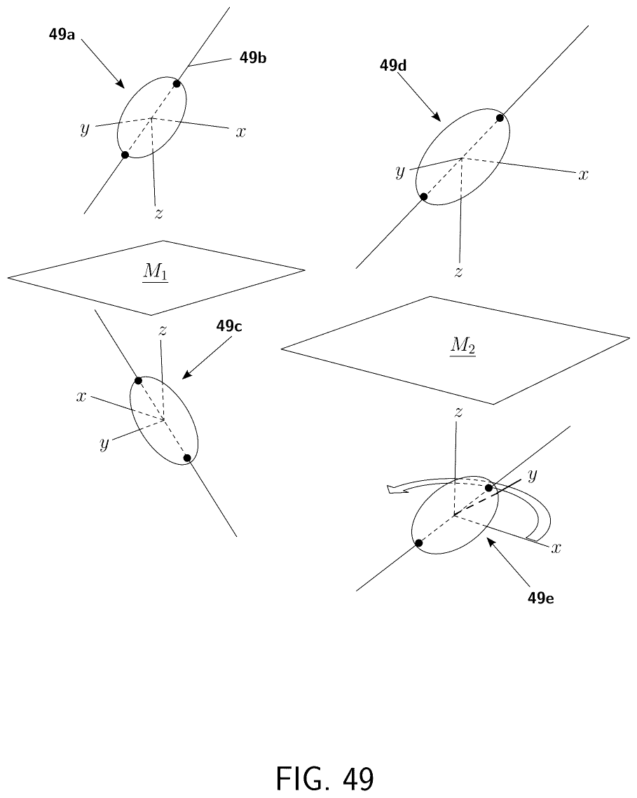

In particular, FIG. 49 shows an oriented first particle 49a having a long spheroid axis 49b generally parallel to the xz-plane. The first particle is mirrored across a mirror plane M₁ to form a second particle 49c. This second particle is not congruent with the first particle. Also, notice how the x-coordinate changed direction to maintain a right handed coordinate system. Therefore, consider a third particle 49d, it too is spheroidal and has its long axis designated with the axis as drawn parallel to the xz-plane. However, now we mirror the particle and also rotate the particle by π radians about the z-axis to form a fourth particle 49e. This fourth particle is congruent (in orientation) with the third particle 49d. Notice how the y-axis has changed direction.

This can be set more exactly with some math. The symmetry operation is a z-reflection across the mirror plane, followed by π radian of rotation about the z-axis.

$${{S}^{=}}_{1} = [ \begin{matrix}- 1 & 0 \\ 0 & 1\end{matrix} ] [ \begin{matrix}- 1 & 0 \\ 0 & - 1\end{matrix} ] = [ \begin{matrix}1 & 0 \\ 0 & - 1\end{matrix} ] \qquad ( 249 )$$

The first matrix (with only a single “−1” entry) corresponds to the flipping of the axis for the second particle 49c. The second matrix (with two “−1’ entries along the diagonal) corresponds to an additional π radians of rotation as shown in the fourth particle 49e. The result is that the y-axis has flipped. This is easy to see by comparing the third particle 49d with the fourth particle 49e. This provides the entry, in the right-hand-side matrix product, of a “−1” in the yy-position in Eq. 249.

Thus, for the congruence of the geometry, before and after symmetry operations, it is necessary that the commutator of [S̅₁, J̅′]=S̅₁J̅′−J̅′S̅₁=0 and we must have that

S̅₁⁻¹J̅′S̅₁=J̅′. (250)

### Now, let

$${{J}^{′}}^{=} = [ \begin{matrix}A & B \\ C & D\end{matrix} ] \qquad ( 251 )$$

then Eq. 250 becomes

$$[ \begin{matrix}A & - B \\ - C & D\end{matrix} ] = [ \begin{matrix}A & B \\ C & D\end{matrix} ] \qquad ( 252 )$$

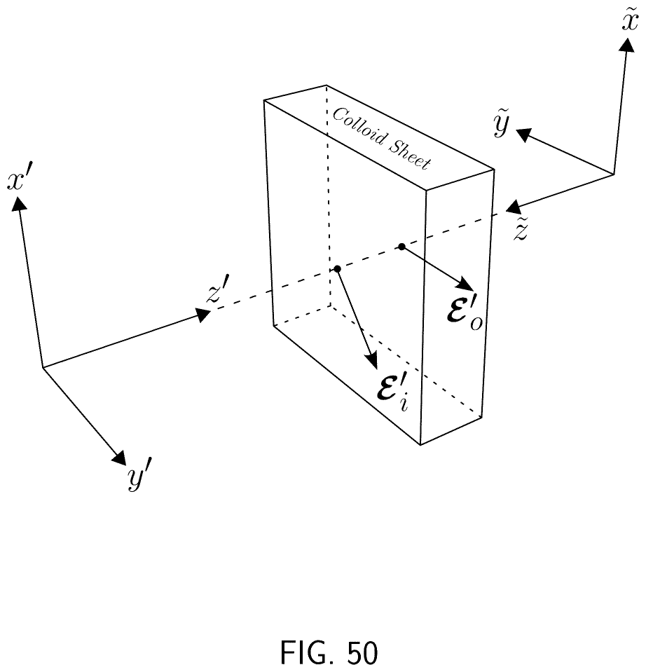

This equation provides important information, however it is incomplete. In particular, consider FIG. 50 where a portion of a colloid sheet is shown. On one side of the sheet are the forward coordinates (primed coordinates) and other side are the backwards coordinates (with tilde accent). As an electromagnetic waves travels in the forward z-direction an electric field is transformed from ε′ᵢ to ε′ₒ on passing through the colloid sheet so that

ε′ₒ=J̅′ε′ᵢ. (253)

Therefore, the backward traveling wave, with propagation starting from the tilde-accent side and moving towards the primed side, requires that

εᵢ*=(J̅⁻¹)*εₒ*, (254)

where the phase conjugate * provides time reversal. However, for pure lossless rotation, we anticipate pure rotation for the electric field. This implies that that the matrix describing the rotation is unitary wherein we expect that T̅⁻¹=T̅^{†}, where the dagger † is the adjoint operator (i.e. complex conjugate and transpose), so that

εᵢ*=J̅^{T}εₒ*, (255)

where the roman type T represents transpose. Thus, the backwards traveling wave is described by the transpose of the forward transmission matrix. However, we are not yet done as we need to also account for a change in coordinates. Again, by inspection of FIG. 50 we can see that one of x or y must be reversed to maintain a right-handed coordinate system. This requires that the off-diagonal elements have a negative sign. In particular, we anticipate that Eq. 252 becomes

$$[ \begin{matrix}A & B \\ C & D\end{matrix} ] = [ \begin{matrix}A & - B \\ - C & D\end{matrix} ] = {\underbrace{[ \begin{matrix}A & - C \\ - B & D\end{matrix} ]}}_{Transpose \& Neg . Off - Diag .} \qquad ( 256 )$$

which can only be true when J̅ takes the form

$${{J}^{′}}^{=} = [ \begin{matrix}A & B \\ B & C\end{matrix} ] . \qquad ( 257 )$$

### Then, Eq. 244

[symbol] =(Λ̅′ᵢ)^{T}J̅′Λ̅′ᵢ (258)

becomes

$$[ \begin{matrix}1 & 0 \\ 0 & 0\end{matrix} ] = \frac{1}{\sqrt{2}} [ \begin{matrix}{e}^{+ i χ} & {e}^{- i χ} \\ {e}^{+ i χ} & - {e}^{- i χ}\end{matrix} ] [ \begin{matrix}A & B \\ B & C\end{matrix} ] \frac{1}{\sqrt{2}} [ \begin{matrix}{e}^{+ i χ} & {e}^{+ i χ} \\ {e}^{- i χ} & - {e}^{- i χ}\end{matrix} ] \qquad ( 259 )$$

where [symbol] is chosen to be “hot coded”, on the left side of the equals, to only allow one polarization state through the colloid film. We can now solve for {A, B, C} to find

$$A = \frac{{e}^{- 2 i χ}}{2} \qquad ( 260 )$$

$$B = \frac{1}{2} \qquad ( 261 )$$

$$C = \frac{{e}^{+ 2 i χ}}{2} \qquad ( 262 )$$

therefore,

$${{J}^{′}}^{=} = \frac{1}{2} [ \begin{matrix}{e}^{- 2 i χ} & 1 \\ 1 & {e}^{+ 2 i χ}\end{matrix} ] . \qquad ( 263 )$$

and from Eq. 248 we get

$$\begin{matrix}{J}^{=} = {R}^{=} ( ψ - \frac{π}{4} ) {{J}^{′}}^{=} {R}^{=} ( \frac{π}{4} - ψ ) \\ = \frac{1}{2} {R}^{=} ( ψ - \frac{π}{4} ) [ \begin{matrix}{e}^{- 2 i χ} & 1 \\ 1 & {e}^{+ 2 i χ}\end{matrix} ] {R}^{=} ( \frac{π}{4} - ψ ) \\ = \frac{1}{2} {R}^{=} ( ψ - \frac{π}{4} ) [ \begin{matrix}{e}^{- 2 i χ} & 0 \\ 0 & {e}^{+ 2 i χ}\end{matrix} ] {R}^{=} ( \frac{π}{4} - ψ ) + \frac{1}{2} {R}^{=} ( ψ ) {R}^{=} ( - \frac{π}{4} ) [ \begin{matrix}0 & 1 \\ 1 & 0\end{matrix} ] {R}^{=} ( \frac{π}{4} ) {R}^{=} ( - ψ )\end{matrix} \qquad ( 264 )$$

Finally, we obtain an expression for the Jones matrix of a dimerized meta-molecule comprising one or more NPs such that

$${J}^{=} = {\underbrace{\frac{1}{2} {R}^{=} ( ψ - \frac{π}{4} ) [ \begin{matrix}{e}^{- 2 i χ} & 0 \\ 0 & {e}^{+ 2 i χ}\end{matrix} ] {R}^{=} ( \frac{π}{4} - ψ )}}_{Meta - Atom - 1} + {\underbrace{\frac{1}{2} {R}^{=} ( ψ ) [ \begin{matrix}1 & 0 \\ 0 & - 1\end{matrix} ] {R}^{=} ( - ψ )}}_{Meta - Atom - 2} \qquad ( 265 )$$

wherein two separate anisotropic meta-atoms come together to create the needed anisotropic response to convert all input polarization states into a single output polarization state.

The first meta-atom provides phase shifts of −2χ and +2χ along a fast and a slow axis respectively, all at an orientation of

$$( ψ - \frac{π}{4} ) ;$$

while the second meta-atom provides phase shifts of 0 and π radians along the fast and slow axis respectively, all at an orientation of ψ.

Each term of Eq. 265 can be realized by two separate uniaxial birefringence responses from two separate meta-atom NPs, as may be provided by Eq. 36 where a diagonal matrix of the form n̅=diag[nₒ, nₒ, nₑ] is needed for each meta-atom. In this way meta-atom-1 and meta-atom-2 may be controlled separately by DEP for the greatest possible polarization control. Different DEP control principles are possible including the use of two separate DEP excitation frequencies for the control of torques separately on different meta-atoms; and alternately the use of different DEP electric field modalities.

Alternately, a single NP can combine the response of each meta-atom by means of coding the meta-atom-1 response in the geometry (shape) of the NP and coding meta-atom-2 response in the crystal structure that comprises the meta-molecule or vice versa. The anisotropy of shape may be uniaxial and the anisotropy of materials may be by uniaxial as well.

Alternately, a deformable NP can be configured by DEP body forces to a shape that provides the needed reconfigurable anisotropy by Eq. 36 where a diagonal matrix of the form n̅=diag[nₓₓ, n_{yy}, n_{zz}], where none of the RI components are equal.

Alternately, a spherical NP can have its crystal structure formed from a bi-axial material.

Even in the cases where the meta-molecule is not reconfigurable, there is still the opportunity to reconfigure its orientation.

The reader should note that the polarization control provided with the PBS technique using metafilms is different than techniques for conventional metasurfaces [17, 18, 19] because OMP based PBS provides:
Dynamic meta-atoms and meta-molecules that can rotate to new positions to allow PBS
Dynamic meta-atoms and meta-molecules that can deform to new shapes to allow PBS
Coordinated motion of meta-atoms and meta-molecules by DEP to allow PBS
Programmable output polarization states instead of a static output polarization from prior-art metasurface designs
A three-dimensional metafilm with more degrees of freedom than a prior-art two-dimensional metasurfaces
Arbitrary and programmable polarization gradients, whereas the prior-art is limited to a constant output polarization states
Multiple ways to obtain a bi-axial meta-molecule (see list at beginning of this section)
The thickness of the metafilm also contributes to the overall response, as multiple NPs will contribute to the needed phase shifts for PBS.
At a more mathematical level mirror symmetries with respect to a plane perpendicular to the z-axis (normal to the beam steering panel) and a center of inversion to account for motion of the meta-atoms. This inversion is equivalent to applying a reflection and a subsequent rotation by π, which does not change the PBS response, i.e. a C₂-symmetry with respect to the z-axis.

In summary, the individual NPs suspended in a colloid can be at least one of shaped, deformed, and orientated by DEP to create the equivalent of two meta-atoms that come together for polarization conversion. There is also a less sophisticated technique wherein one layer of NPs steers one polarization state, followed by polarization conversion by controllable uniaxial waveplates followed by beam steering of the remaining polarizations.

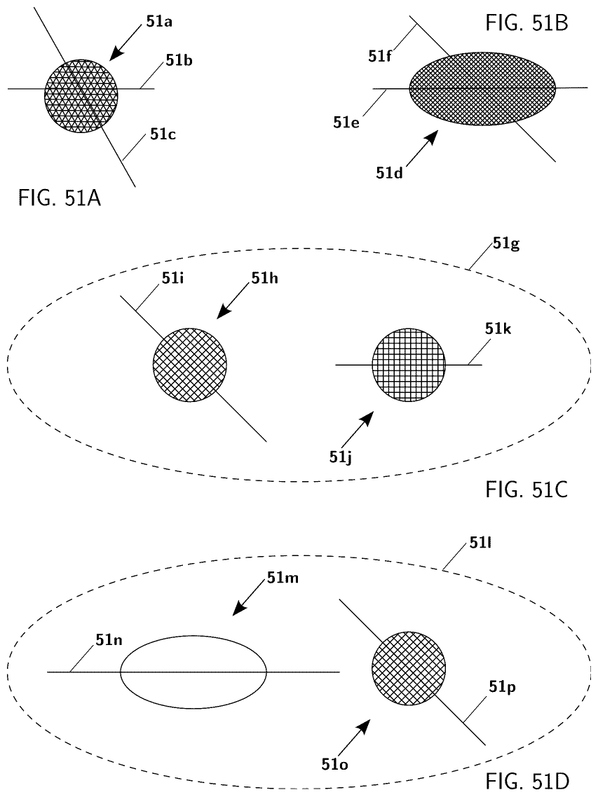

Embodiments of dimerized meta-atoms are provided in FIGS. 51A-D.

FIG. 51A shows a spherical shaped dimerized meta-atom 51a with bi-axial crystal composition that is used in plurality in the formation of a polarization beam steering colloid. This dimerized mata-atom has a first optical axis 51b and a second optical axis 51c.

FIG. 51B shows an ellipsoidal dimerized meta-atom 51d with uniaxial crystal anisotropy and uniaxial shape anisotropy, which in combination form a biaxial anisotropy and in combination are used in plurality the formation of a polarization beam steering colloid. This dimerized mata-atom has a first optical axis 51e and a second optical axis 51f.

FIG. 51C shows a system of two dimerized meta-atoms 51g. The first meta-atom 51h has a first optical axis 51i, due to the underlying crystal structure of the meta-atom. The second meta-atom 51j has a second optical axis 51k, due to the underlying crystal structure of the meta-atom. The relative orientation between the meta-atoms is maintained by dielectrophoretic forces and torques. Thus, the meta-atoms in combination form a biaxial anisotropy and in paired combination are used in plurality for the formation of a polarization beam steering colloid.

FIG. 51D shows a system of two dimerized meta-atoms 511. The first meta-atom 51m has a first optical axis 51n, which is due only to its shape as it is amorphous (no hatching marks). The second meta-atom 51 has a second optical axis 51p that is due to the underlying crystal structure. The relative orientation between the meta-atoms is maintained by dielectrophoretic forces and torques. Thus, the meta-atoms in combination form a biaxial anisotropy and in paired combination are used in plurality for the formation of a polarization beam steering colloid.

Thus the meta-atoms (i.e. the NPs) are dynamically controlled to form a dimerized polarization control meta-molecule. The meta-molecules are meta-molecules are either held together by physical chemical bonds or by dielectrophoretic forces and torques. The meta-molecules are dynamic and can orientate into the needed direction for PBS.

### General Summary

Voltage and current electrodes carrying a harmonic signal (sine waves) can be used to create electric fields that are perpendicular and parallel to electrodes to synthesize a rotating electric field from point-to-point within a colloid. The fields are orthogonal and in phase quadrature. This rotating electric field is used to generate DEP-based torques on NPs that can orientate the NPs into a specific three dimensional orientation by either a steady-state process (i.e. orientations where torque is zero) or by a transient process (i.e. rotations over a time window) to create a designer A-GRIN medium. There are potentially many tens of thousands of NPs per cubic micron so that the law of large numbers comes into play and an average NP orientation is associated with each volume element, so that a distinct RI ellipsoid orientation is also clearly defined for the designer anisotropic A-GRIN medium. Light then propagates along geodesics that are determined by the distribution of NP orientations in the colloid. It is possible to change orientations of NPs by just changing the DEP excitation frequency. It is possible to use the viscosity of the colloid to enable an analog memory so that once the state of the colloid is set the optical properties are also set for a period of time before the voxel needs to be refreshed with a new DEP signal. This allows time division multiplexing of the DEP drive signal and a “display-like” beam steering system that is capable of controlling refraction, reflection, and diffraction. The electrodes may be a transparent medium like transparent indium tin oxide or it may be implemented by conductive liquids that are separate from the colloid. The technology may be used for optics or for other electromagnetic radiation bands so long as the appropriate size particles are used, this may or may not be nanoscale. The ability to bend and steer light by electronically controlling scattering and RI has many practical applications. The above summary is specific for dielectrophoresis, but the principles may be applied to other phoretic modalities such as magnetophoresis, chemophoresis, etc. as already mentioned. In this way optics may be modified and light controlled by a process of optometaphoresis, which is a new and emerging field of optics.

### Additional Embodiments

In this section a list of the additional embodiments is provided.
1. A cross section of a colloid in the xz-plane may have NPs that rotate in the xz-plane. However, other planes of rotation also exist. The principle plans include the xy-plane, yz-plane, and the xz-plane. Other intermediate planes are also possible. Additionally, the techniques discussed in this document allow for beam steering that is not in the incident plane. That is, light ray trajectories along nonplanar trajectories is possible within the colloid.
2. The focus of this document has been optics (e.g. ultraviolet, visible, and infrared), however other electromagnetic bands are equally accessible. This can include terahertz waves and millimeter wave bands as may be useful in radar, communications, and other applications.
3. In discussions so far, all of the light steering action takes place in one colloid layer, where the light rays bend along a continuous curve to redirect light. A second approach uses a multiple layers to manage orthogonal polarizations of light.
4. In another approach, a plurality of separate layers are used to allow piecewise bending of an input light ray. Each layer can have constant E_{·} and E_{∥}. In this way Eqs. 162 and 163 have ω→∞ as an approximation. This corresponds to a constant index ellipsoid on each layer instead of one layer with an infinite number of layers. Such a configuration would be much thicker as an optical system and have many more separate voltage and current electrodes, however the electric fields would not need to spatially vary within a layer so that very large electrodes could be used. For example, this might have applications in solar energy where meter square electrodes might be useful in solar power plants that are kilometers in diameter and only simple large electrodes are used to keep cost low.
5. Another embodiment combines prior-art metasurfaces with the metafilms of this disclosure to form a hybrid system. For example a metasurface lens may have a fixed focal length and the metafilm, which is in contact or near contact with the metasurface, then provides a zoom feature to the lens. This embodiment can be generalized and to radar, LiDAR and other applications.
6. More than one spectral band can be beam steered. For example, both a laser beam and a terahertz beam can be steered simultaneously with a extended colloid having a plurality of different NPs therein.
7. Rotating electric fields, with elliptical polarization, in a thin colloid layer will cause rotational diffusion of nanoparticles to a unique steady-state orientation that is substantially independent of temperature.
8. The initial orientation, gradient, and direction of nanoparticle rotation along a phase-ray trajectory determine the direction of beam steering and the curvature of the resulting trajectory.
9. Fermat's principle provides phase-ray trajectories, not energy-ray trajectories. This appears to be often misunderstood by the general scientific community. This makes a significant difference in the detailed design of anisotropic optics, but conceptually makes only a small difference as beam steering is always cased by changes in the refractive index, even if diffraction effects are used in beam steering.
10. Obtain the energy-ray vector field from a phase-ray vector field by taking the gradient of the dispersion relation field using the phase-ray's linear optical momentum p=n\hat{k}=k as input, whereby νₑ=∇ₖω(k).
11. Obtain boundary refractions by conservation of phase-ray tangential components of the linear optical momentum. Energy-ray information is not used.
12. Energy-rays and phase-rays can be made one and the same in an anisotropic medium by aligning the optical electric fields with the optical axis of the uniaxial anisotropic nanoparticles and then choosing the gradient in the orientation of nanoparticles to always keep the electric field parallel to the optical axis, even as the light rays traverse a curved trajectory.
13. It is not necessary to have energy-rays and phase-rays align in magnitude and direction for beam-steering to occur.
14. The segmented electrodes introduced in this disclosure can provide translation and rotation to nanoparticles so that gradients in the volume fraction and orientation of the nanoparticles can be controlled simultaneously.
15. Beam steering and focusing is typically done with extraordinary wave polarization so this polarization needs to be obtained for all rays by conversion in a colloid, and this is possible with optometaphoresis.
16. It is possible to control polarization dynamically with elliptically polarized electric fields that rotate in a plane that is perpendicular to the elliptically rotating electric fields used for beam steering. Therefore, polarization control and conversion and beam steering are two separate and controllable optical functions using optometaphoresis.
17. An anisotropic colloid can have gradients in its orientational distribution as well as its volume fraction and these distributions can be synthesized to provide new types of fluidic metamaterials by means of dielectrophoresis.
18. Voltage electrodes and current electrodes, printed across a thin gap containing a thin colloid sheet, can be combined to provide rotating electric fields inside the colloid that are either parallel or perpendicular to a thin colloid layer depending on how the electrodes are energized. This overcomes the problem of prior art needing four voltage electrodes with geometric configuration that is not compatible with dielectrophoresis of a thin colloid sheet.
19. Segmenting an electrode into long wire-like sub-arrays allows its applied electric field to decay into the colloid, even for very large electrodes on the order of meters square. This overcomes the problem that large and flat electrodes have a constant magnitude electric field instead of a decreasing electric field magnitude as the point of observation moves away form electrodes, which is a critical problem to solve for light control.
20. Segmenting an electrode into long wire-like sub-arrays allows complex weighting of the voltage and current signals to (1) overcome the effects of fringing fields and (2) to allow fine tuning of the orientation of nanoparticles to beam steer, focus, and allow light to ingress and egress from light-guide modes. Thus the weighting on segmented wires is very much like a phased-array antenna controller, but for broadband light (and other electromagnetic bands too).
21. Stacking segmented electrodes, having long wire-like sub-arrays, with the direction of the wires at π/2 radians allows orthogonal fields and phase quadrature fields in the colloid layer.
22. Electric current electrodes support harmonic sheets of current and can induce electric fields that are parallel to the current sheet.
23. Electric current electrodes support harmonic lines of current (in wires) and can induce electric fields that are parallel to the line-current (wires).
24. It is possible to have mixtures of particles with both positive and negative material dispersion so that chromatic dispersion is eliminated from optical functions like beam steering and focusing.
25. It is possible to divide a light beam by polarization multiplexing to steer two separate beams independently.
26. It is possible to combine two separate light beams by polarization demultiplexing using different OMP layers.
27. Polarization beam steering that uses the full three-dimensional colloid film is possible with NPs configured to provide different phase shifts in different directions and this can be dynamically changed by DEP to allow a mixture of input polarizations to be converted into one polarization and beam steered as a e-wave.
28. Different polarization states can be beam steered from different layers of colloid.
29. Lithographically formed particles allow for near perfect colloid dispersions. For example, plasma etched silicon particles that are also doped to provide particle-to-particle repulsion for a stable colloid.

### Different Ways to Describe Disclosure

It is often the case that having an alternate way of describing something can provide new insights into the true nature of the thing being described. So in this section some alternative descriptions of the disclosure are provided to further teach the true nature of the invention. In particular,
1. A phased array system to control input light by at least one micro-structured Radio Frequency (RF) Phased Array Antenna (segmented electrodes), with controllable: current amplitudes, current phases, voltage amplitudes, and voltage phases, which are all impressed in a coordinated way on the antenna elements (segmented wires forming electrodes) of said phased array antenna, by the RF source and electronic controller, so that the resulting near-field RF energy irradiates a colloid-sheet to provide at least one of translation, rotation, and deformation of a plurality of free-floating and dispersed meta-atoms (nanoparticles), by a dielectrophoretic process between said RF energy and said meta-atoms, and where said meta-atoms are randomly dispersed in said colloid, which has at least one of isotropic and anisotropic meta-atoms (nanoparticles) dispersed therein, which are subsequently formed into a fluidic metamaterial with its meta-atoms gaining distributional structure, while also retaining random structure, so that light trajectories can be bent and wave properties of light modified and controlled by a software programmable micro-structured RF Phased Array Antenna, to provide at least one of refraction, reflection, diffraction, polarization conversion, orbital angular momentum conversion, and guided light functions for a plurality of end-use applications.
2. A phased array system to control input optical light, e.g. visible light, by using at least one radio frequency (RF) phased arrayed antenna (wires) to manipulate the distributional structure of meta-atoms randomly dispersed in a colloid, such that at least one of the position, orientation, and shape of said meta-atoms is controlled by the near-field modal structure of the RF energy, so that at least one of isotropic and anisotropic graded refractive index optics bends light internal to said colloid to provide at least one of optical: refraction, reflection, diffraction, polarization conversion, and guided light functions, for a plurality of end-use applications.
3. A phased array system to control input light with at least one near-field micro-structured radio frequency (RF) phased array antenna array (segmented electrode), which is used to manipulate meta-atoms (nanoparticles) per cubic micron in a colloid dispersion by dielectrophoretic forces and torques impressed by said phased array antennas, to provide at least one of optical: refraction, reflection, diffraction, polarization conversion (spin angular momentum conversion), orbital angular momentum conversion, and guided light functions, for a plurality of end-use applications requiring dynamic operation, small to extremely large aperture areas upward to square meters, and control of low to intense optical energy, all over a large range of environmental conditions with a paper-thin and robust light-control device that can be programmed into a wide range of optical devices and systems and which can retain its optical properties for a period of time without RF fields by means of the memory of a viscous colloid.
4. A phased array system to control light passing through a paper-thin liquid colloid sheet with meta-atoms therein and sandwiched by transparent micro-structured RF phased array antennas in near contact with said colloid sheet, whereby near-field RF energy from oscillating and phase-controlled voltages and currents in the RF antenna, impress dielectrophoretic forces and torques on a very large plurality of meta-atoms suspended in said liquid colloid, to change at least one of the position, orientation, and shape of meta-atoms therein, so that the local refractive index in said colloid sheet is modified and subsequent interactions of light with meta-atoms bends said light to provide at least one of refraction, reflection, diffraction, polarization synthesis, orbital-angular synthesis, and guided light functions so that software programmable RF energy controls the trajectory and properties of light.
5. A phased array fluidic metamaterial system to bend light and modify its wave properties by passing said light through a paper-thin and transparent colloid sheet, with a large plurality of randomly located meta-atoms (particles) dispersed therein, and by impressing dielectrophoretic forces and torques on said meta-atoms with optically transparent near-field RF energy from phased array antennas (segmented electrodes), so that the point-to-point optical refractive index (both isotropic and anisotropic) in said colloid can be software controlled for optical refraction, reflection, diffraction, polarization synthesis, orbital-angular synthesis, and guided-light functions for compact, narrow-to-broad-band, and low-to-high-power, light-control applications.
6. The device of item 5, wherein said meta-atoms are about 1 nm to 100,000 nm in size.
7. The device of item 5, wherein said light is generalized to other optical bands, including at least one of ultraviolet light, visible light, infrared light, sub-millimeter wave light, millimeter wave light, and microwaves.
8. The device of item 5, wherein said RF Phased Array is generalized to other frequency bands other than radio frequencies. The device of item 5, wherein said phased array system is integrated with other metasurface technology to create a hybrid system of solid-state and wet-state metamaterials.
9. A light control device comprising radio frequency (RF) micro-structured near-field phased-array antenna-electrodes surrounding a liquid colloid of meta-atoms in a control-volume, wherein said meta-atoms are given spatial structure by dielectrophoretic forces and torques from RF electric signals on said antenna-electrodes from a controller, to control at least one of: refraction, reflection, diffraction, spin polarization, orbital-angular polarization.

### APPENDIX: THE CHALLENGES OF CONVENTIONAL I-GRIN OPTICS

I-GRIN optics is that of effectively spherical NPs, i.e. when both the material properties and shape are taken into account. It is what most people think of for GRIN optics. It has the property that RI is a function of position only. If we specify circular trajectory arcs for the phase-ray trajectories in Eq. 139, i.e. to simplify the analysis, then \hat{τ}⊥∇ In n(r). Therefore, [∇ In n(r)]·[∇ ln n(r)]=1/ρ², and

$${( \frac{\partial n ( x , z )}{\partial x} )}^{2} + {( \frac{\partial n ( x , z )}{\partial z} )}^{2} = \frac{{n}^{2} ( x , z )}{{ρ}^{2} ( x , z )} = {( \frac{{n}_{1} sin {α}_{1} - {n}_{2} sin {α}_{2}}{L} )}^{2} . \qquad ( 266 )$$

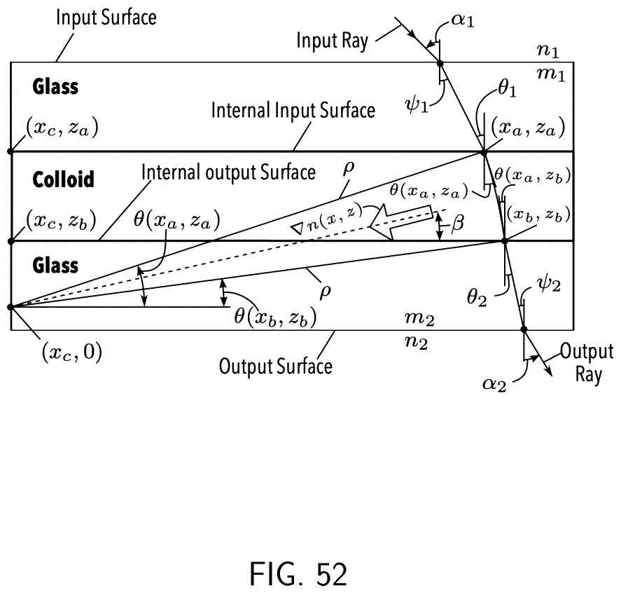

The last equality comes from the geometry of FIG. 52, where (1) the thickness of the colloid sheet is L=zₐ−z_{b}=ρ sin θ(xₐ, zₐ)−ρ sin θ(x_{b}, z_{b}), (2) Snell's law is applied by n₁ sin αᵢ=m₁ sin ψ₁=n(xₐ, zₐ) sin θ(xₐ, zₐ), and n₂ sin α₂=m₂ sin ψ₂=n(x_{b}, z_{b})sin θ(x_{b}, z_{b}), and (3) we enforce that the gradient of the RI points along the bisector of the angle formed by the points (xₐ, zₐ), (x_{c}, 0), and (x_{b}, z_{b}), as shown by the red arrow, so that n(xₐ, zₐ)=n(x_{b}, z_{b}), which is absolutely critical for large-angle beam steering. The solution to Eq. 266 is then found by product solutions and the well-known separation of variable techniques to be

$$n ( x , z ) = [ \frac{{n}_{2} sin {α}_{2} - {n}_{1} sin {α}_{1}}{L} ] ( x cos β + z sin β ) + {n}_{0} , \qquad ( 267 )$$

where the required gradient angle β is

$$β = \frac{1}{2} \{ {sin}^{- 1} [ \frac{{n}_{1} sin {α}_{1}}{n ( {x}_{a} , {z}_{a} )} ] - {sin}^{- 1} [ \frac{{n}_{2} sin {α}_{2}}{n ( {x}_{b} , {z}_{b} )} ] \} . \qquad ( 268 )$$

Finally, by Eq. 35, a colloid comprising isotropic spherical particles has a beam steering NP volume fraction

$${v}_{P} ( x , z ) = \frac{1}{L} [ \frac{{n}_{2} sin {α}_{2} - {n}_{1} sin {α}_{1}}{{n}_{P} - {n}_{L}} ] ( x cos β + z sin β ) + \frac{{n}_{0} - {n}_{L}}{{n}_{P} - {n}_{L}} . \qquad ( 269 )$$

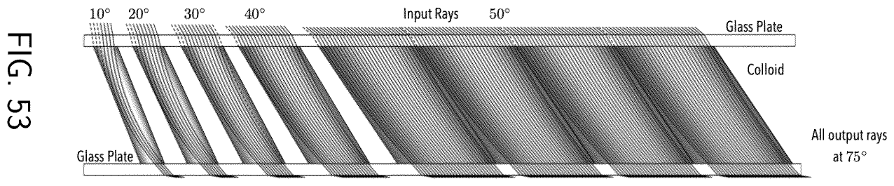

In FIG. 53, several beam steering examples are shown. It is seen that large-angle beam steering by I-GRIN requires both the gradient angle and the blaze width to dynamically change as the light beam is steered. Even then, large angle steering causes light leakage—see dashed rays in FIG. 53. These requirements have not been implemented by prior researchers, to the best of this author's knowledge, and this has likely been the cause of the poor results of prior attempts at large-angle beam steering by refraction, see [8]. As discussed below, A-GRIN overcomes these I-GRIN challenges intrinsically and therefore may be a better choice for controlling light.

### REFERENCES

[1] Ronald Pethig, “Dielectrophoresis, Theory, Methodology and Biological Applications,” Wiley, 2017, ISBN 978-1-118-67145-0.
[2] C. W. Misner, K. Thorne, J. A. Wheeler, D. I. Kaiser, “Gravitation,” Princeton University Press 2017, ISBN 9780691177793.
[3] Richard Feynman, “The Feynman Lectures on Physics,” Vol. II, Ch 11 Inside Dielectrics, Eq. 11.23.
[4] John David Jackson, “Classical Electrodynamics, 3rd Edition,” Wiley, 1999, ISBN 978-0-471-30932-1.
[5] Julius Adams Stratton, “Electromagnetic Theory,” ISBN 9781515288732, McGraw-Hill 1941.
[6] Amnon Yariv and Pochi Yeh, “Optical Waves In Crystals,” John Wiley & Sons, 1984, ISBN 0-471-09142-1.
[7] D. R. Lovett, “Tensor Properties of Crystals,” IOP Publishing Ltd 1989, ISBN 0-85274-031-X
[8] Rowan Morris, Mamatha Nagaraj, and Cliff Jones, “Liquid Crystal Devices for Beam Steering Applications,” Micromachines 2021, 12, 247.
[9] Erwin Kreyszig, “Differential Geometry,” Dover Books, ISBN-13: 978-0486667218, 1st edition 1991.
[10] Gabriel Barton, “Elements of Green's Functions and Propagation,” Oxford University Press, 1989, ISBN 0 19 851998 2
[11] Thomas B. Jones, “Electromechanics of Particles,” Cambridge University Press, 1995, ISBN-13 978-0-521-01910-1
[12] B. R. Russell, “Surface Charges on Conductors Carrying Steady Currents,” American Journal Of Physics, Vol. 36, No. 6, June 1968.
[13] A. K. T. Assis, et. al., “The Electric Field Outside a Stationary Resistive Wire Carrying a Constant Current,” Foundations of Physics, Vol. 29, No. 5, 1999.
[14] R. P. Feynman, R. B. Leighton, and M. Sands, The Feynman Lectures on Physics, Vol. II (Addison Wesley, Reading, M A, 1964), page 13-7.
[15] Shuai Wang, et. al., “Arbitrary Polarization Conversion Dichroism Metasurfaces for All-In-One Full Poincaré Sphere Polarizers,” Light: Science & Applications, https://doi.org/10.1038/s41377-021-00468-y
[16] Soham Saha, Deesha Shah, Vladimir M. Shalaev, and Alexandra Boltasseva, “Tunable Metasurfaces, Controlling Light in Space and Time,” Optics and Photonics News, July/Augut 2021
[17] S. Wang, Z. Deng, Y. Wang, Q. Zhou, X. Wang, Y. Cao, B. Guan, S. Xiao, and X. Li, “Arbitrary polarization conversion dichroism metasurfaces for all-in-one full Poincaré sphere polarizers,” Light: Science & Applications (2021)10:24.
[18] R. J. Potton, “Reciprocity in optics,” Reports on Progress in Physics, Rep. Prog. Phys. 67 (2004) 717-754.
[19] C. Menzel, C. Rockstuhl, and F. Lederer, “Advanced Jones calculus for the classification of periodic metamaterials,” Physical Review A 82, 053811 (2010), DOI: 10.1103/PhysRevA.82.053811

### SPECIFICATION END NOTES

### Scope of Invention

First, while the above descriptions in each of the sections contains many specific details for using generalized optometaphoresis based on dielectrophoresis for light control, these details should not be construed as limiting the scope of the invention, but merely providing illustrations of some of the possible methods, physical embodiments and applications. In particular, the present invention is thus not limited to the above theoretical modeling and physical embodiments, but can be changed or modified in various ways on the basis of the general principles of the invention.

Second, every effort was made to provide accurate analysis of the physics as part of teaching the disclosure. Nonetheless, typographical and other errors in equations sometimes make it through reviews. This should not be considered disqualifying in any way. Therefore, derivations, individual equations, textural descriptions, and figures should be taken together so that clarity of meaning is ascertained from a body of information even in the case of unintended theoretical and/or typographical errors. Also, note that many of the figures in the disclosure are not to scale, but are instead provided to maximize understanding of the underlying concepts. So again the totality of the disclosure is important to consider.

Third, the theoretical discussion provided in this disclosure reused some mathematical symbols to mean different things in different locations of the text for historical and pragmatic reasons. The meaning is readily discernible by those skilled in the art when taken in context of the associated descriptions.

Fourth, many potential end-use applications follow from a few physical principles and a few generic embodiments. There are more potential specific applications than can reasonably be discussed and shown in detail with figures.

Fifth, it is to be understood that beam steering with only one layer of colloid may be replaced with many layers of colloid where the electric fields of the dielectrophoresis are constant in amplitude, instead of decaying, in each colloid layer. In this way γ=0 in each layer and θ₀ changes in each layer. Therefore, it becomes possible to approximate continuous beam steering by a series of steps that each provide a small step in angular displacement towards the total angular displacement. This has the distinct advantage of a constant uniform amplitude electric field amplitude across each colloid layer and the electrodes can be very large, on the scale of meters square.

Sixth, the scope of the invention should in general be determined by the appended claims and their equivalents jointly with the examples, embodiments, and theoretical analysis provided.

### Acknowledgements

The author wishes to express his sincere appreciation and thanks to his entire family for their support during the early development of this technology. Also, a special thanks to my eight year old daughter, Anora, for her extra-special “patience with daddy,” for his long hours away form her and for her ever-present and energetic scientific curiosity, as I have tried to develop optometaphoresis to help address global warming with new and better forms of concentrated solar energy to leave her, in some small way, a world of beauty and wonder.

### INDUSTRIAL APPLICABILITY

This invention of optometaphoresis has broad applicability for controlling light by scattering processes from small particles that migrate to change the optical response. The control includes optical operations as beam steering and focusing as well as general wavefront modification without significant restrictions. Specific applications include, but are not limited to: Concentrating Solar Thermal (CST) systems for intense heat without fossil fuels, Concentrating Solar Power (CSP) systems for electricity without fossil fuels Light Detection and Ranging (LiDAR), electronically focused camera lenses, robotic visions systems, adaptive automotive headlights, light-art, free-space photonic network configurations for computing, laser machining, laser power beaming to remotely power drones, beamed energy-distribution networks, 3D-printing, topographic mapping, automated inspection, dynamic holograms, remote sensing, point-to-point communications, computer displays, augmented reality displays, virtual reality displays, mixed reality displays, electronic paper, sensor drones, surveying, drought monitoring sensors, aircraft collision avoidance, 5G Light Fidelity (LiFi) networks, drone based structural inspection, very large aperture adjustable-membrane-optics for satellites & astronomy, construction site monitoring, security, laser scanning for bar code readers, optical reflectance switches for telecommunications, solar heliostats, solar power plants, solar desalination plants, solar smelting plants, solar mining, solar radiation control windows, light-beam power combiner, laser systems, laser gyroscopes, laser machining, a manufacturing machine for making solid graded refractive index devices via photo-curing curing, software reconfigurable optics, polarization beam steering systems for optical memories and solar concentration, dynamic broadband millimeter and terahertz wave antennas for communications and next generation radar, and many many others.

Reference Signs List

| | |
|---|---|
| 10a | Indicatrix-1 |
| 10b | Indicatrix-2 |
| 10c | Indicatrix-3 |
| 22a | Null Angular Rotation Ray |
| 22b | Positive Angular Rotation Ray |
| 22c | Negative Angular Rotation Ray |
| 23a | Null Angular Rotation Ray |
| 23b | Positive Angular Rotation Ray |
| 23c | Negative Angular Rotation Ray |
| 24a | In-Page Field |
| 24b | Out-Of-Page Field |
| 24c | Phase Ray 1 |
| 24d | Phase Ray 2 |
| 24e | Phase Ray 3 |
| 24f | Phase Ray 4 |
| 26a | Colloid Input Surface |
| 26b | Colloid Output Surface |
| 26c | Example Ray |
| 26d | Colloid Output Surface |
| 28a | Mirror |
| 29a | cos Electrode |
| 29b | cos Electrode |
| 29c | sin Electrode |
| 29d | sin Electrode |
| 29e | Colloid Region |
| 30a | Voltage Electrode |
| 30b | Current Electrode |
| 30c | First Transparent Plate |
| 30d | Second Transparent Plate |
| 30e | Colloid |
| 31a | Hybrid Electrode |
| 31b | First Transparent Plate |
| 31c | Second Transparent Plate |
| 31d | Colloid |
| 32a | RI Ellipsoid |
| 32b | Colloid |
| 33a | Input Light |
| 33b | Output Light |
| 33c | First Transparent Layer |
| 33d | First Electrode |
| 33e | Second Transparent Layer |
| 33f | Second Electrode |
| 33g | Colloidal Layer |
| 34a | Input Rays |
| 34b | First Transparent Panel |
| 34c | Colloid Layer |
| 34d | Refractive Index Ellipsoid |
| 34e | Curved Ray |
| 34f | Second Transparent Panel |
| 34g | Output Rays |
| 34h | Voltage Sheet Electrode |
| 34i | Current Sheet Electrode |
| 35a | Input Light Beam |
| 35b | Plurality of Output Light Beams |
| 35c | Common Focus Region |
| 35d | Beam Steering Pixels |
| 36a | Voltage Electrodes |
| 36b | Current Electrodes |
| 36c | Nanoparticle Colloid |
| 36d | First Transparent Layer |
| 36e | Second Transparent Layer |
| 37a | Voltage Electrode |
| 37b | Current Electrode |
| 37c | Colloid Region |
| 37d | x-Current Sheet |
| 37e | y-Current Sheet |
| 37f | RI Ellipsoid |
| 37g | Beam Steering Plane |
| 38a | Arrayed Wires |
| 38b | Wire |
| 38c | First Resistive Node |
| 38d | Second Resistive Node |
| 38e | First Signal Source |
| 38f | Second Signal Source |
| 42a | Incident Light Ray |
| 42b | First External Cover |
| 42c | First Segmented Electrode |
| 42d | First Electro-Optic Insulator |
| 42e | Second Segmented Electrode |
| 42f | First Internal Cover |
| 42g | Colloid Layer |
| 42h | Second Internal Cover |
| 42i | Third Segmented Electrode |
| 42j | First Electro-Optic Insulator |
| 42k | Fourth Segmented Electrode |
| 42l | Second External Cover |
| 42m | Output Ray |
| 42n | Optional Mirror Layer |
| 42o | Oriented Indicatrix Distribution |
| 43a | Segmented Wire Array |
| 43b | Example Wire |
| 43c | First Transistor Array |
| 43d | Second Transistor Array |
| 43e | First Electronic Controller |
| 43f | Second Electronic Controller |
| 43g | First DEP Signal Connection |
| 43h | Second DEP Signal Connection |
| 49a | First Particle |
| 49b | Long Spheroid Axis |
| 49c | Second Particle |
| 49d | Third Particle |
| 49e | Fourth Particle |
| 51a | Spherical Dimerized Meta-Atom |
| 51b | First Optical Axis |
| 51c | Second Optical Axis |
| 51d | Ellipsoidal Dimerized Meta-Atom |
| 51e | First Optical Axis |
| 51f | Second Optical Axis |
| 51g | Two Dimerized Meta-Atom |
| 51h | First Meta-Atom |
| 51i | First Optical Axis |
| 51j | Second Meta-Atom |
| 51k | Second Optical Axis |
| 51l | Two Dimerized Meta-Atom |
| 51m | First Meta-Atom |
| 51n | First Optical Axis |
| 51o | Second Meta-Atom |
| 51p | Second Optical Axis |

1. An electrode system for redirecting and controlling input light by dielectrophoresis, comprising:
(a) at least one resistive and transparent electrode, to provide electric fields either normal to, or parallel to, said electrode when energized with an appropriate harmonic (sinusoidal and oscillating) electrical signal, wherein these electrodes may be solid pixelated structures or segmented into parallel segmented wires that forms a locally and substantially planar electrode;
(b) a transparent particle colloid sheet, which provides a plurality of particles in a liquid, such that the particles migrate by applied dielectrophoretic forces and torques, by at least one of translation, orientation, and deformation;
(c) at least one electrical signal source, which energizes said electrodes with oscillating harmonic signals at a dielectrophoretic frequency substantially different than optical frequencies;
(d) at least one electronic controller, that modifies signal strength and phase to each said electrode and each said wire forming a segmented electrode to achieve a particular light control objective; and
(e) at least one combined electrode holder and colloid container;
wherein said electrodes are placed internal to said at least one combined electrode holder and colloid container so that said electrodes and said colloid sheet are juxtaposed, but not necessarily touching, and where said electrodes are voltage-electrodes when harmonic voltage-signals have a phase difference of 0 radians across a resistive and transparent electrode, which induces electric fields normal to the plane of the electrodes; and where said electrodes are current-electrodes when harmonic voltage-signals have a phase difference of π radians across a resistive and transparent electrode, which induces electric fields parallel to the plane of the electrodes and parallel to said wires in wire segmented electrodes; and where the electrode-to-electrode and wire-to-wire magnitude and phase provided by apodization control from said electronic controller modifies the effective wire resistance via channel resistances of transistors, wire-to-wire voltages, wire-to-wire harmonic phases, and other electronic means to provide multiple modes of particle manipulation within said colloid by dielectrophoresis, which then locally change the local refractive index of said colloid to allow spectrally broadband, polarization diverse, coherent-diverse, power-level-diverse, and large-area light-fields of said input light to be modified dynamically by at least one of programmable refraction, reflection, diffraction, focusing, light-guide ingress, light-guide egress, and general wavefront modification to allow optical devices to be software programmable and dynamically reconfigurable instead of hardware specific and non-reconfigurable, to allow multiple optical functions to be integrated into a robust “solid-state” structure and small volume.

2. The device of claim 1, wherein said electrode system comprise at least one of: one, two, three, or four electrodes, which are either voltage-electrodes or current electrodes as needed for controlling light.

3. The device of claim 1, wherein said voltage-electrode and said current-electrodes are energized to provide phase quadrature electric fields with substantially π/2 radians phase difference so that the resulting electric field rotates within the colloid in a plane that is perpendicular to the local planes of the electrodes.

4. The device of claim 1, wherein two of said at least one voltage-electrode and/or said at least one current-electrode are energized to provide phase quadrature electric fields with substantially π/2 radians phase difference so that the resulting electric field rotates within the colloid and is parallel to the local planes of the electrodes.

5. The device of claim 1, wherein said at least one current-electrode is energized to provide orthogonal electric fields with 0 radians phase difference so that the resulting electric field rotates within the colloid and is parallel to the local planes of the electrodes for azimuth beam steering.

6. The device of claim 1, wherein said at least one voltage-electrode and said current-electrode are physically the same electrode, but energized differently by two oscillating signals that have substantially zero degrees of phase shift or substantially π radians of phase shift to induce oscillating voltages or oscillating currents with normal or parallel electric fields, to the plane of said electrodes, respectively.

7. The device of claim 1, wherein said electrodes are continuous sheets of resistive material.

8. The device of claim 1, wherein said electrodes are segmented sheets of resistive material with parallel wires running in substantially in one direction and joined at two common nodes.

9. The device of claim 1, wherein said electrodes are segmented sheets of resistive material with parallel wires running in substantially in one direction and joined at two common nodes through transistors or other electronic devices used to modify voltage and current for the purposes of adipozation.

10. The device of claim 1, wherein said nanoparticle colloid includes anisotropic particles much larger than the molecules of liquid forming the colloid.

11. The device of claim 1, wherein said particle forces, orientations, and stress vary with frequency.

12. The device of claim 1, wherein said second transparent plate is also mirrored to allow an electronically controllable mirror.

13. The device of claim 1, wherein said transparent anisotropic nanoparticle colloid has a anisotropic liquid such as a liquid crystal.

14. The device of claim 1, wherein said at least one voltage-electrode and said at least one current-electrode are transparent and electrically resistive.

15. The device of claim 1, wherein said at least one voltage-electrode and said at least one current-electrodes are the same electrode.

16. The device of claim 1, wherein said transparent anisotropic nanoparticle colloid has a near constant gradient in the angle of nanoparticle orientation that steers a beam without focusing.

17. The device of claim 1, wherein said transparent anisotropic nanoparticle colloid has a near linear and other order gradient terms in the angle of nanoparticle orientation that focuses a beam.

18. The device of claim 1, wherein said transparent anisotropic nanoparticle colloid is viscous enough to retain the orientation of nanoparticles within said colloid for a period of time, even in the presence of Brownian movements, so that an analog memory exists and dielectrophoresis is no longer needed to hold the state of said colloid for a period of time.

19. The device of claim 1, wherein said input light comprising one polarization state is converted into an output polarization state and simultaneously beam steered.

20. The device of claim 1, wherein said transparent particle colloid sheet comprises dimerized meta-atoms forming meta-molecules that provide polarization conversion from potentially many input polarization states to one output polarization state.

21. The device of claim 1, wherein said transparent particle colloid sheet comprises dimerized meta-atoms forming meta-molecules, by at least one of physical chemical bonds and dielectrophoretic forces and torques.

22. A light control device comprising radio frequency (RF) micro-structured near-field phased-array antenna-electrodes surrounding a liquid colloid of meta-atoms in a control-volume, wherein said meta-atoms are given spatial structure by dielectrophoretic forces and torques from RF electric signals on said antenna-electrodes from a controller, to control at least one of: refraction, reflection, diffraction, spin polarization, orbital-angular polarization.

23. The device of claim 22, wherein said device drives a process of optometaphoresis.

24. The device of claim 22, wherein said controller impresses at least one of currents and voltages on said antenna-electrodes.

25. The device of claim 22, wherein said spatial structure is at least on of position and orientation of a meta-atoms.

26. The device of claim 22, wherein said RF phased array antenna electrodes are at least partially transparent.

27. The device of claim 22, wherein said RF phased array antenna electrodes comprise wires that support at least one of oscillating voltages and currents that are also phase controlled.

28. The device of claim 22, wherein said RF phased array antenna electrodes utilizes oscillating voltages and currents, as needed, to induce orthogonal and phase quadrature electric fields in different planes as needed to induce forces and torques on meta-atoms to control said light.

29. The device of claim 22, wherein said meta-atoms comprise at least one of amorphous particle materials, crystals, cage molecules, such as Bucky Balls, carbon and silicon polymers, Janus particles, quantum dots, plasmonic dots, soft dispersed materials, particle-clusters such as meta-molecules, lithographically formed particles, plastic particles such as polystyrene, and self-assembled particles like cells and viruses, and particles of different shapes.

30. The device of claim 22, wherein said meta-atoms are about 1 nm to 100,000 nm in size.

31. The device of claim 22, wherein said light is generalized to other optical bands, including at least one of ultraviolet light, visible light, infrared light, sub-millimeter wave light, millimeter wave light, and microwaves.

32. The device of claim 22, wherein said RF Phased Array is generalized to other frequency bands other than radio frequencies and wherein said phased array system is integrated with at least one of metasurface technology to create a hybrid metasurface and metafilm system.

33. The device of claim 22, wherein said phased array system is integrated with other metasurface technology to create a hybrid system of solid-state and wet-state metamaterials.
